(19) United States
(12) Patent Application Publication
(10) Pub. No.: US 2024/0258627 A1
(43) Pub. Date: Aug. 1, 2024

(54) ELECTRIC TOOL SYSTEM WITH REMOVABLE BATTERY PACK

(71) Applicant: BLACK & DECKER INC., New Britain, CT (US)

(72) Inventors: Timothy J. Hennesy, Baltimore, MD (US); Michael Varipatis, Fallston, MD (US); Mark Cherry, White Marsh, MD (US); Nathan J. Osborne, Baltimore, MD (US)

(21) Appl. No.: 18/633,613

(22) Filed: Apr. 12, 2024

Related U.S. Application Data
(63) Continuation of application No. 17/305,495, filed on Jul. 8, 2021, now Pat. No. 12,009,539.
(60) Provisional application No. 62/705,634, filed on Jul. 8, 2020.

(51) Int. Cl. H01M 50/247; B25F 5/02; H01M 50/204; H01M 50/296

(52) U.S. Cl. CPC H01M 50/247; H01M 50/204; H01M 50/296; B25F 5/021; H01M 2220/30

(57) ABSTRACT

The present disclosure is directed to an electric power tool system with cordless power tools and removable, rechargeable battery packs that mate with the power tools to provide stored energy to the power tools. The battery packs may include a first battery pack having a basic interface and a second battery pack having an advanced interface. The power tools may include a first power tool having a basic interface and a second power tool having an advanced interface. The basic interface battery pack may mate with both the basic interface power tool and the advanced interface power tool. The advanced interface battery pack may mate with both the basic interface power tool and the advanced interface power tool.

### RELATED APPLICATIONS

This application is a continuation of and claims priority to U.S. patent application Ser. No. 17/305,495, filed Jul. 8, 2021, and titled, “Electric Tool System with Removable Battery Pack,” which in turn claims the benefit of priority under 35 U.S.C. § 119(e) to U.S. Provisional Patent Application No. 62/705,634, filed Jul. 8, 2020, titled “Electric Tool System with Removable Battery Pack.”

### TECHNICAL FIELD

This application relates to a cordless power tool system including a set of cordless power tools, a set of rechargeable and removable battery packs, and a set of battery pack chargers.

### BACKGROUND

Electric tools include an electric load and require a source of electricity to power the load. Electric tools may be broken down into two groups: (1) corded electric tools that source electricity through a cord plugged into a source of alternating current and (2) cordless electric tools that source electricity from a battery. Cordless electric tools may be broken down into two groups: (1) tools that use an internal, integrated battery and (2) tools that use a removable battery pack.

The cordless electric tools that use a removable battery pack and the removable battery packs that provide electricity (energy/power) to a cordless electric tool require an interface between the tools and the packs. The tool includes a tool portion/aspect/element of the combination interface and the pack includes a pack portion/aspect/element of the combination interface. The interface allows the tool and the pack to couple/mate and decouple/unmate with each other such that when the tool and the pack are coupled/mated the pack will provide power to the tool and will stay affixed to the tool during operation of the combination.

The interface is configured and defined such that only tools and packs that are intended to work with each will be able to fully couple/mate. Particularly, different tool and pack manufacturers configure and define the interface between their tools and packs such that a tool of one manufacturer will not fully couple/mate with a battery pack of another manufacture.

A cordless power tool and a removable battery pack mate together in order to enable the battery pack to provide stored energy to the power tool in order to operate the power tool. Mating the power tool and the battery pack requires an interface. The power tool includes a power tool portion of the interface and the battery pack includes a battery pack portion of the interface. Together the power tool portion of the interface and the battery pack portion of the interface form the combination interface. The combination interface may also be referred to as the tool-pack interface or simply as the interface.

A latching mechanism is typically provided to lock the removable battery pack to the power tool. The latching mechanism may include male/female components provided on the battery pack, the tool, or a combination of the two. In some configurations, the latching mechanism is provided in the form of an actuatable stop that locks the battery pack relative to the terminal block of the tool along an insertion axis of the battery pack.

A battery pack typically includes a series of battery cells connected in a series, a parallel, or a series/parallel configuration. The battery cells may be electrically connected in a series configuration to increase the voltage rating of the battery pack, in a parallel configuration to increase the current and/or charge capacity of the battery pack, or a series-parallel combination configuration. For example, a battery pack marketed as a 20V Max battery pack in the power tool industry with a nominal voltage of approximately 18V may include a single string of five battery cells (5S1P), or multiple such strings of five battery cells connected in parallel (5S×P, where x>1). The battery pack current capacity, and consequently its runtime, may be increased by increasing the number of parallel strings of battery cells. In this example, the parallel connections are made at the ends of the strings, though it should be understood that parallel connections may be made between a node of adjacent cells of one string and a corresponding node of adjacent cells of a second string. In an embodiment, the battery pack may be a convertible battery pack where the strings of cells may be switchably configured in series or parallel depending on the voltage requirement of the power tool. U.S. Pat. No. 9,406,915, which is incorporated herein by reference in its entirety, describes examples of such a convertible battery pack.

### SUMMARY

In one general aspect, a removable battery pack for providing electrical energy to a cordless electric tool includes a housing including a plurality of terminal slots and an interface including a first set of rails and a second set of rails.

Implementations may include one or more of the following features. For example, in some implementations, the housing includes a rear wall, the first set of rails terminates forward of the rear wall, and the second set of rails terminates at the rear wall.

For example, in some implementations, the housing includes a rear wall and the second set of rails are positioned closer to the rear wall than the first set of rails.

For example, in some implementations, the housing includes a rear wall and the first set of rails are positioned closer to the rear wall than the second set of rails.

For example, in some implementations, the first set of rails are generally in a same plane as the second set of rails.

For example, in some implementations, the first set of rails are not in a same plane as the second set of rails.

For example, in some implementations, the battery housing includes a datum plane and the first set of rails are offset from the datum plane by a first distance and the second set of rails are offset from the datum plane by a second distance.

For example, in some implementations, the first set of rails includes two rails in a first plane and the second set of rails includes two rails in a second plane, each of the two rails of the first set of rails includes a side wall, the side walls of the two rails of the first set of rails being generally parallel to each other and separated by a first distance and each of the two rails of the second set of rails includes a side wall, the side walls of the two rails of the second set of rails being generally parallel to each other and separated by a second distance. For example, in some implementations, the first distance is generally less than the second distance.

For example, in some implementations, the battery pack housing is configured to mate with the cordless electric tool in a mating direction and wherein the datum plane is generally parallel to the mating direction and wherein the first distance is offset from the datum plane in a direction generally perpendicular to the datum plane and wherein the second distance is offset from the datum plane in a direction generally perpendicular to the datum plane.

For example, in some implementations, the battery pack further includes a first set of grooves associated with the first set of rails and a second set of grooves associated with the second set of rails.

Implementations may include one or more of the following features. For example, in some implementations, the housing having a forward side and a rearward side, the forward side including the plurality of terminal slots, the first set of rails positioned closer to the forward side than the second set of rails.

In some implementations, the second set of rails are positioned closer to the forward side than the first set of rails.

In another general aspect, an interface of a removable battery pack for mating with an interface of a cordless electric tool includes a first set of rails and a first set of grooves associated with the first set of rails and a second set of rails and a second set of grooves associated with the second set of rails.

Implementations may include one or more of the following features. For example, in some implementations, the interface includes the first set of rails and the first set of grooves are positioned closer to a forward side of the battery pack than the second set of rails and the second set of grooves.

Implementations may include one or more of the following features. For example, in some implementations, the first set of rails terminates forward of a rear wall of a battery pack housing, and the second set of rails terminates at the rear wall.

For example, in some implementations, the second set of rails are positioned closer to a rear wall of a battery pack housing than the first set of rails.

For example, in some implementations, the first set of rails are positioned closer to a rear wall of a battery pack housing than the second set of rails.

For example, in some implementations, the first set of rails are generally in a same plane as the second set of rails.

For example, in some implementations, the first set of rails are not in a same plane as the second set of rails.

For example, in some implementations, the interface further includes a datum plane and wherein the first set of rails are offset from the datum plane by a first distance and the second set of rails are offset from the datum plane by a second distance.

For example, in some implementations, the first set of rails includes two rails in a first plane and the second set of rails includes two rails in a second plane, each of the two rails of the first set of rails includes a side wall, the side walls of the two rails of the first set of rails being generally parallel to each other and separated by a first distance and each of the two rails of the second set of rails includes a side wall, the side walls of the two rails of the second set of rails being generally parallel to each other and separated by a second distance. For example, in some implementations, the first distance is generally less than the second distance.

For example, in some implementations, the interface is configured to mate with an interface of a cordless electric tool in a mating direction and wherein the datum plane is generally parallel to the mating direction and wherein the first distance is offset from the datum plane in a direction generally perpendicular to the datum plane and wherein the second distance is offset from the datum plane in a direction generally perpendicular to the datum plane.

In another general aspect, a cordless electric power tool for receiving electrical energy from a removable battery pack, the power tool includes a housing including a plurality of terminal and an interface including a first set of rails and a second set of rails.

In some implementations, the housing includes a forward side and a rearward side, the forward side including the plurality of terminals, the first set of rails being positioned closer to the forward side than the second set of rails.

Implementations may include one or more of the following features. For example, in some implementations, the housing includes a front wall, the first set of rails terminates prior to the front wall, and the second set of rails terminates at the front wall.

For example, in some implementations, the housing includes a front wall and the second set of rails are positioned closer to the front wall than the first set of rails.

For example, in some implementations, the housing includes a front wall and the first set of rails are positioned closer to the front wall than the second set of rails.

For example, in some implementations, the first set of rails are generally in a same plane as the second set of rails.

For example, in some implementations, the first set of rails are not in a same plane as the second set of rails.

For example, in some implementations, the power tool housing includes a datum plane and the first set of rails are offset from the datum plane by a first distance and the second set of rails are offset from the datum plane by a second distance. In some implementations, the first distance is generally less than the second distance. In some implementations, the first distance is generally greater than the second distance.

For example, in some implementations, the first set of rails includes two rails in a first plane and the second set of rails includes two rails in a second plane, each of the two rails of the first set of rails includes a side wall, the side walls of the two rails of the first set of rails being generally parallel to each other and separated by a first distance and each of the two rails of the second set of rails includes a side wall, the side walls of the two rails of the second set of rails being generally parallel to each other and separated by a second distance. For example, in some implementations, the first distance is generally less than the second distance. In some implementations, the first distance is generally greater than the second distance.

For example, in some implementations, the power tool housing is configured to mate with the battery pack in a mating direction and wherein the datum plane is generally parallel to the mating direction and wherein the first distance is offset from the datum plane in a direction generally perpendicular to the datum plane and wherein the second distance is offset from the datum plane in a direction generally perpendicular to the datum plane.

For example, in some implementations, the power tool further includes a first set of grooves associated with the first set of rails and a second set of grooves associated with the second set of rails.

In another general aspect, a cordless power tool system includes a removable battery pack configured to mate with a cordless power tool and to provide electrical energy to the cordless power tool. The battery pack includes a housing including forward side and a rearward side, the forward side including a plurality of terminal slots that provide access to a plurality of battery terminals and an interface including a first set of battery pack rails and a first set of battery pack grooves associated with the first set of battery pack rails and a second set of battery pack rails and a second set of battery pack grooves associated with the second set of battery pack rails, the first set of battery pack rails and the first set of battery pack grooves positioned closer to the forward side of the battery pack housing than the second set of battery pack rails and the second set of battery pack grooves. The cordless power tool system includes a cordless power tool configured to mate with the removable battery pack and to receive electrical energy from the removable battery pack. The cordless power tool includes a housing having a forward side and a rearward side, the rearward side including a plurality of tool terminals configured to mate with the plurality of battery terminals upon mating with the removable battery pack and an interface including a first set of power tool rails and a first set of power tool grooves associated with the first set of power tool rails and a second set of power tool rails and second set of power tool grooves associated with the second set of power tool rails, the first set of power tool rails and the first set of power tool grooves positioned closer to the rearward side of the power tool housing than the second set of power tool rails and the second set of power tool grooves. The first set of battery pack rails and the first set of battery pack grooves and the second set of battery pack rails and the second set of battery pack grooves and the first set of power tool rails and the first set of power tool grooves and the second set of power tool rails and the second set of power tool grooves are shaped, dimensioned and configured such that when the battery pack is mated with the power tool the first set of battery pack rails is received in the first set of power tool grooves and the second set of battery pack rails is received in the second set of power tool grooves and the first set of power tool rails is received in the first set of battery pack grooves and the second set of power tool rails is received in the second set of battery pack grooves.

These and other advantages and features will be apparent from the description and the drawings.

### BRIEF DESCRIPTION OF THE DRAWINGS

FIG. 1 is diagram of example embodiment of a power tool system.

FIGS. 2a-2d illustrate a first example embodiment of a battery pack of the power tool system of FIG. 1 including only a primary interface element.

FIGS. 3a-3d illustrate a first example embodiment of a power tool of the power tool system of FIG. 1 including only a primary interface element.

FIGS. 4a-4d illustrate a combination of the battery pack of FIGS. 2a-2d and the power tool of FIGS. 3a-3d.

FIGS. 5a-5d illustrate a first example embodiment of a battery pack of the power tool system of FIG. 1 including a primary and a secondary interface element.

FIGS. 6a-6d illustrate a combination of the battery pack of FIGS. 5a-5d and the power tool of FIGS. 3a-3d.

FIGS. 7a-7d illustrate a first example embodiment of a power tool of the power tool system of FIG. 1 including a primary interface element and a secondary interface element.

FIGS. 8a-8d illustrate a combination of the battery pack of FIGS. 2a-2d and the power tool of FIGS. 7a-7d.

FIGS. 9a-9d illustrate a combination of the battery pack of FIGS. 5a-5d and the power tool of FIGS. 7a-7d.

FIGS. 10a-10d illustrate a second example embodiment of a battery pack of the power tool system of FIG. 1 including a primary interface element and a secondary interface element.

FIGS. 11a-11d illustrate a combination of the battery pack of FIGS. 10a-10d and the power tool of FIGS. 3a-3d.

FIGS. 12a-12d illustrate a second example embodiment of a power tool of the power tool system of FIG. 1 including a primary interface element and a secondary interface element.

FIGS. 13a-13d illustrate a combination of the battery pack of FIGS. 2a-2d and the power tool of FIGS. 12a-12d.

FIGS. 14a-14d illustrate a combination of the battery pack of FIGS. 10a-10d and the power tool of FIGS. 12a-12d.

FIGS. 15a-15d illustrate a third example embodiment of a battery pack of the power tool system of FIG. 1 including a primary interface element and a secondary interface element.

FIGS. 16a-16d illustrate a combination of the battery pack of FIGS. 15a-15d and the power tool of FIGS. 3a-3d.

FIGS. 17a-17d illustrate a third example embodiment of a power tool of the power tool system of FIG. 1 including a primary interface element and a secondary interface element.

FIGS. 18a-18d illustrate a combination of the battery pack of FIGS. 2a-2d and the power tool of FIGS. 17a-17d.

FIGS. 19a-19d illustrate a combination of the battery pack of FIGS. 15a-15d and the power tool of FIGS. 17a-17d.

FIGS. 20a-20d illustrate a fourth example embodiment of a battery pack of the power tool system of FIG. 1 including a primary interface element and a secondary interface element.

FIGS. 21a-21d illustrate a combination of the battery pack of FIGS. 20a-20d and the power tool of FIGS. 3a-3d.

FIGS. 22a-22d illustrate a fourth example embodiment of a power tool of the power tool system of FIG. 1 including a primary interface element and a secondary interface element.

FIGS. 23a-23d illustrate a combination of the battery pack of FIGS. 2a-2d and the power tool of FIGS. 22a-22d.

FIGS. 24a-24d illustrate a combination of the battery pack of FIGS. 20a-20d and the power tool of FIGS. 22a-22d.

FIGS. 25a-25d illustrate a fifth example embodiment of a battery pack of the power tool system of FIG. 1 including a primary interface element and a secondary interface element.

FIGS. 26a-26d illustrate a combination of the battery pack of FIGS. 25a-25d and the power tool of FIGS. 3a-3d.

FIGS. 27a-27d illustrate a fifth example embodiment of a power tool of the power tool system of FIG. 1 including a primary interface element and a secondary interface element.

FIGS. 28a-28d illustrate a combination of the battery pack of FIGS. 2a-2d and the power tool of FIGS. 27a-27d.

FIGS. 29a-29d illustrate a combination of the battery pack of FIGS. 25a-25d and the power tool of FIGS. 27a-27d.

FIGS. 30a-30d illustrate a sixth example embodiment of a battery pack of the power tool system of FIG. 1 including a primary interface element and a secondary interface element.

FIGS. 31a-31d illustrate a sixth example embodiment of a power tool of the power tool system of FIG. 1 including a primary interface element and a secondary interface element.

FIGS. 32a-32d illustrate a combination of the battery pack of FIGS. 2a-2d and the power tool of FIGS. 31a-31d.

FIGS. 33a-33d illustrate a combination of the battery pack of FIGS. 30a-30d and the power tool of FIGS. 31a-31d.

FIGS. 34a-34b and FIGS. 35a-35b illustrate a second example embodiment of a battery pack of the power tool system of FIG. 1 including only a primary interface element.

FIGS. 36a-36d illustrate a combination of the battery pack of FIGS. 34a-34b and FIGS. 35a-35b and the power tool of FIGS. 3a-3d.

FIGS. 37a-37d illustrate a seventh example embodiment of a battery pack of the power tool system of FIG. 1 including a primary and a secondary interface.

FIGS. 38a-38d illustrate a combination of the battery pack of FIGS. 37a-37d and the power tool of FIGS. 3a-3d.

FIGS. 39a-39d illustrate a seventh example embodiment of a power tool of the power tool system of FIG. 1 including a primary interface element and a secondary interface element.

FIGS. 40a-40d illustrate a combination of the battery pack of FIGS. 34a-34b and FIGS. 35a-35b and the power tool of FIGS. 39a-39d.

FIGS. 41a-41b and FIGS. 42a-42b illustrate a combination of the battery pack of FIGS. 37a-37d and the power tool of FIGS. 39a-39d.

FIGS. 43a-43b and FIGS. 44a-44b illustrate an eighth example embodiment of a battery pack of the power tool system of FIG. 1 including a primary interface element and a secondary interface element.

FIGS. 45a-45d illustrate a combination of the battery pack of FIGS. 43a-43b and FIGS. 44a-44b and the power tool of FIGS. 3a-3d.

FIGS. 46a-46d illustrate an eighth example embodiment of a power tool of the power tool system of FIG. 1 including a primary interface element and a secondary interface element.

FIGS. 47a-47d illustrate a combination of the battery pack of FIGS. 34a-34b and FIGS. 35a-35b and the power tool of FIGS. 46a-46d.

FIGS. 48a-48d illustrate a combination of the battery pack of FIGS. 43a-43b and FIGS. 44a-44b and the power tool of FIGS. 46a-46d.

FIGS. 49a-49d illustrate a fourth example embodiment of a battery pack of the power tool system of FIG. 1 including only a primary interface element.

FIGS. 50a-50d illustrate a third example embodiment of a power tool of the power tool system of FIG. 1 including only a primary interface element.

FIGS. 51a-51d illustrate a combination of the battery pack of FIGS. 49a-49d and the power tool of FIGS. 50a-50d.

FIGS. 52a-52d illustrate a ninth example embodiment of a battery pack of the power tool system of FIG. 1 including a primary interface element and a secondary interface element.

FIGS. 53a-53d illustrate a combination of the battery pack of FIGS. 52a-52d and the power tool of FIGS. 50a-50d.

FIGS. 54a-54d illustrate a ninth example embodiment of a power tool of the power tool system of FIG. 1 including a primary interface element and a secondary interface element.

FIGS. 55a-55d illustrate a combination of the battery pack of FIGS. 49a-49d and the power tool of FIGS. 54a-54d.

FIGS. 56a-56d illustrate a combination of the battery pack of FIGS. 52a-52d and the power tool of FIGS. 54a-54d.

FIG. 57 illustrates is diagram of a second example embodiment of a power tool system.

FIGS. 58a-58i illustrate another example embodiment of a battery pack of the power tool system of FIG. 57 including only a primary interface element.

FIGS. 59a-59h illustrate another example embodiment of a battery pack of the power tool system of FIG. 57 including only a primary interface element.

FIGS. 60a-60i illustrate another example embodiment of a battery pack of the power tool system of FIG. 57 including a primary interface element and a secondary interface element.

FIG. 61a-61b illustrates an example embodiment of a power tool of the power tool system of FIG. 57 including only a primary interface element.

FIG. 62a-62b illustrates another example embodiment of a power tool of the power tool system of FIG. 57 including only a primary interface element.

FIGS. 63a-63d illustrate an example embodiment of a power tool of the power tool system of FIG. 57 including a primary interface element and a secondary interface element.

FIG. 64 illustrates a combination of an example battery pack including only a primary interface element and an example power tool including only a primary interface element of the power tool system of FIG. 57.

FIG. 65 illustrates a combination of an example battery pack including only a primary interface element and an example power tool including only a primary interface element of the power tool system of FIG. 57.

FIG. 66 illustrates a combination of an example battery pack including a primary interface element and a secondary interface element and an example power tool including only a primary interface element of the power tool system of FIG. 57.

FIG. 67 illustrates a combination of an example battery pack including only a primary interface element and an example power tool including only a primary interface element of the power tool system of FIG. 57.

FIG. 68 illustrates a combination of an example battery pack including only a primary interface element and an example power tool including a primary interface element and a secondary interface element of the power tool system of FIG. 57.

FIG. 69 illustrates a combination of an example battery pack including a primary interface element and a secondary interface element and an example power tool including a primary interface element and a secondary interface element of the power tool system of FIG. 57.

FIG. 70 illustrates another example combination of an example battery pack including a primary interface element and a secondary interface element and an example power tool (foot/shroud) including a primary interface element and a secondary interface element after mating.

FIG. 71 illustrates the example combination of FIG. 70 prior to mating.

FIG. 72 illustrates the example power tool (foot/shroud) of FIGS. 70 and 71.

FIG. 73 illustrates the example battery pack of FIGS. 70 and 71.

FIGS. 74-77 illustrate another example embodiment of a battery pack including only a primary interface element.

FIGS. 78 and 79 illustrate another example embodiment of a battery pack including a primary interface element and a secondary interface element.

FIGS. 80-82 illustrate another example embodiment of a power tool (foot/shroud) including only a primary interface element.

FIGS. 83 and 84 illustrate another example embodiment of a power tool (foot/shroud) including a primary interface element and secondary interface element.

FIGS. 85-87 illustrate a combination of the battery pack of FIGS. 74-77 and the power tool (foot/shroud) of FIGS. 80-82.

FIGS. 88-90 illustrate a combination of the battery pack of FIGS. 78 and 79 and the power tool (foot/shroud) of FIGS. 83 and 84.

### DETAILED DESCRIPTION

This document describes battery packs having a basic interface—sometimes also referred to as a single rail interface. These battery packs may be referred to as basic interface battery packs and their interface may be referred to as a battery pack basic interface. This document also describes battery packs having an advanced interface—sometimes also referred to as a dual rail interface. These battery packs may be referred to as advanced interface battery packs and their interface may be referred to as a battery pack advanced interface.

This document also describes power tools having a basic interface—sometimes also referred to as a single rail interface. These power tools may be referred to as basic interface power tools and their interface may be referred to as a power tool basic interface. This document also describes power tools having an advanced interface—sometimes also referred to as a dual rail interface. These power tools may be referred to as advanced interface power tools and their interface may be referred to as a power tool advanced interface.

The basic interface may include only a single pair of rails and/or a single pair of grooves. The advanced interface may include both a first or primary pair of rails and/or an associated first or primary pair of grooves (essentially equivalent to the single pair of rails and grooves of the basic interface, in geometrical configuration, e.g., the positioning and size of the rails and grooves relative to a datum plane) and a second or secondary pair of rails and/or an associated second or secondary pair of grooves having a distinct geometrical configuration as compared to the first or primary set of rails and/or the first or primary set of grooves.

The basic interface battery packs and secondary (or supplemental) interface battery packs are compatible with both single rail interface cordless electric tools and dual rail interface cordless electric tools. The dual rail interface battery packs provide a technical solution to technical problems encountered with battery packs that are larger (e.g., longer, wider, taller, and/or heavier) than battery packs having a single rail interface. The secondary rail support assembly portion of the interface provides additional structural support for securing and retaining the larger battery packs. The secondary rail support assembly portion of the interface provides an additional set of rails for structurally supporting the larger battery packs. Improved single rail interface battery packs also achieve additional structural support benefits for securing and retaining the improved battery packs to the power tools. As described in additional details below, the dual rail interface may include two rail elements and different implementations may include different arrangements and placement of the two rail elements with respect to one another for different battery pack types. As mentioned above, one benefit of the secondary rail support assembly portion of the interface of the dual rail battery packs is that they are compatible not only with power tools having a dual rail interface, but also with tools having a single rail interface. Similarly, improved single rail interface battery packs are compatible with both single rail interface tools and dual rail interface tools.

This document also describes tools having only a single set of rails and tools having both a primary and a secondary set of rails—also referred to as dual rail tools. The dual rail interface includes two rail elements, which provide additional structural support for receiving, mating with, and structurally supporting battery packs that include the dual rail interface. One benefit of the dual rail support assembly interface tools is that they are compatible with both single rail interface battery packs and dual rail interface battery packs. The compatibility of the dual rail interface tools with multiple different types of battery pack interfaces allows flexibility for users. Improved single rail interface tools also achieve additional structural support benefits for securing and retaining the improved single rail interface power tools to the battery pack.

A first example battery pack may include only a primary rail support assembly and a second example battery pack may include a primary (first) rail support assembly and a second (second) rail support assembly.

A single rail interface system may include a primary rail support assembly element, where the primary rail support assembly element may include two rails. A single rail interface system on a battery pack or on a power tool also may be referred to as a basic interface system. As used herein, “dual” means double, or having two elements. For example, a dual rail interface system includes a first rail element and a second rail element. The first rail element may include two rails and the second rail element may include two rails. The first rail element of the dual rail interface system may be generally the same as a single rail element of a single rail interface system and the second rail element of the dual rail interface system is supplemental to the first rail element. A dual rail interface system on a battery pack or on a power tool may include what is referred to as a primary interface element and a secondary interface element.

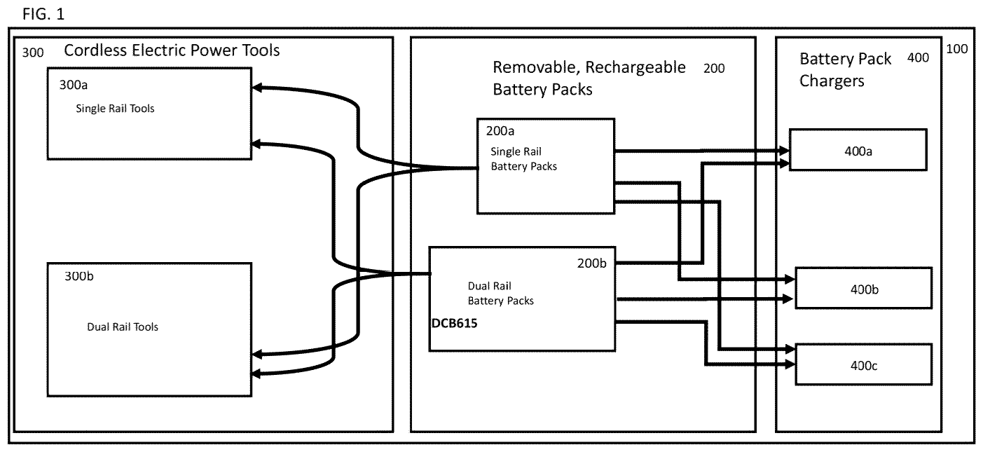

FIG. 1 illustrates an example embodiment of a cordless, electric power tool system 100. The tool system 100 includes a set of removable, rechargeable battery packs 200, a set of cordless electric power tools 300 and a set of battery pack chargers 400. FIG. 1 illustrates the compatibility of the set of battery packs 200 with the set of cordless electric power tools 300 and the set of battery pack chargers 400.

The set of removable, rechargeable battery packs 200 may include a subset of single rail (also referred to as primary rail only) interface battery packs 200a and a subset of dual rail (also referred to as primary rail and secondary rail) interface battery packs 200b. The single rail interface battery packs 200a may include single voltage battery packs (e.g., 12V, 14.4V, 18V, 20V, etc.) and multiple voltage (also referred to as multi-voltage) battery packs (e.g., 18V/36V, 20V/40V, 20V/60V, etc.). The dual rail interface battery packs 200b may include single voltage battery packs (e.g., 12V, 14.4V, 18V, 20V, etc.) and multi-voltage battery packs (e.g., 18V/36V, 20V/40V, 20V/60V, etc.).

The set of cordless electric tools 300 may include a subset of single rail interface tools 300a and a subset of dual rail interface tools 300b. The primary rail interface tools 300a may include tools that have different operating voltages such as, for example, low voltage tools, medium voltage tools, high voltage tools, etc. The dual rail interface tools 300b also may include tools that have different operating voltages such as, for example, low voltage tools, medium voltage tools, high voltage tools, etc.

As mentioned above, FIG. 1 illustrates that the single rail interface battery packs 200a are compatible with both the single rail interface tools 300a and the dual rail interface tools 300b. Similarly, the dual rail interface battery packs 200b are compatible with both the single rail interface tools 300a and the dual rail interface tools 300b.

The set of battery pack chargers 400 may include a subset of first voltage chargers 400a (e.g., low voltage chargers), a subset of second voltage chargers 400b (e.g., medium voltage chargers), and a subset of third voltage chargers 400c (e.g., high voltage chargers). FIG. 1 illustrates that the single rail interface battery packs 200a are compatible with both the first voltage chargers 400a, the second voltage chargers 400b, and the third voltage chargers 400c. Similarly, the dual rail interface battery packs 200b are compatible with both the first voltage chargers 400a, the second voltage chargers 400b, and the third voltage chargers 400c.

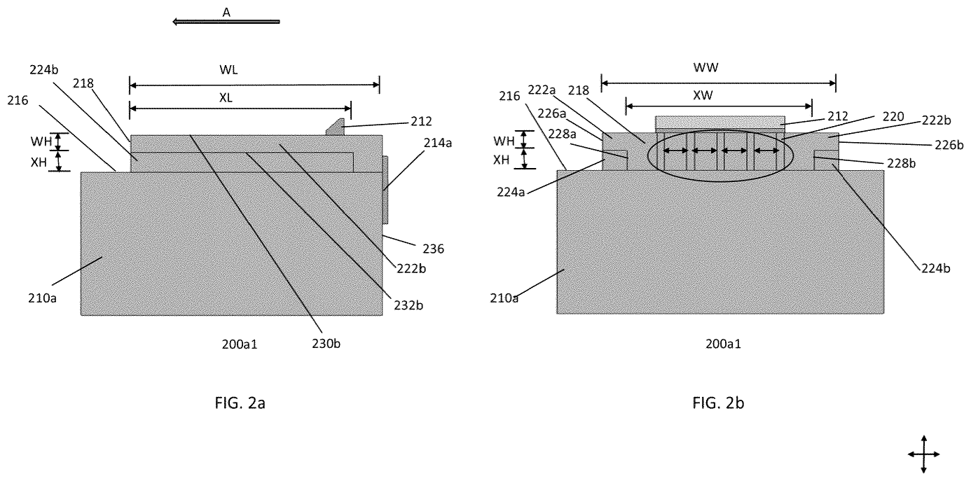

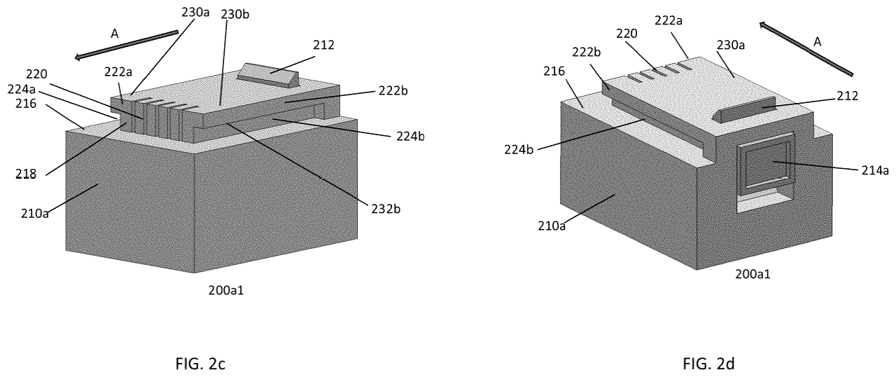

In the figures and example embodiments below for FIGS. 2-56, a single rail interface battery pack and a single rail interface tool are designated by the letter “a”. More specifically, the single rail interface battery packs are designated using the numeral “200” and the letter “a” followed by a number (e.g., 1, 2, 3, etc.) indicating the particular example embodiment. The dual rail interface battery packs are designated using the numeral “200” and the letter “b” followed by a number (e.g., 1, 2, 3, etc.) indicating the particular example embodiment. Similarly, the single rail interface tools are designated using the numeral “300” and the letter “a” followed by a number (e.g., 1, 2, 3, etc.) indicating the particular example embodiment. The dual rail interface tools are designated using the numeral “300” and the letter “b” followed by a number (e.g., 1, 2, 3, etc.) indicating the particular example embodiment. Any particular exceptions to this convention are described with respect to particular example embodiments.

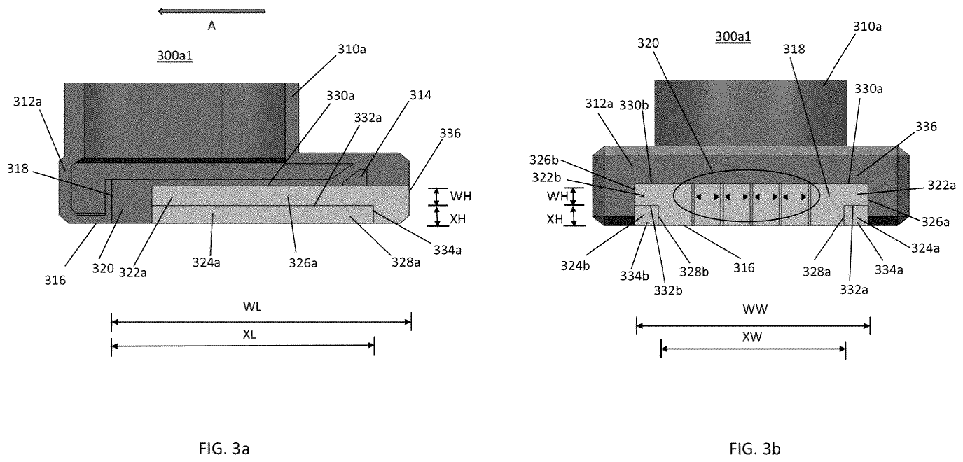

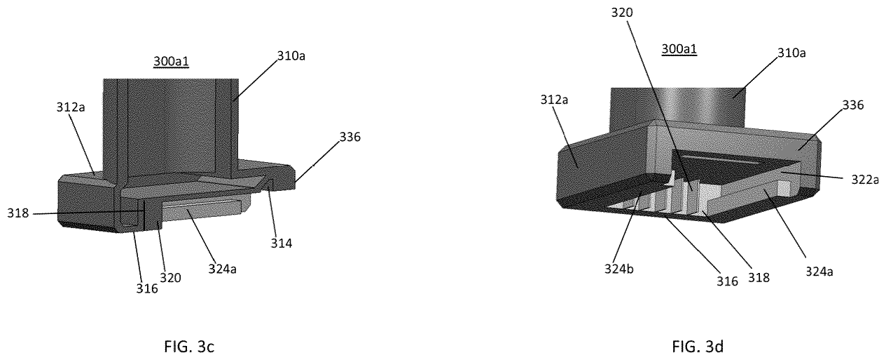

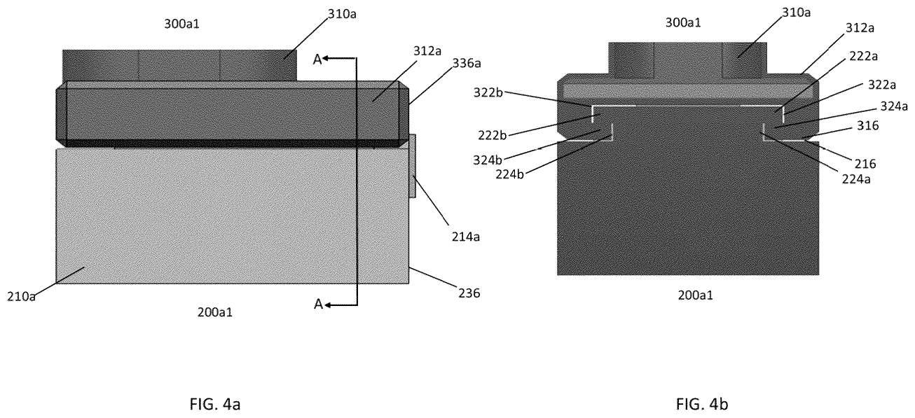

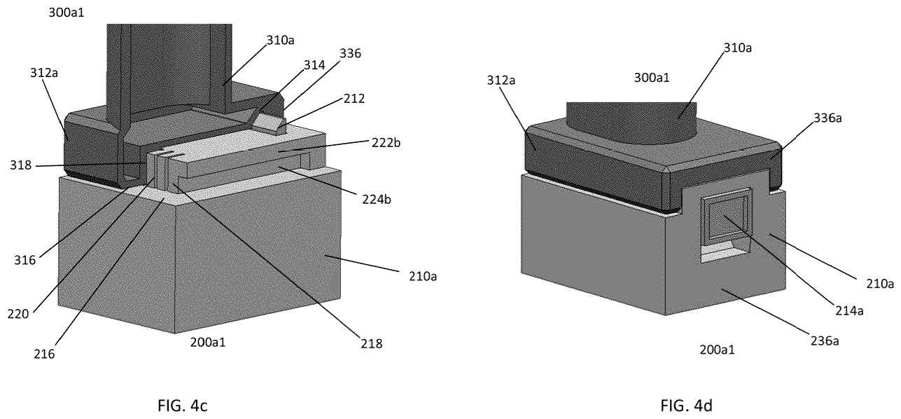

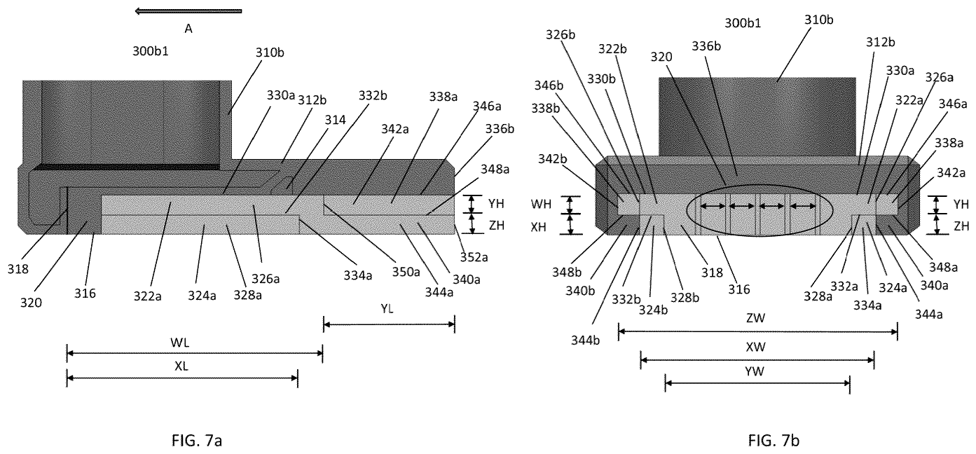

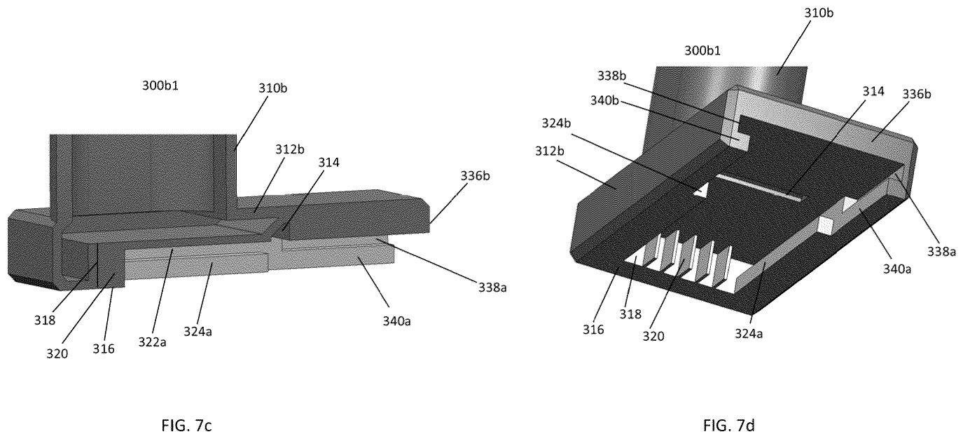

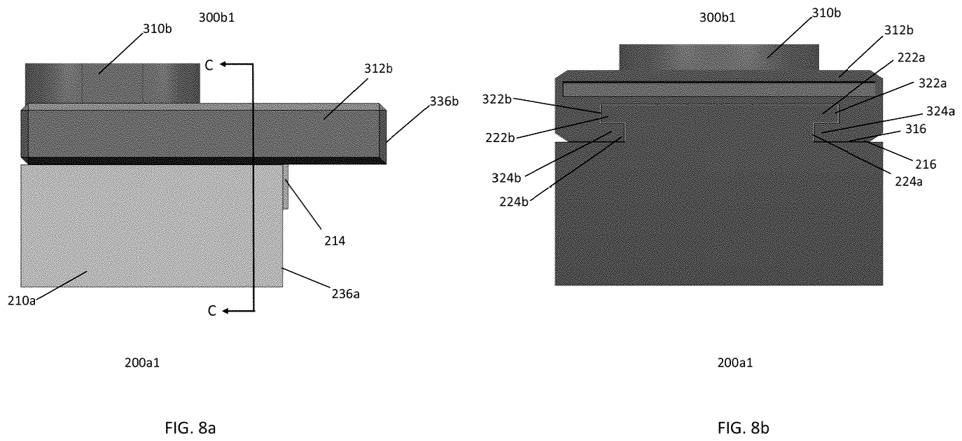

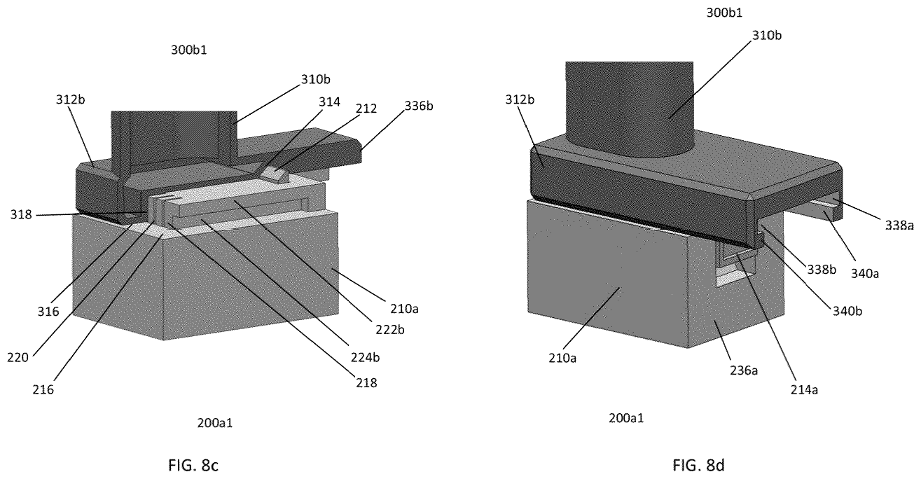

FIGS. 2a-2d illustrate a first example embodiment of a battery pack 200a1 of the power tool system of FIG. 1. The battery pack 200a1 includes an example of a basic battery pack rail interface. FIG. 2a illustrates a right side view, FIG. 2b illustrates a front view, FIG. 2c illustrates a front isometric view, and FIG. 2d illustrates a rear isometric view of the single rail interface battery pack 200a1. The basic rail interface is equivalent to a primary rail interface, as described in more detail below. The battery pack 200a1 includes a housing 210a. The housing may have a forward side and a rearward side. The battery pack 200a1 includes an interface for mating with a corresponding interface of an electric tool 300a1 (described in more detail below) with respect to FIGS. 3a-3d and FIGS. 4a-4d or with an interface of an electric tool 300b1 (described in more detail below with respect to FIGS. 7a-7d and 8a-8d. When mating (coupling) a battery pack 200a1 with an electric tool, the battery pack 200a1 will be inserted into (coupled with) the electric tool 300a1 and the electric tool 300a1 will receive the battery pack 200a1 in a mating direction, indicated by the arrow labeled A.

The interface of the battery pack 200a1 may be referred to as a basic interface or a first interface or a single rail interface. The interface includes a latch 212 and a latch actuation button 214a. The interface also includes a base surface or plane (also referred to as a horizontal datum plane) 216. The base surface 216 is approximately, generally parallel to the insertion direction A. The base surface 216 serves to define the relative position and orientation of various elements of the interface. The interface also includes a mating surface 218 (also referred to as a vertical datum plane). The mating surface 218 faces forward and is generally perpendicular to the base surface 216 and the mating direction A. The mating surface 218 includes a plurality of terminal slots 220. Each of the plurality of terminal slots 220 is positioned within the mating surface 218 in a position to correspond to one of a plurality of battery pack terminals (not shown). The single rail support assembly battery pack interface includes a set of rails (referred to as a set of primary rails) 222 and a set of grooves (referred to as a set of primary grooves) 224.

The set of rails 222 includes at least one and preferably two rails 222a, 222b. Each of the rails 222a, 222b extends laterally (generally perpendicular to the mating direction A and generally parallel to the base surface 216). As illustrated in FIG. 2b, one of the rails 222a is on one side of the battery pack housing 210a and the other rail 222b is on the opposite side of the battery pack housing 210a.

The set of grooves 224 includes at least one and preferably two grooves 224a, 224b. Each of the grooves 224a, 224b is defined by a space between a corresponding rail 222a, 222b and the base surface 216. As illustrated in FIG. 2b, one of the grooves 224a is on one side of the battery pack housing 210a and the other groove 224b is one the opposite side of the battery pack housing 210a. The rails 222a, 222b and the corresponding grooves 224a, 224b define, in part, the single rail interface that is compatible to mate (couple) with either a single rail support assembly electric tool or a dual rail support assembly electric tool.

The set of rails 222a, 222b are further defined by primary rail side walls 226a, 226b, rail top walls 230a, 230b, and rail bottom walls 232a, 232b, which are the top walls 232a, 232b of the grooves 224a, 224b. The set of grooves 224a, 224b are further defined by groove side walls 228a, 228b, groove top walls 232a, 232b, which are the bottom walls 232a, 232b of the rails 222a, 222b, and the groove rear walls 234a, 234b. The battery pack housing 210a is also further defined by a housing rear wall 236.

As illustrated in FIG. 2a, a length dimension WL defines a length distance from the battery pack housing rear wall 236 to the mating surface 218. A length dimension XL defines a length distance from the rear wall 234a, 234b of the grooves 224a, 224b to the mating surface 218. Referring also to FIG. 2b, a height dimension XH defines a height distance from the base surface 216 to the rail bottom wall/groove top wall 232a, 232b. A height dimension WH defines a height distance from the rail bottom wall 232a, 232b to the rail top wall 230a, 230b. As illustrated in FIG. 2b, a width dimension WW defines a width distance from the rail side wall 226a to the rail side wall 226b. A width dimension XW defines a width distance from the groove side wall 228a to the groove side wall 228b.

FIGS. 3a-3d illustrate a first example embodiment of a power tool 300a1 of the power tool system of FIG. 1. The power tool 300a1 includes an example of a basic power tool rail interface. FIG. 3a illustrates a section, right side view, FIG. 3b illustrates a front view, FIG. 3c illustrates a section, rear isometric view, and FIG. 3d illustrates an isometeric, bottom front view of the basic power tool rail interface. The power tool 300a1 includes a housing 310a. The power tool 300a1 includes an interface for mating (coupling) with a corresponding interface of a battery pack 200a1, as described above with respect to FIGS. 2a-2d and described below with respect to FIGS. 4a-4d. When mating (coupling) the power tool 300a1 with a battery pack, the power tool 300a1 will receive the battery pack in a mating direction indicated by the arrow labeled A.

The interface of the power tool 300a1 will be referred to as a basic interface or a primary rail support assembly interface. The tool interface includes a tool shroud (foot) 312a and a tool catch 314. The tool catch 314 engages with the latch 212 on the battery pack 200a1 to maintain the engagement of the battery pack 200a1 within the tool shroud 312a. The tool interface also includes tool horizontal datum plane 316 (or horizontal datum plane), which is approximately parallel to the mating direction A, and a tool vertical datum plane 318 (or vertical datum plane), which is approximately perpendicular to the mating direction A. The horizontal datum plane 316 and the vertical datum plane 318 serve to define the relative position and orientation of various elements of the interface. The tool shroud 312a includes a set of power tool terminals 320. Each of the plurality of terminals 320 extends from and are generally perpendicular to the vertical datum plane 318 and are approximately perpendicular to the horizontal datum plane 316. The single rail support assembly tool interface includes a set of tool grooves 322 (referred to as a set of primary grooves), and a set of tool rails 324 (referred to as a set of primary rails).

The set of tool rails 324 includes at least one rail and preferably two tool rails 324a, 324b. Each of the tool rails 324a, 324b extends laterally (generally perpendicular to the mating direction A and generally parallel to the horizontal datum plane 316). As illustrated in FIG. 3b, one of the tool rails 324a is on one side of the tool shroud 312 and the other tool rail 324b is on the opposite side of the tool shroud 312.

The tool shroud 312 defines tool groove side walls 326a, 326b and tool rail side walls 328a, 328b. The tool shroud 312 defines tool groove top walls 330a, 330b. The tool shroud 312 also defines tool rail top walls 332a, 332b, which also define and may be referred to as tool groove bottom walls 332a, 332b. The tool rails 324a, 324b each include a tool rail front wall 334a, 334b. The tool housing 310a also defines a tool housing front wall 336.

The set of grooves 322 includes at least one and preferably two grooves 322a, 322b. Each of the grooves 322a, 322b is defined by a space between a corresponding rail 324a, 324b and the tool groove top walls 330a, 330b. As illustrated in FIG. 3b, one of the grooves 322a is on one side of the tool shroud 312 and the other groove 322b is on the opposite side of the tool shroud 312. The tool rails 324a, 324b and the tool grooves 322a, 322b define the single rail interface that is compatible to mate (couple) with either a single rail support assembly battery pack interface or a dual rail support assembly battery pack interface.

As illustrated in FIG. 3a, a length dimension WL defines a length distance from the tool housing front wall 336 to the vertical datum plane 318. A length dimension XL defines a length distance from the tool rail front walls 334a, 334b to the vertical datum plane 318. Referring also to FIG. 3b, a height dimension XH defines a height distance from the horizontal datum plane 316 to the tool rail top walls 332a, 332b. A height dimension WH defines a height distance from the tool rail top walls 332a, 332b to the tool groove top walls 330a, 330b. In FIG. 3b, a width dimension WW defines a width distance between the tool groove side walls 326a, 326b. A width dimension XW defines a width distance between the tool rail side walls 328a, 328b.

The dimensions WL, XL, WW, XW, WH, and XH in FIGS. 2a and 2b match and are approximately equal to the same corresponding dimensions WL, XL, WW, XW, WH, and XH in FIGS. 3a and 3b. The matching dimensions enable the battery pack 200a1 to mate with the power tool 300a1. With additional details regarding the dimensions, each rail 222a, 222b ends at a rail lateral wall 226. There is a distance (dimension) WW between the lateral wall 226a of the rail 222a and the lateral wall 226b of the rail 222b. The height dimension WH of the rails 222a, 222b is in a direction generally perpendicular to the base surface 216. Also, each groove 224a, 224b ends at a lateral wall 228a, 228b, respectively. The groove lateral walls 228a, 228b connect the rails 224a, 224b and the base surface 216. There is a distance (dimension) XW between the lateral wall 228a of the groove 224a and the lateral wall 228b of the groove 224b. There is also a height dimension XH of the grooves 224a, 224b in a direction generally perpendicular to the base surface 216.

Referring also to FIGS. 4a-4d, FIG. 4a illustrates a combination of the battery pack 200a1 of FIGS. 2a-2d and the power tool 300a1 of FIGS. 3a-3d in a mated or coupled state. FIG. 4a illustrates a side view and FIG. 4b illustrates a cross-section front view taken along the line A-A of FIG. 4a of the combination. FIG. 4c illustrates a partial cut-away isometric view and FIG. 4d illustrates an isometric view of the combination.

As illustrated in more detail in FIGS. 4a-4d, the battery pack rails 222a, 222b are sized to fit in the power tool grooves 322a, 322b. The battery pack rails 222a, 222b slide within and along the power tool grooves 322a, 322b until the battery pack vertical datum plane 218 stops at the power tool vertical datum plane 318, and vice versa. Similarly, the power tool rails 324a, 324b are sized to fit within the battery pack grooves 224a, 224b. The power tool rails 324a, 324b slide within and along the battery pack grooves 224a, 224b until the battery pack vertical datum plane 218 stops at the power tool vertical datum plane 318, and vice versa. The battery pack latch 212 engages with the power tool catch 314 to hold the battery pack 200a1 within the tool shroud 312.

The tool horizontal datum plane 316 mates with and rests on the battery pack base surface 216. The power tool housing front wall 336a is approximately flush with and forms an approximate vertical plane with the battery pack housing rear wall 236a.

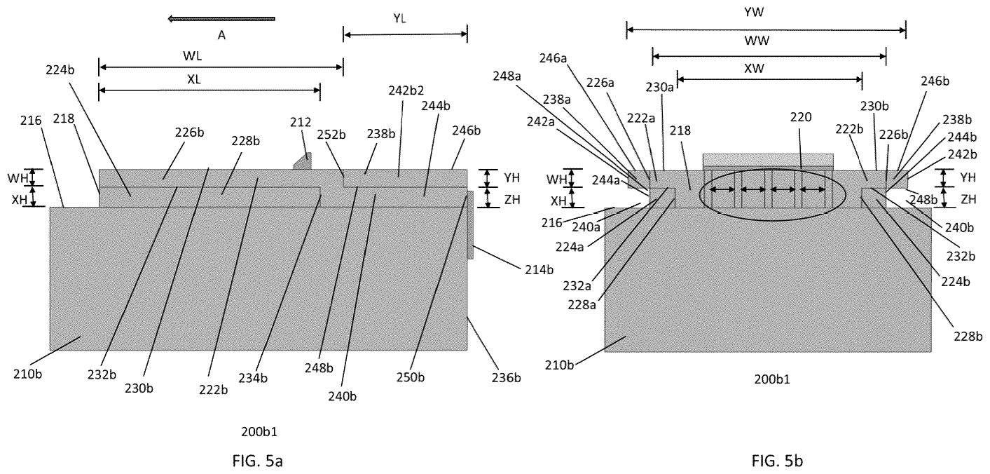

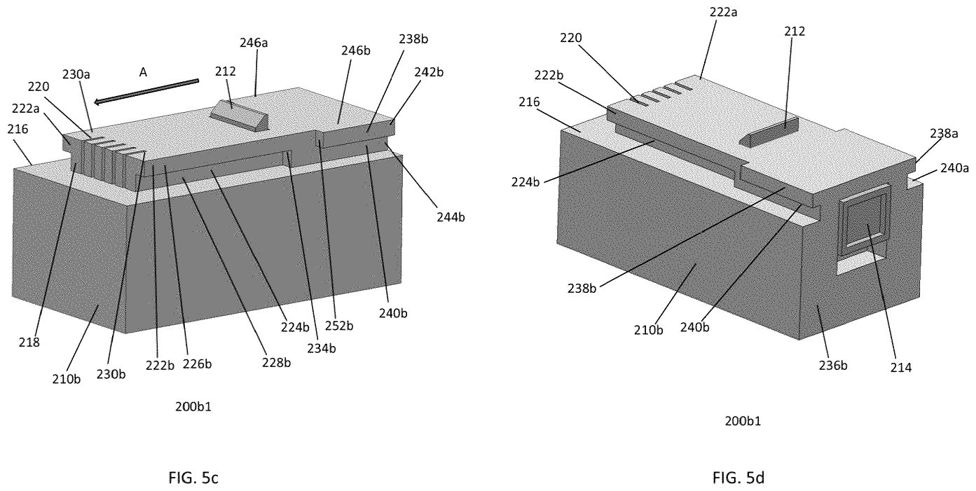

FIGS. 5a-5d illustrate a first example embodiment of a dual rail battery pack 200b1 of the power tool system of FIG. 1 including a primary and a secondary interface element. Referring to FIGS. 5a-5d, an example embodiment of a dual (double) rail battery pack interface is illustrated. The battery pack 200b1 has two sets of rails including a first set of rails 222a, 222b and a second set of rails 238a, 238b. The battery pack 200b1 includes two corresponding sets of grooves including a first set of grooves 224a, 224b and a second set of grooves 240a, 240b. The dual rail support assembly battery pack interface is compatible with both a single rail interface power tool, such as power tool 300a1 of FIGS. 3a-3d, and a dual rail interface power tool (described below in detail). The dual rail support assembly battery pack interface provides additional structural support to hold the battery pack and keep the battery pack mated within the power tool. The battery pack 200b1 includes the same features of the single rail interface battery pack 200a1 of FIGS. 2a-2d—in the form of a first or a primary rail support assembly—plus additional features that relate to the second set of rails 238a, 238b and the corresponding second set of grooves 240a, 240b—the second or secondary rail support assembly. The reference numbers to the single rail interface features are common to both the single rail interface battery pack 200a1 and the dual rail interface battery pack 200b1. The description of those common features may be found above with respect to FIGS. 2a-2d. In this example embodiment, the battery pack housing is reference 210b.

The second set of rails 238a, 238b and second set of grooves 240a, 240b include rail side walls 242a, 242b, groove side walls 244a, 244b, rail top walls 246a, 246b, rail bottom walls/groove top walls 248a, 248b, groove rear walls/plane 250a, 250b, and rail front walls 252a, 252b. The battery pack 200b1 includes a length dimension YL that defines a length distance from the second rail front walls 252a, 252b to the second groove rear walls/planes 250a, 250b. In this example embodiment, the second set of rails 238a, 238b and the first set of rails 222a, 222b are generally in a single (or same) plane As illustrated in FIG. 5b, as width dimension YW, with respect to the second set of rails, defines a width distance from the second rail side wall 242a to the second rail side wall 242b. The additional surface area provided by the addition of the second set of rails 238a, 238b to the battery pack 200b1 is one feature to enable the structural support for holding the battery pack within the power tool. A second rail height dimension YH defines a height distance from the rail top walls 246a, 246b to the rail bottom walls/groove top walls 248a, 248b. A second groove height dimension ZH defines a height distance from the rail bottom walls/groove top walls 248a, 248b to the base surface 216. In this example embodiment, the second rail height dimension YH and the second groove height dimension ZH are the same as the WH and XH height dimensions, respectively.

The second set of rails 238a, 238b and the second set of grooves 240a, 240b may start (originate, emanate) at the housing rear wall 236b, which is further back by a distance YL than the housing rear wall 236a of the single rail support assembly battery pack 200a1 of FIGS. 2a-2d. The first set of rails 222a, 222b and the first set of grooves 224a, 224b may start (originate, emanate) forward of the housing rear wall 236b and forward of the second rail front walls 252a, 252b. In this example, the first set of rails 222a, 222b and the first set of grooves 224a, 224b do not overlap, in the length dimension, with the second set of rails 238a, 238b and the second set of grooves 240a, 240b.

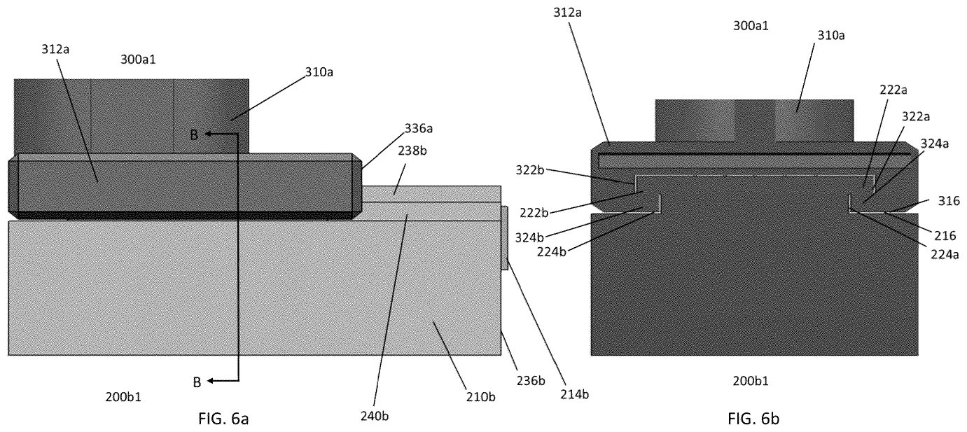

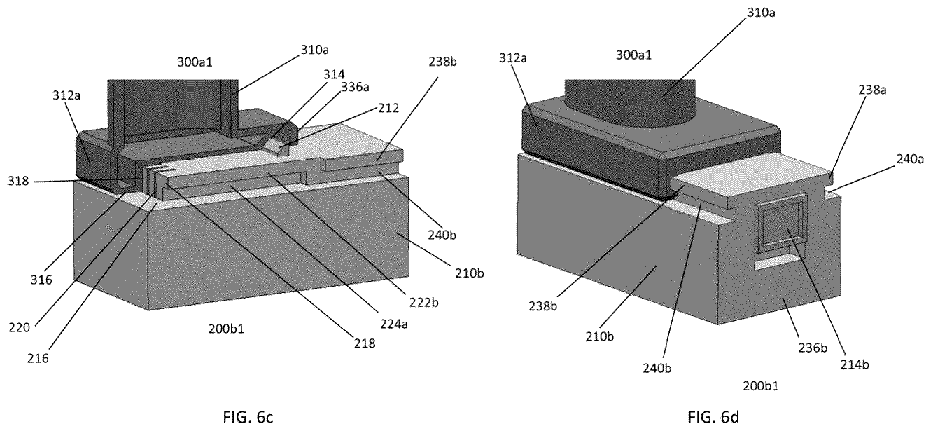

Referring to FIGS. 6a-6d, an example embodiment illustrates a combination of the dual rail support assembly battery pack 200b1 of FIGS. 5a-5d with the single rail support assembly power tool 300a1 of FIGS. 3a-3d. FIG. 6a illustrates a side view and FIG. 6b illustrates a cross-section front view taken along the line B-B of FIG. 6a of the combination. FIG. 6c illustrates a partial, cut-away isometric view and FIG. 6d illustrates an isometric view of the combination. In this example, the tool shroud 312a does not cover or engage with the second set of rails 238a, 238b and the second set of grooves 240a, 240b. The latch 212 engages with the tool catch 314, both of which are in a same relative location to each other.

As illustrated in FIGS. 6a-6d, and similarly to FIGS. 4a-4d, the primary battery pack rails 222a, 222b are sized to fit in the power tool grooves 322a, 322b. The primary battery pack rails 222a, 222b slide within and along the power tool grooves 322a, 322b until the battery pack vertical datum plane 218 stops at the power tool vertical datum plane 318, and vice versa. Similarly, the power tool rails 324a, 324b are sized to fit within the primary battery pack grooves 224a, 224b. The power tool rails 324a, 324b slide within and along the primary battery pack grooves 224a, 224b until the battery pack vertical datum plane 218 stops at the power tool vertical datum plane 318, and vice versa. The battery pack latch 212 engages with the power tool catch 314 to hold the battery pack 200a1 within the tool shroud 312.

FIGS. 7a-7d illustrate a first example embodiment of a dual rail power tool of the power tool system of FIG. 1 including a primary interface element and a secondary interface element. Referring to FIGS. 7a-7d, an example embodiment of a dual rail support assembly power tool interface is illustrated. The power tool 300b1 has two sets of rails including a first (primary) set of rails 324a, 324b and a second (secondary) set of rails 340a, 340b. The power tool 300b1 includes two corresponding sets of grooves including a first (primary) set of grooves 322a, 322b and a second (secondary) set of grooves 338a, 338b. The power tool 300b1 includes the same features of the single rail interface power tool 300a1 of FIGS. 3a-3d—in the form of a first (primary) rail support assembly—plus additional features that relate to the second set of rails 340a, 340b and the second set of grooves 338a, 338b—the second (secondary) rail support assembly. The reference numbers to the primary rail support assembly interface features are common to both the single rail interface power tool 300a1 and the dual rail interface power tool 300b1. The description of those common features may be found above with respect to FIGS. 3a-3d. The tool housing is referenced as reference number 310b and the tool shroud is referenced as reference number 312b.

The second set of rails 340a, 340b and the second set of grooves 338a, 338b include tool groove side walls 342a, 342b, tool rail side walls 344a, 344b, tool groove top walls/rails bottom walls 346a, 346b, tool rail top walls/tool groove bottom walls 348a, 348b, tool groove rear walls 350a, 350b, and tool rail front walls 352a, 352b. In this example embodiment, the second set of tool rails 340a, 340b are in a same horizontal plane as the first set of tool rails 324a, 324b. The tool shroud 312b of FIGS. 7a-7d is longer than the tool shroud 312a of FIGS. 300a-300d. As illustrated in FIG. 7a, the tool 300b1 includes a length dimension YL that is defines a distance from the tool groove rear wall plane 350a, 350b to the tool rail front wall 352a, 352b. The additional length distance is the same length distance for the secondary rail 238a, 238b of the battery pack 200b1 of FIGS. 5a-5d. A tool groove height dimension YH for the second set of tool grooves 338a, 338b may be the same as the groove height dimension WH for the first set of tool grooves 322a, 322b. A tool rail height dimension ZH for the second set of tool rails 340a, 340b may be the same as the tool height XH for the first set of tool rails 324a, 324b. A width dimension ZW defines a width distance of the second set of tool grooves 338a, 338b across the tool shroud 312b from the tool groove side wall 342a to the tool groove side wall 342b.

Referring to FIGS. 8a-8d, there is illustrated a combination of the example single rail interface battery pack 200a1 of FIGS. 2a-2d and the example dual rail support assembly power tool 300b1 of FIGS. 7a-7d. FIG. 8a illustrates a side view and FIG. 8b illustrates a cross-section front view taken along the line C-C of FIG. 8a of the combination. FIG. 8c illustrates a partial cut-away isometric view and FIG. 8d illustrates an isometric view of the combination. In this example, the tool shroud 312b extends beyond the battery pack 200a1. The latch 212 engages with the tool catch 314, both of which are in a same relative location to each other.

As illustrated in FIGS. 8a-8d, the (basic) battery pack rails 222a, 222b are sized to fit in the primary power tool grooves 322a, 322b. The basic battery pack rails 222a, 222b slide within and along the primary power tool grooves 322a, 322b until the battery pack vertical datum plane 218 stops at the power tool vertical datum plane 318, and vice versa. Similarly, the primary power tool rails 324a, 324b are sized to fit within the basic battery pack grooves 224a, 224b. The primary power tool rails 324a, 324b slide within and along the basic battery pack grooves 224a, 224b until the battery pack vertical datum plane 218 stops at the power tool vertical datum plane 318, and vice versa. The battery pack latch 212 engages with the power tool catch 314 to hold the battery pack 200a1 within the tool shroud 312.

In FIGS. 8a-8d, the second set of tool rails 340a, 340b and the second set of tool grooves 338a, 338b are not utilized to hold the battery pack 200a1.

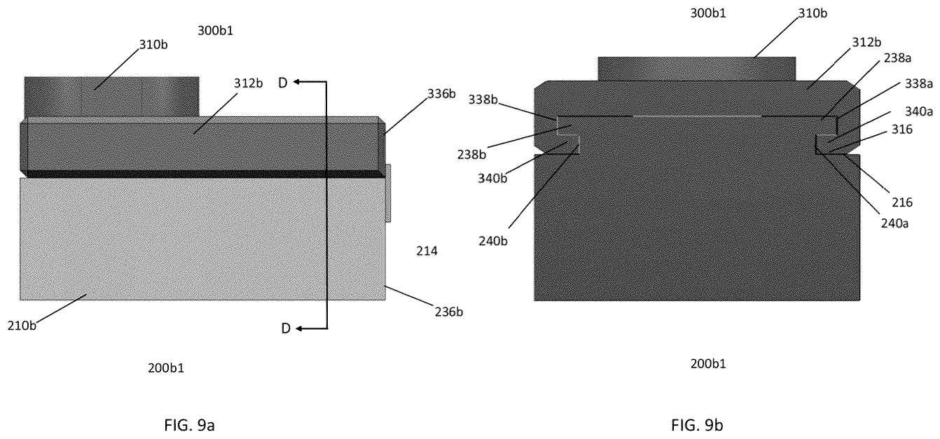

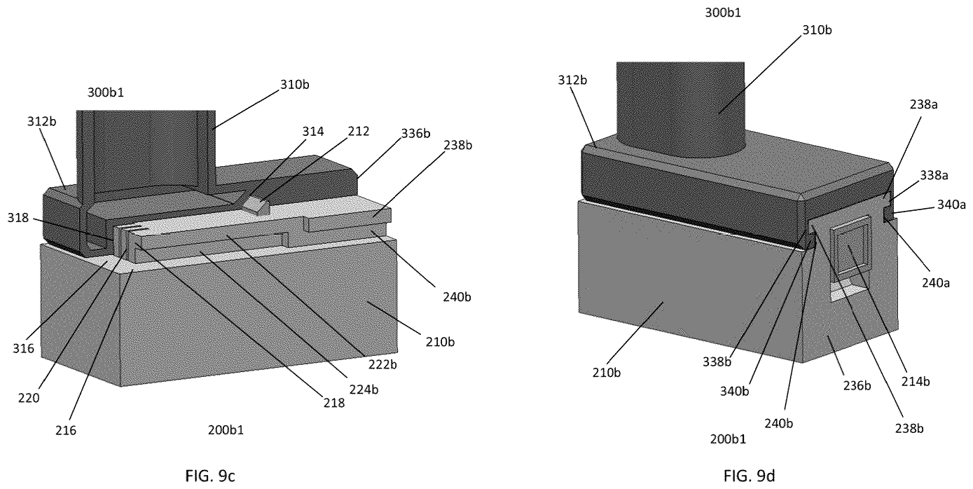

Referring to FIGS. 9a-9d, there is illustrated a combination of the example dual rail interface battery pack 200b1 of FIGS. 5a-5d with the example dual rail support assembly power tool 300b1 of FIGS. 7a-7d. FIG. 9a illustrates a side view and FIG. 9b illustrates a cross-section front view taken along the line D-D of FIG. 9a of the combination. FIG. 9c illustrates a partial, cut-away isometric view and FIG. 9d illustrates an isometric view of the combination. In this example, the tool shroud 312b covers and receive the entire battery pack 200b1. The latch 212 engages with the tool catch 314, both of which are in a same relative location to each other.

As illustrated in FIGS. 9a-9d, the primary battery pack rails 222a, 222b and the secondary battery pack rails 238a, 238b are sized to fit and be received in the primary power tool grooves 322a, 322b and the secondary power tool grooves 338a, 338b, respectively. The primary battery pack rails 222a, 222b and the secondary battery pack rails 238a, 238b slide within and along the primary power tool grooves 322a, 322b and the secondary power tool grooves 338a, 338b, respectively until the battery pack vertical datum plane 218 stops at the power tool vertical datum plane 318, and vice versa. Similarly, both the primary power tool rails 324a, 324b and the secondary power tool rails 340a, 340b are sized to fit and be received in the primary battery pack grooves 224a, 224b and the secondary battery pack grooves 240a, 240b, respectively. The primary power tool rails 324a, 324b and the secondary power tool rails 340a, 340b slide within and along the primary battery pack grooves 224a, 224b and the secondary battery pack grooves 240a, 240b, respectively until the battery pack vertical datum plane 218 stops at the power tool vertical datum plane 318, and vice versa. The battery pack latch 212 engages with the power tool catch 314 to hold the battery pack 200a1 within the tool shroud 312.

The dimensions WL, XL, YL, WW, XW, YW, WH, XH, and ZH in FIGS. 5a and 5b match and are approximately equal to the same corresponding dimensions WL, XL, YL, WW, XW, YW, WH, XH, and ZH in FIGS. 7a and 7b. The matching dimensions enable the battery pack 200b1 to mate with the power tool 300b1.

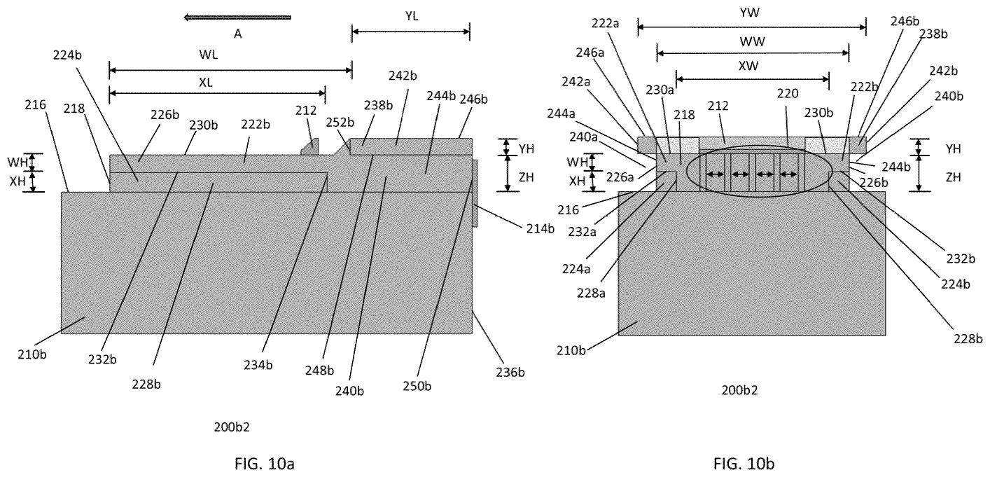

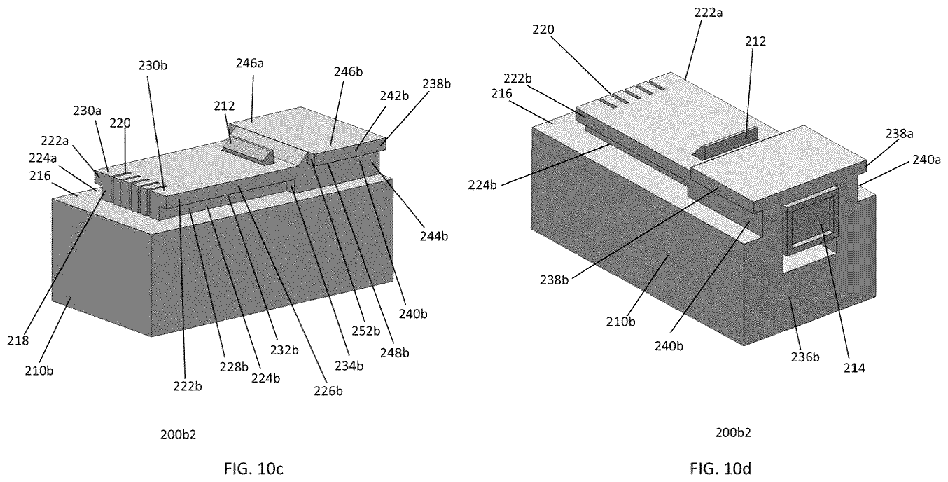

FIGS. 10a-10d illustrate a second example embodiment of a dual rail battery pack of the power tool system of FIG. 1 including a primary interface element and a secondary interface element. Referring to FIGS. 10a-10d, a second embodiment of a dual rail interface battery pack 200b2 is illustrated. In this example, the dual rail interface battery pack 200b2 is similar to the dual rail interface battery pack 200b1 with at least one difference being that in the battery pack 200b2 the second set of rails 238a, 238b are in a different horizontal plane that the first set of rails 222a, 222b. In this example, the second set of rails 238a, 238b are on a higher plane relative to the base surface 216 than the first set of rails 222a, 222b. In other words, the second set of rails 238a, 238b are further from the base surface 216 than the first set of rails 222a, 222b. Additionally, the groove height dimension ZH for the second set of grooves 240a, 240b is greater than the groove height dimension XH for the first set of grooves 224a, 224b. The dual rail interface battery pack 200b2 with the sets of rails on different planes and with one set of grooves having a dimension that is greater than the dimension of another set of grooves so that the battery pack may accommodate power tools of different sizes including tools that have a larger tool shroud.

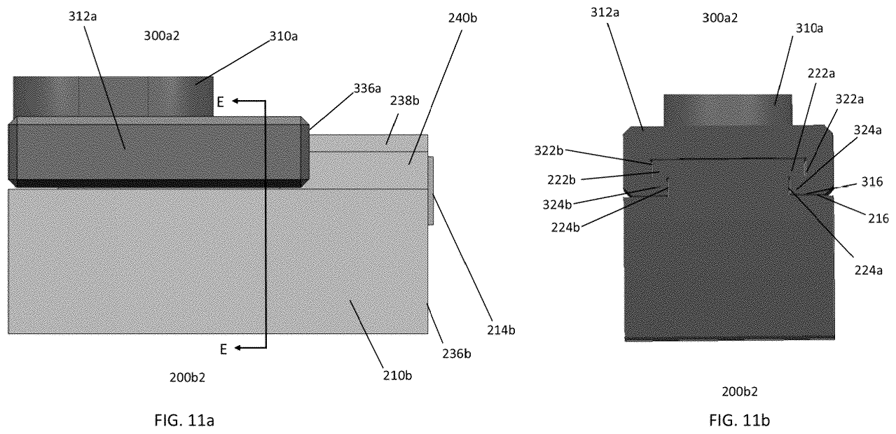

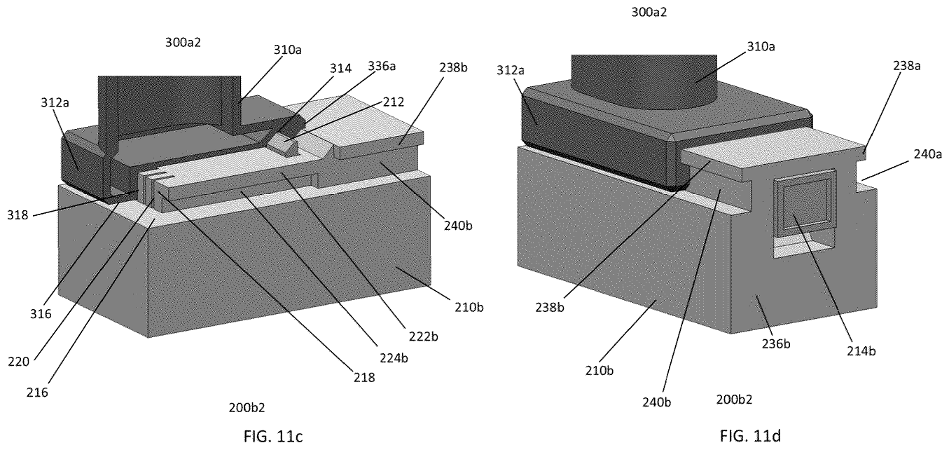

FIGS. 11a-11d illustrate a combination of the dual rail battery pack of FIGS. 10a-10d and the power tool of FIGS. 3a-3d. The dual rail interface battery pack 200b2 is compatible with a single rail interface power tool such as the single rail interface power tool 300a2 as illustrated in FIGS. 11a-11d. FIG. 11a illustrates a side view and FIG. 11b illustrates a cross-section front view taken along the line E-E of FIG. 11a of the combination. FIG. 11c illustrates a partial, cut-away isometric view and FIG. 11d illustrates an isometric view of the combination. The single rail interface power tool 300a2 includes the same features as described above with respect to the single rail interface power tool 300a1. The power tool 300a2 engages with the dual rail interface battery pack 200b2 using the first set of rails 222a, 222b and the first set of grooves 224a, 224b on the battery pack and not the second set of rails 238a, 238b and grooves 240a, 240b.

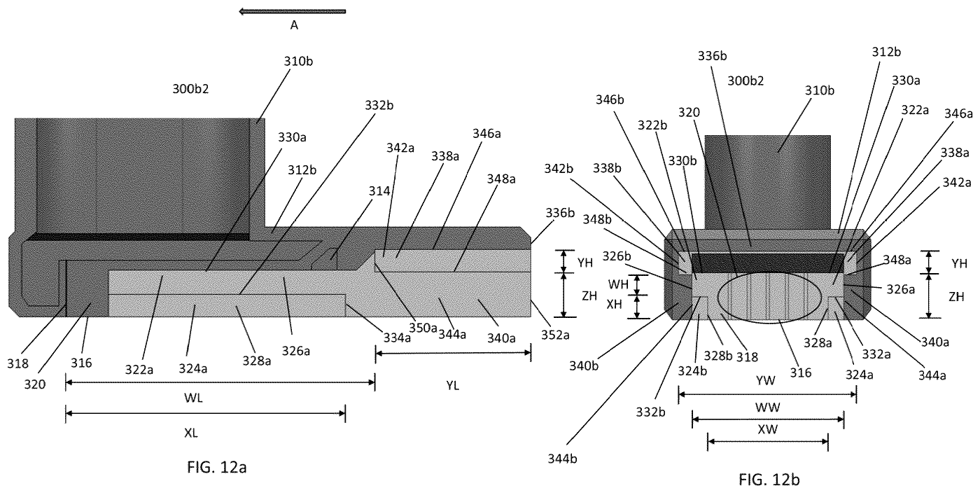

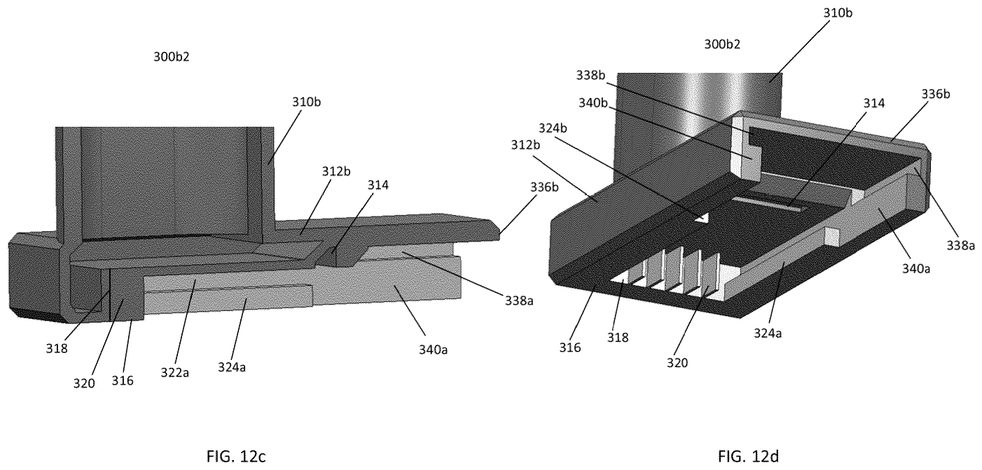

FIGS. 12a-12d illustrate a second example embodiment of a dual rail interface power tool 300b2 that is compatible with both a single rail interface battery pack and a dual rail interface battery pack. In the example of FIGS. 12a-12d, the top walls 348a, 348b of the second set of rails 340a, 340b are on a different plane than the top walls 332a, 332b of the first set of rails 324a, 324b. Additionally, the rail height dimension ZH for the second set of rails 340a, 340b is greater than the rail height dimension XH of the first set of rails 324a, 324b. The first set of rails 324a, 324b and the first set of grooves 322a, 322b may remain unchanged from the previous embodiments of the single rail interface power tools 300a1, 300a2 and the dual rail interface power tool 300b1.

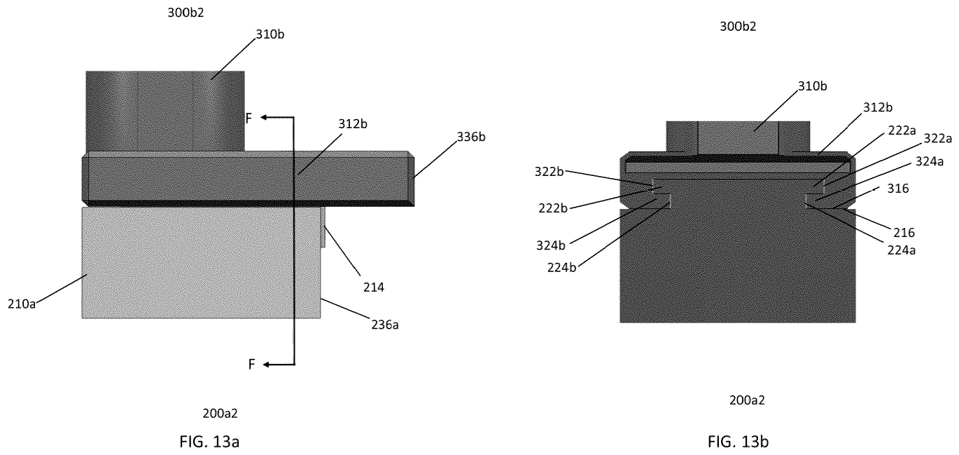

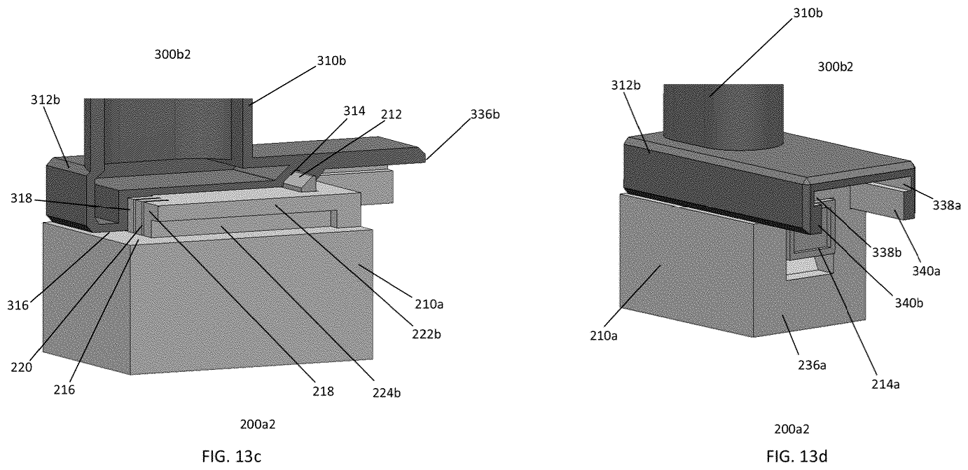

FIGS. 13a-13d illustrate a combination of the single rail battery pack of FIGS. 2a-2d and the dual rail power tool of FIGS. 12a-12d. Referring also to FIGS. 13a-13d, the dual rail interface power tool 300b2 is compatible with the single rail interface battery pack 200a2. FIG. 13a illustrates a side view and FIG. 13b illustrates a cross-section front view taken along the line F-F of FIG. 13a of the combination. FIG. 13c illustrates a partial, cut-away isometric view and FIG. 13d illustrates an isometric view of the combination. In this example, the tool shroud 312b extends beyond the battery pack 200a2. The latch 212 engages with the tool catch 314, both of which are in a same relative location to each other.

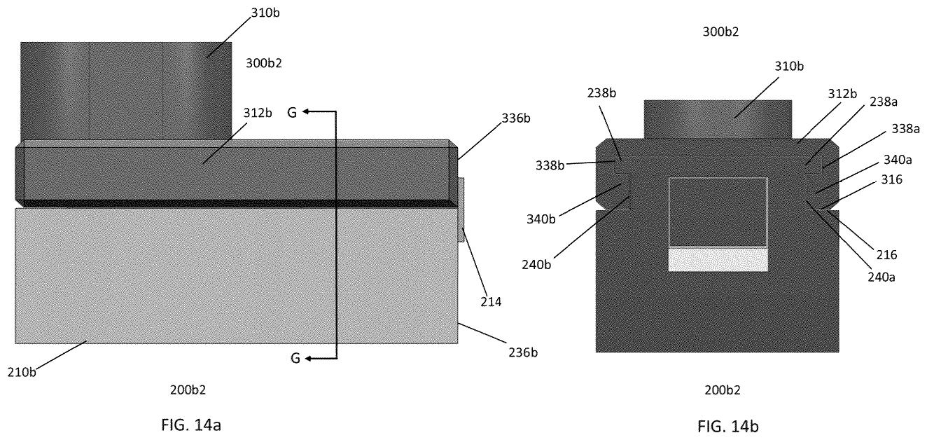

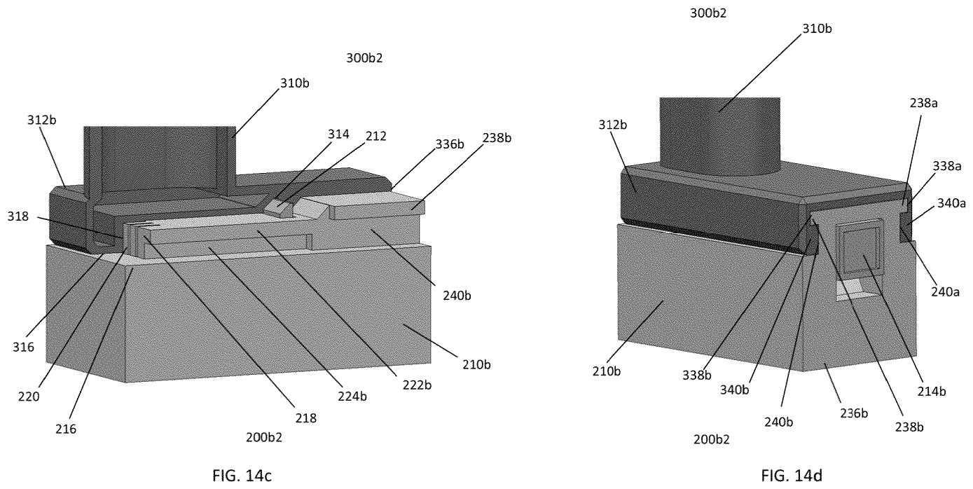

FIGS. 14a-14d illustrate a combination of the dual rail battery pack of FIGS. 10a-10d and the dual rail power tool of FIGS. 12a-12d. Referring to FIGS. 14a-14d, the dual rail interface power tool 300b2 is compatible with the dual rail interface battery pack 200b2. FIG. 14a illustrates a side view and FIG. 14b illustrates a cross-section front view taken along the line G-G of FIG. 14a of the combination. FIG. 14c illustrates a partial, cut-away isometric view and FIG. 14d illustrates an isometric view of the combination. In this example, the tool shroud 312b covers and receive the entire battery pack 200b2. The latch 212 engages with the tool catch 314, both of which are in a same relative location to each other.

As illustrated in FIGS. 14a-14d, both the primary battery pack rails 222a, 222b and the secondary battery pack rails 238a, 238b are sized to fit and be received in the primary power tool grooves 322a, 322b and secondary power tool grooves 338a, 338b, respectively. The primary battery pack rails 222a, 222b and the secondary battery pack rails 238a, 238b slide within and along the primary power tool grooves 322a, 322b and the secondary power tool grooves 338a, 338b, respectively until the battery pack vertical datum plane 218 stops at the power tool vertical datum plane 318, and vice versa. Similarly, both the primary power tool rails 324a, 324b and secondary power tool rails 340a, 340b are sized to fit and be received in the primary battery pack grooves 224a, 224b and secondary battery pack grooves 240a, 240b, respectively. The primary power tool rails 324a, 324b and secondary power tool rails 340a, 340b slide within and along the primary battery pack grooves 224a, 224b and the secondary battery pack grooves 240a, 240b, respectively until the battery pack vertical datum plane 218 stops at the power tool vertical datum plane 318, and vice versa. The battery pack latch 212 engages with the power tool catch 314 to hold the battery pack 200a1 within the tool shroud 312.

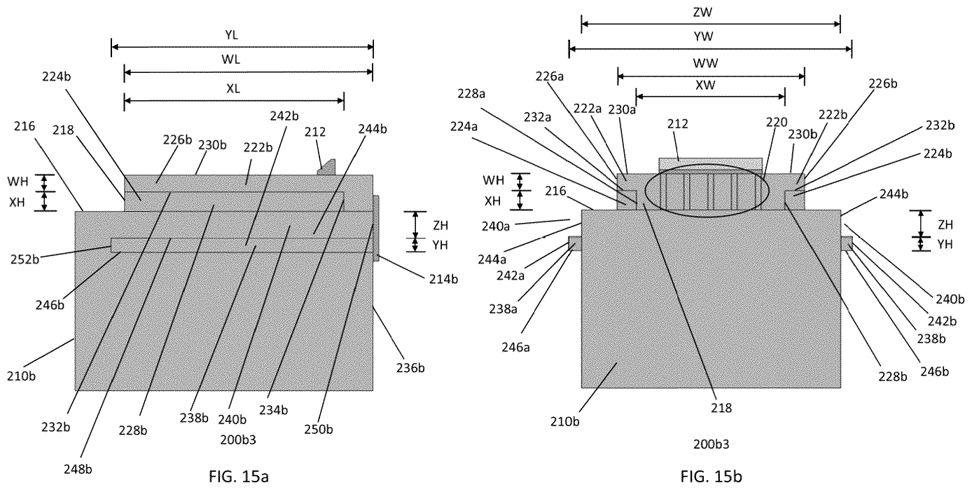

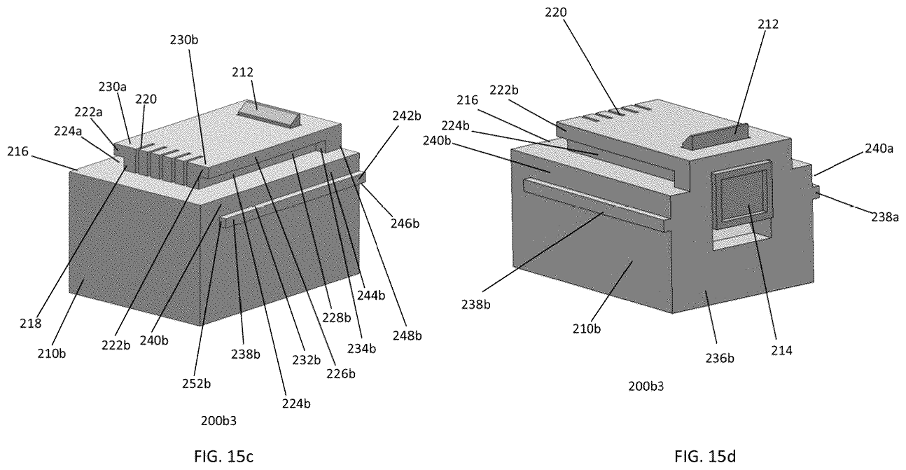

Referring to FIGS. 15a-15d, a third embodiment of a dual rail interface battery pack 200b3 is illustrated. In this example, the dual rail interface battery pack 200b3 includes the second set of rails 238a, 238b on each side of the battery pack housing 210b. Similarly, the second set of grooves 240a, 240b is above the second set of rails having a height ZH. In this example, the first set of rails 222a, 222b and the first set of grooves remain the same as in previous embodiments. In this example, the second set of rails 238a, 238b is on a lower plane relative to the base surface 216 and on a lower plane relative to the first set of rails 222a, 222b. Additionally, the second set of grooves 240a, 240b are on a different horizontal plane than the first set of grooves 224a, 224b. The second set of grooves 240a, 240b is on a lower plane relative to the base surface 216 and on a lower plane relative to the first set of grooves 224a, 224b. The dual rail interface battery pack 200b3 with the sets of rails on different planes and on each side of the housing 210b may accommodate power tools of different sizes including tools that have a larger tool shroud.

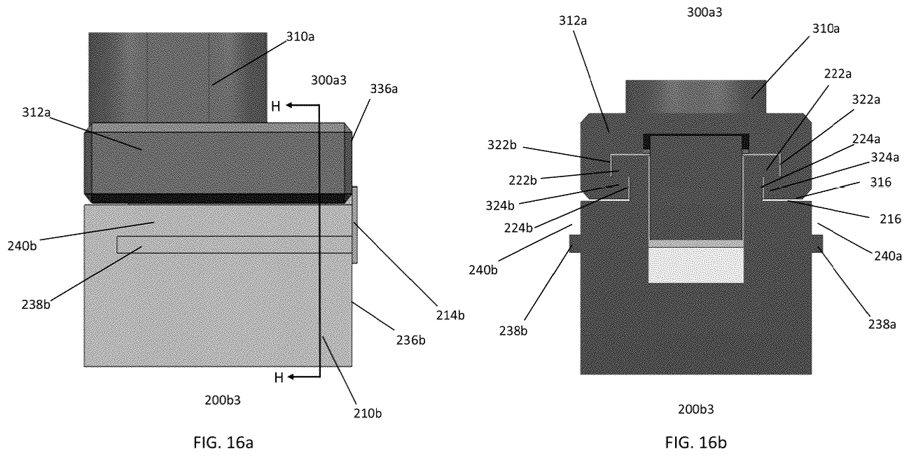

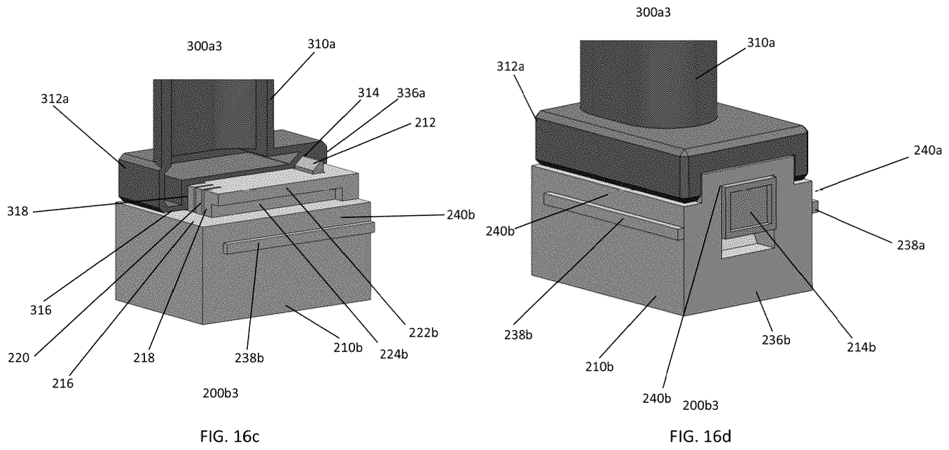

The dual rail interface battery pack 200b3 is compatible with a single rail interface power tool such as the single rail interface power tool 300a3, as illustrated in FIGS. 16a-16d. FIG. 16a illustrates a side view and FIG. 16b illustrates a cross-section front view taken along the line H-H of FIG. 16a of the combination. FIG. 16c illustrates a partial, cut-away isometric view and FIG. 16d illustrates an isometric view of the combination. The single rail interface power tool 300a3 includes the same features as described above with respect to the single rail interface power tool 300a1. The power tool 300a3 engages with the dual rail interface battery pack 200b3 using the first set of rails 222a, 222b and the first set of grooves 224a, 224b on the battery pack and not the second set of rails 238a, 238b and grooves 240a, 240b.

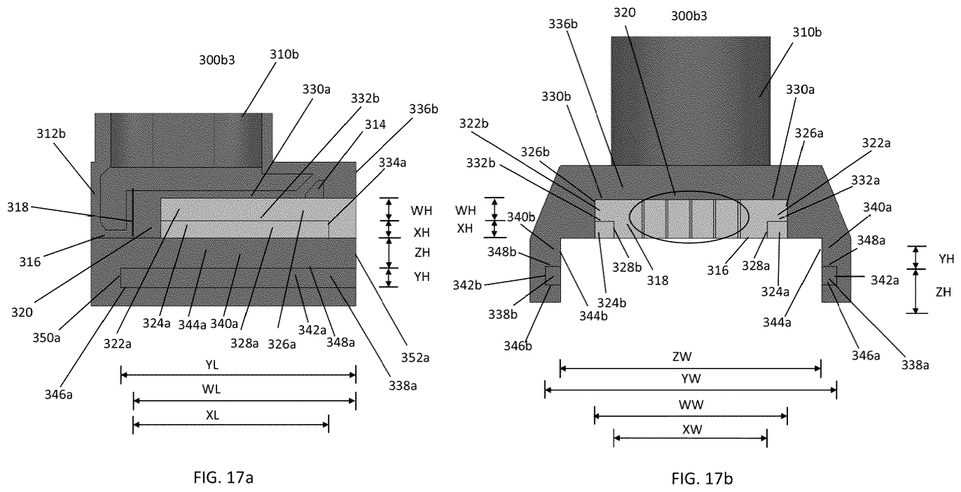

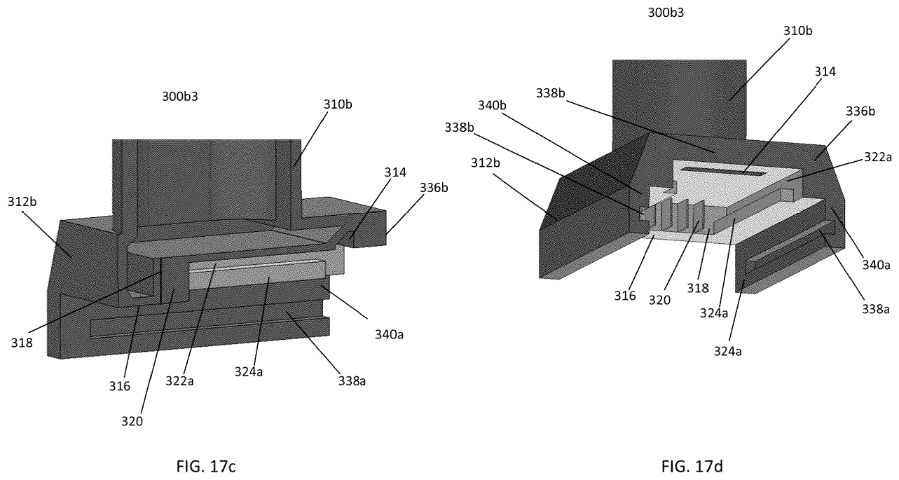

FIGS. 17a-17d illustrate a third example embodiment of a dual rail interface power tool 300b3 that is compatible with both a single rail interface battery pack and a dual rail interface battery pack. In the example of FIGS. 17a-17d, the top walls 348a, 348b of the second set of rails 340a, 340b are on a different plane than the first set of rails 324a, 324b. Additionally, the second set of rails 340a, 340b have a larger height ZH than the height XH of the first set of rails 324a, 324b. The second set of rails 340a, 340b and the second set of grooves 338a, 338b are positioned out wider in the tool shroud 312b than the first set of rails 324a, 324b and the first set of grooves 322a, 322b. The first set of rails 324a, 324b and the first set of grooves 322a, 322b remain unchanged from the previous embodiments of the single rail interface power tools 300a1, 300a2 and the dual rail interface power tools 300b1, 300b2.

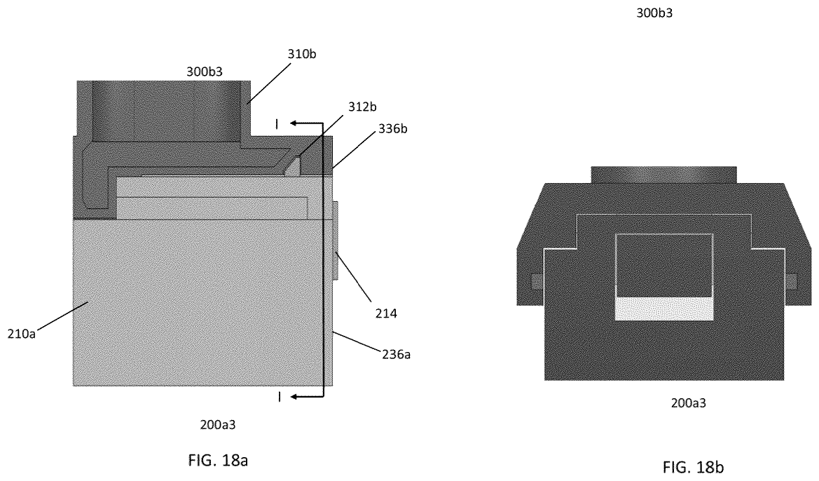

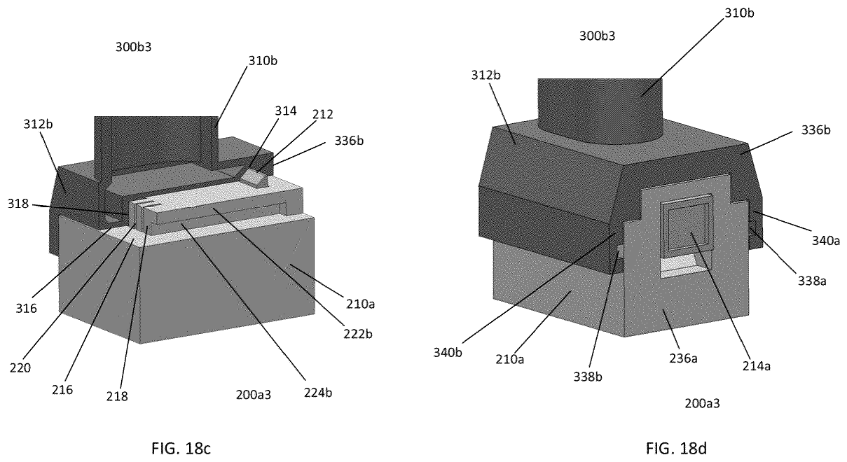

Referring also to FIGS. 18a-18d, the dual rail interface power tool 300b3 is compatible with the single rail interface battery pack 200a3. FIGS. 18a-18d illustrate a combination of the single rail battery pack of FIGS. 2a-2d and the dual rail power tool of FIGS. 17a-17d. Referring also to FIGS. 18a-18d, the dual rail interface power tool 300b3 is compatible with the single rail interface battery pack 200a3. FIG. 18a illustrates a side view and FIG. 18b illustrates a cross-section front view taken along the line I-I of FIG. 18a of the combination. FIG. 18c illustrates a partial, cut-away isometric view and FIG. 18d illustrates an isometric view of the combination. In this example, the tool shroud 312b covers and receives the entire battery pack 200a3. The latch 212 engages with the tool catch 314, both of which are in a same relative location to each other.

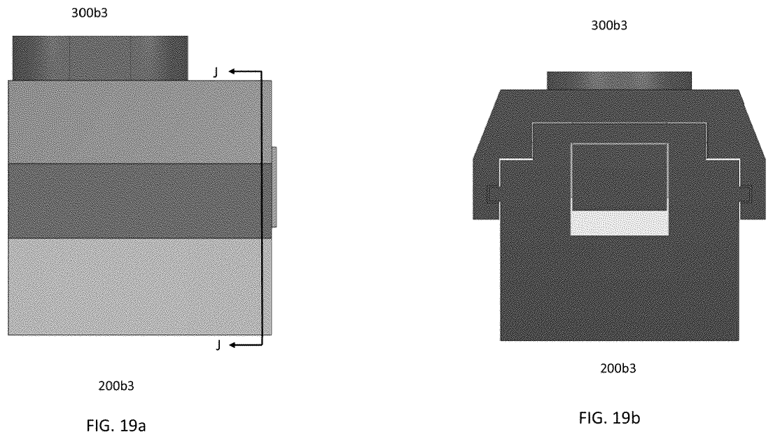

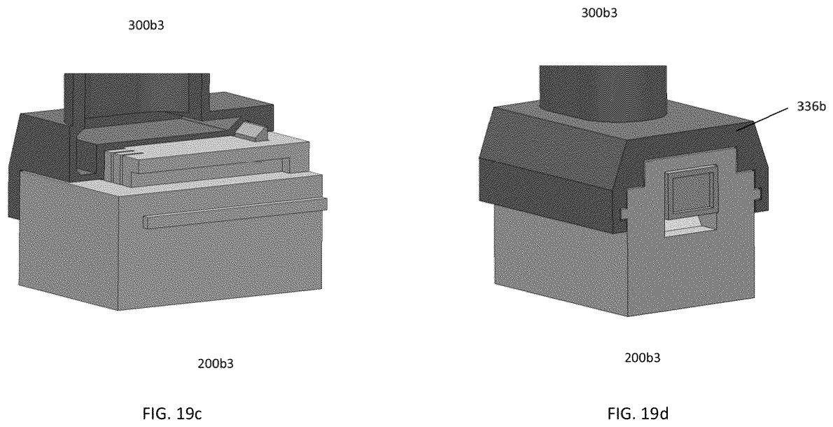

FIGS. 19a-19d illustrate a combination of the dual rail battery pack of FIGS. 15a-15d and the dual rail power tool of FIGS. 17a-17d. Referring to FIGS. 19a-19d, the dual rail interface power tool 300b3 is compatible with the dual rail interface battery pack 200b3. FIG. 19a illustrates a side view and FIG. 19b illustrates a cross-section front view taken along the line J-J of FIG. 19a of the combination. FIG. 19c illustrates a partial, cut-away isometric view and FIG. 19d illustrates an isometric view of the combination. In this example, the tool shroud 312b covers and receives the entire battery pack 200b3. The latch 212 engages with the tool catch 314, both of which are in a same relative location to each other.

As illustrated in FIGS. 19a-19d, the primary battery pack rails 222a, 222b and secondary battery pack rails 238a, 238b are sized to fit in the primary power tool grooves 322a, 322b and secondary power tool grooves 338a, 338b, respectively. The primary battery pack rails 222a, 222b and the secondary battery pack rails 238a, 238b slide within and along the primary power tool grooves 322a, 322b and secondary power tool grooves 338a, 338b, respectively until the battery pack vertical datum plane 218 stops at the power tool vertical datum plane 318, and vice versa. Similarly, the primary power tool rails 324a, 324b and the secondary power tool rails 340a, 340b are sized to fit and be received in the primary battery pack grooves 224a, 224b and secondary battery pack grooves 240a, 240b, respectively. The primary power tool rails 324a, 324b and secondary power tool rails 340a, 340b slide within and along the primary battery pack grooves 224a, 224b and the secondary battery pack grooves 240a, 240b, respectively until the battery pack vertical datum plane 218 stops at the power tool vertical datum plane 318, and vice versa. The battery pack latch 212 engages with the power tool catch 314 to hold the battery pack 200a1 within the tool shroud 312. In this example, the opening width of the tool shroud 312 accommodates the width of the battery pack 200b3 with the second set of grooves 240a, 240b on the side of the battery pack housing 210b.

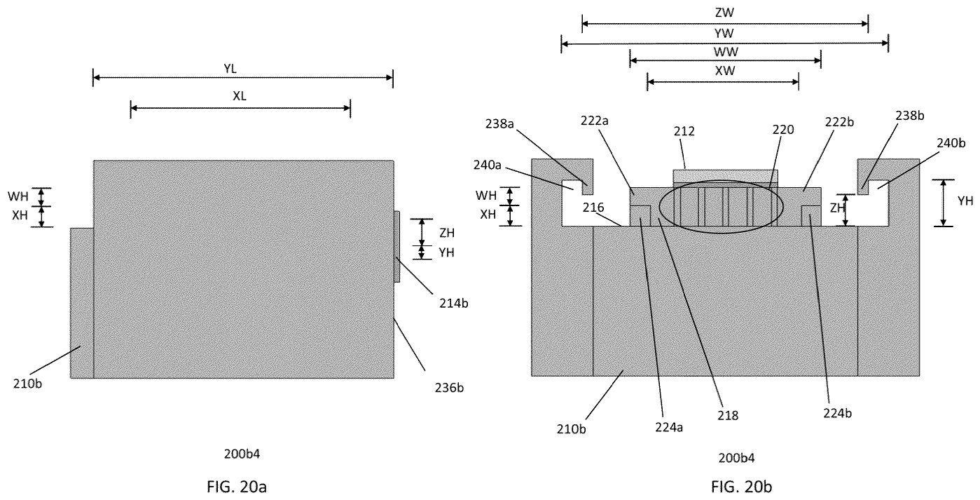

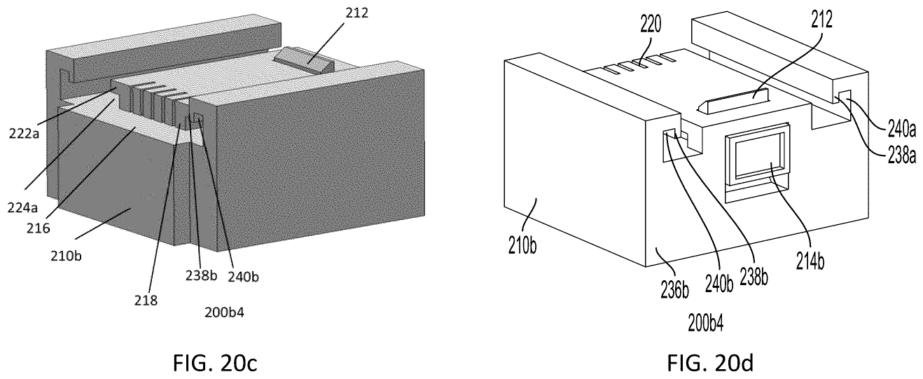

Referring to FIGS. 20a-20d, a fourth example embodiment of a dual rail interface battery pack 200b4 is illustrated. In this example, the dual rail interface battery pack 200b4 includes the second set of rails 238a, 238b on each side of the battery pack housing 210b and a second set of grooves 240a, 240b, which form an L-shaped hook. In contrast to the previous embodiments, in this embodiment, the rails 238a, 238b and the grooves 240a, 240b are side-by-side and adjacent to each other instead of the rails on top of the grooves. The bottom walls of the grooves 240a, 240b are in a same plane as the base surface 216 and the bottom walls of the grooves 224a, 224b. The bottom wall of the rails 238a, 238b are a height distance ZH above the base surface 216. In this example, the first set of rails 222a, 222b and the first set of grooves 224a, 224b remain the same as in previous embodiments. In this example, the second set of rails 238a, 238b are perpendicular with respect to the base surface 216, as seen by the formed L-shape. The second set of rails 238a, 238b are also perpendicular with respect to the first set of rails 222a, 222b.

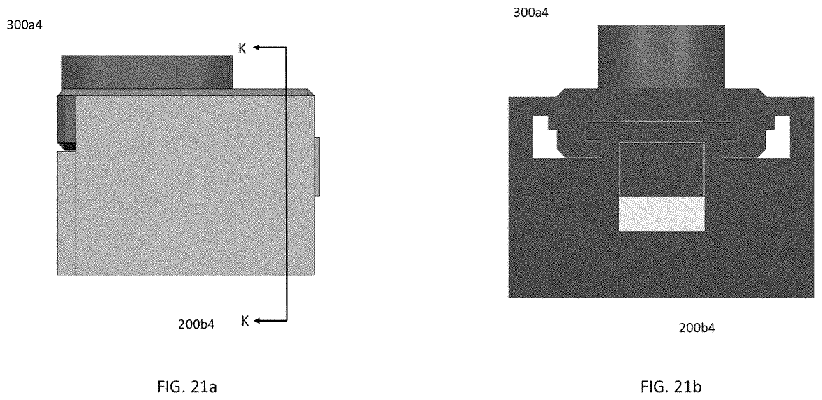

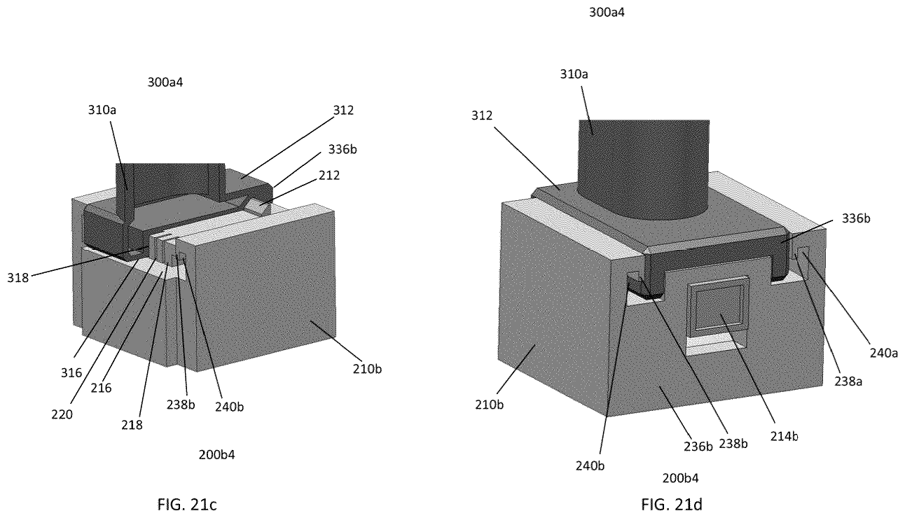

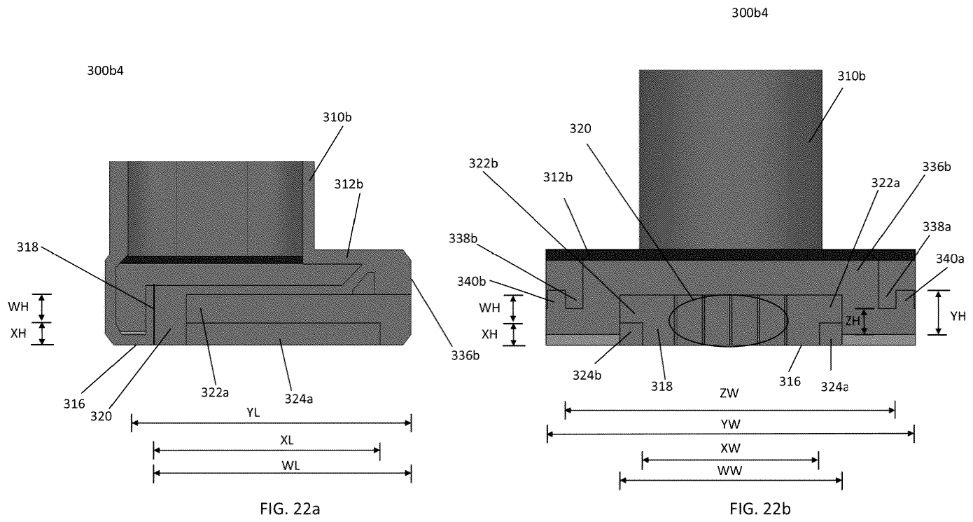

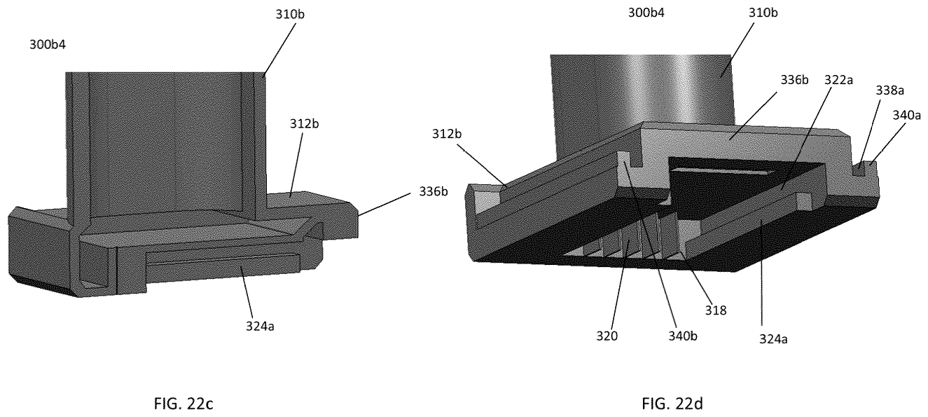

FIGS. 21a-21d illustrate a combination of the dual rail battery pack of FIGS. 20a-20d and the single rail power tool of FIGS. 3a-3d. The dual rail interface battery pack 200b4 is compatible with a single rail interface power tool such as the single rail interface power tool 300a4 as illustrated in FIGS. 21a-21d. FIG. 21a illustrates a side view and FIG. 22b illustrates a cross-section front view taken along the line K-K of FIG. 21a of the combination. FIG. 21c illustrates a partial, cut-away isometric view and FIG. 21d illustrates an isometric view of the combination. The single rail interface power tool 300a4 includes the same features as described above with respect to the single rail interface power tool 300a1. The power tool 300a4 engages with the dual rail interface battery pack 200b3 using the first set of rails 222a, 222b and the first set of grooves 224a, 224b on the battery pack and not the second set of rails and grooves.

FIGS. 22a-22d illustrate a fourth example embodiment of a dual rail interface power tool 300b4 that is compatible with both a single rail interface battery pack and a dual rail interface battery pack. In the example of FIGS. 22a-22d, the second set of rails 340a, 340b and the second set of grooves 338a, 338b are located exterior to the tool shroud 312b, whereas the first set of rails 324a, 324b and the first set of grooves 322a, 322b are located in the interior of the tool shroud 312b. The second set of rails 340a, 340b are on a different plane than the first set of rails 324a, 324b and in a different orientation than the first set of rails 324a, 324b., with the sets of rails 340a, 340b and 324a, 324b being oriented perpendicular to each other. The second set of rails 340a, 340b and the second set of grooves 338a, 338b are adjacent (side-by-side) to each other in contrast to the first set of rails 324a, 324b and the first set of grooves 322a, 322b, which have the grooves 322a, 322b on top of the rails 324a, 324b.

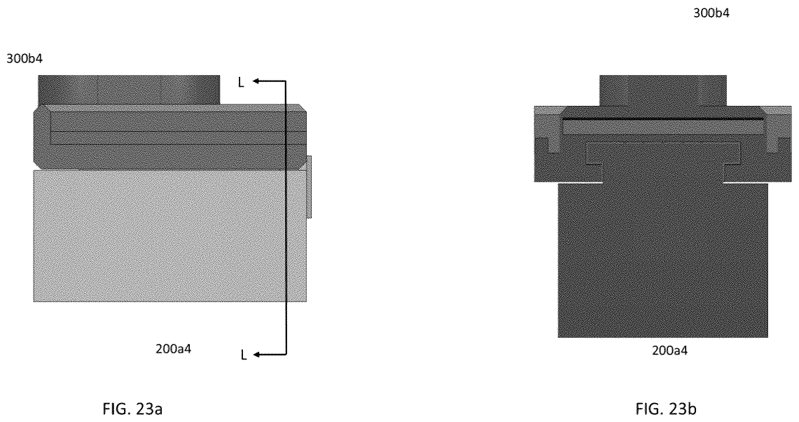

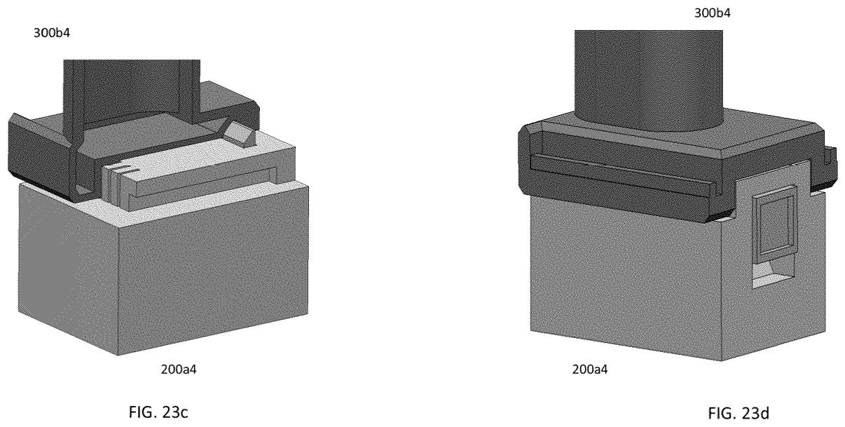

Referring also to FIGS. 23a-23d, the dual rail interface power tool 300b4 is compatible with the single rail interface battery pack 200a4. FIG. 23a illustrates a side view and FIG. 23b illustrates a cross-section front view taken along the line L-L of FIG. 23a of the combination. FIG. 23c illustrates a partial, cut-away isometric view and FIG. 23d illustrates an isometric view of the combination. The latch 212 engages with the tool catch 314, both of which are in a same relative location to each other.

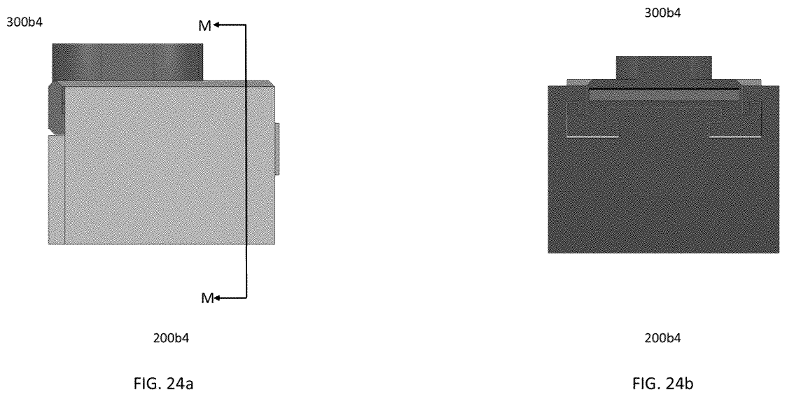

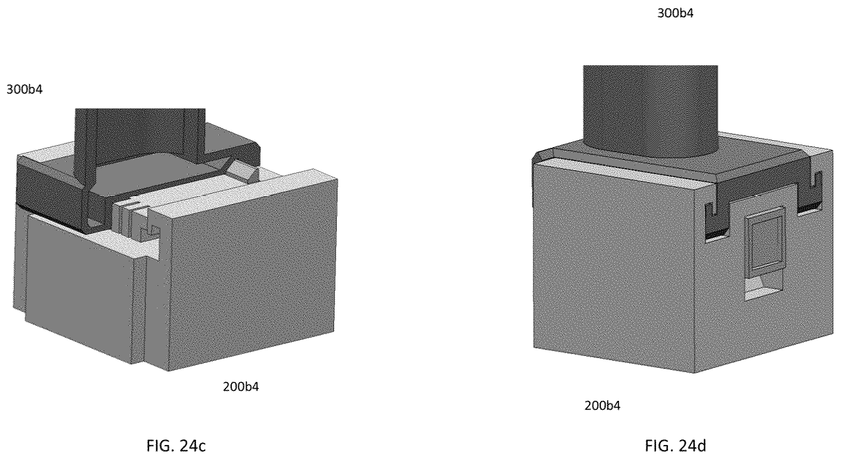

FIGS. 24a-24d illustrate a combination of the dual rail battery pack of FIGS. 20a-20d and the dual rail power tool of FIGS. 22a-22d. Referring to FIGS. 24a-24d, the dual rail interface power tool 300b4 is compatible with the dual rail interface battery pack 200b4. FIG. 24a illustrates a side view and FIG. 24b illustrates a cross-section front view taken along the line M-M of FIG. 24a of the combination. FIG. 24c illustrates a partial, cut-away isometric view and FIG. 24d illustrates an isometric view of the combination. In this example, the tool shroud 312b does not cover the entire battery pack 200b4 because the pack second rails 238a, 238b overlap the outside of the tool second rails 340a, 340b. The latch 212 engages with the tool catch 314, both of which are in a same relative location to each other.

As illustrated in FIGS. 24a-24d, the primary battery pack rails 222a, 222b and the secondary battery pack rails 238a, 238b are sized to fit and be received in the primary power tool grooves 322a, 322b and secondary power tool grooves 338a, 338b, respectively. The primary battery pack rails 222a, 222b and the secondary battery pack rails 238a, 238b slide within and along the primary power tool grooves 322a, 322b and the secondary power tool grooves 338a, 338b, respectively until the battery pack vertical datum plane 218 stops at the power tool vertical datum plane 318, and vice versa. Similarly, the primary power tool rails 324a, 324b and the secondary power tool rails 340a, 340b are sized to fit and be received in the primary battery pack grooves 224a, 224b and the secondary battery pack grooves 240a, 240b, respectively. The primary power tool rails 324a, 324b, 340a and the secondary power tool rails 340a, 340b slide within and along the primary battery pack grooves 224a, 224b and the secondary battery pack grooves 240a, 240b, respectively until the battery pack vertical datum plane 218 stops at the power tool vertical datum plane 318, and vice versa. The battery pack latch 212 engages with the power tool catch 314 to hold the battery pack 200a1 within the tool shroud 312. In this example, the L-shaped formed by the secondary battery pack rails 238a, 238b and the secondary battery pack grooves 240a, 240b engage the L-shaped formed by the secondary power tool rails 340a, 340b and the secondary power tool grooves 338a, 338b to interlock and secure the dual rail interface battery pack 200b4 to the dual rail interface power tool 300b4.

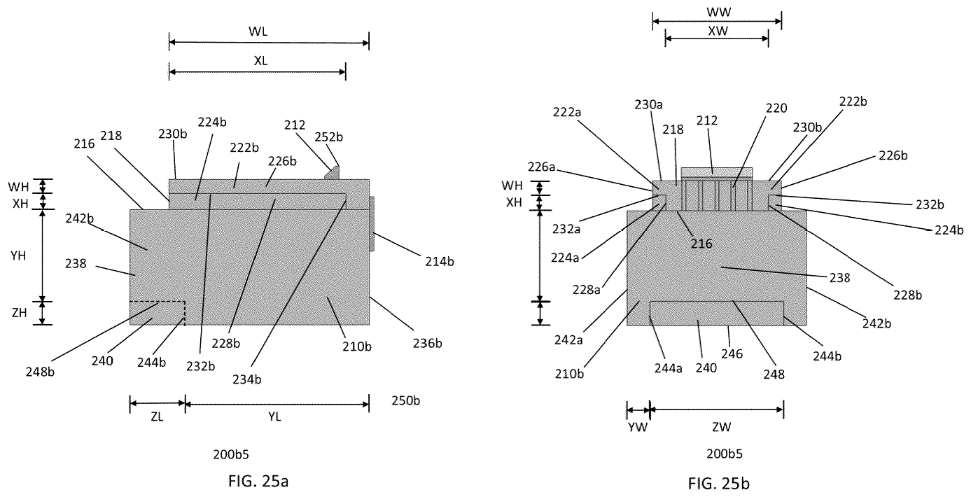

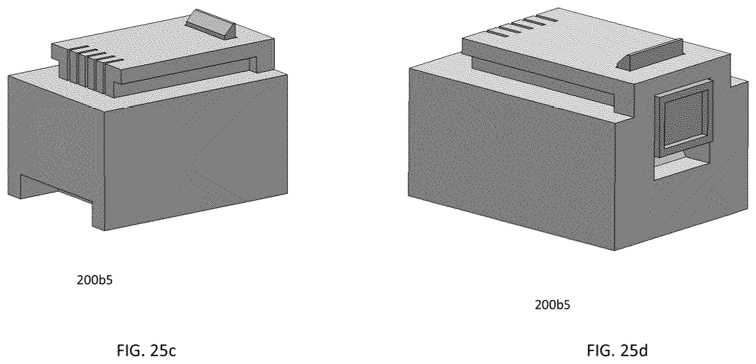

Referring to FIGS. 25a-25d, a fifth example embodiment of a dual rail interface battery pack 200b5 is illustrated. In this example, the dual rail interface battery pack 200b4 includes the second set of rails 238 at the front side of the battery pack housing 210b and a second set of grooves 240, which is formed as a notch or cut-out in the bottom, front side of the battery pack housing 210b. In this example, the second set of rails includes a single rail support assembly element 238 instead of a two rail elements, as in other embodiments. Similarly, the second set of grooves includes a single groove element 240. The primary rail support assembly element 238 is formed by cutting out the groove 240 in the bottom of the battery pack housing 210b to a depth distance indicated by the dimension ZL. The width of the second groove 240 is indicated by the dimension ZW.

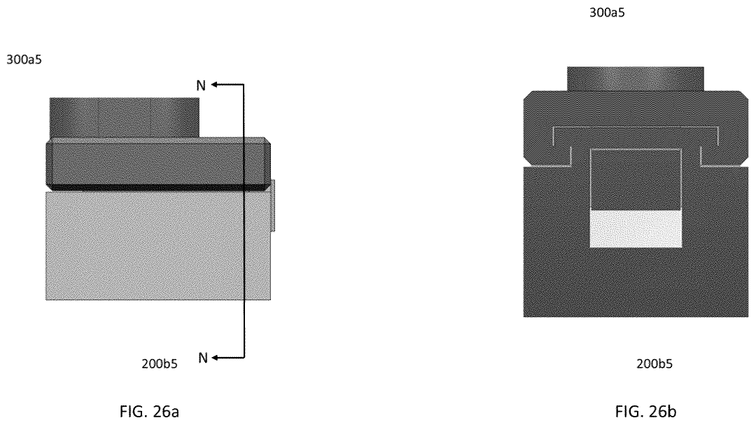

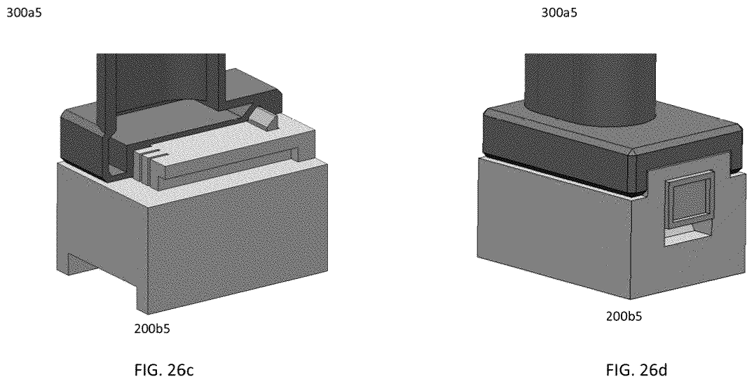

The dual rail interface battery pack 200b5 is compatible with a single rail interface power tool such as the single rail interface power tool 300a5 as illustrated in FIGS. 26a-26d. FIG. 26a illustrates a side view and FIG. 26b illustrates a cross-section front view taken along the line N-N of FIG. 26a of the combination. FIG. 26c illustrates a partial, cut-away isometric view and FIG. 26d illustrates an isometric view of the combination. The single rail interface power tool 300a5 includes the same features as described above with respect to the single rail interface power tool 300a1. The power tool 300a5 engages with the dual rail interface battery pack 200b5 using the first set of rails 222a, 222b and the first set of grooves 224a, 224b on the battery pack and not the second set of rails 238 and grooves 240.

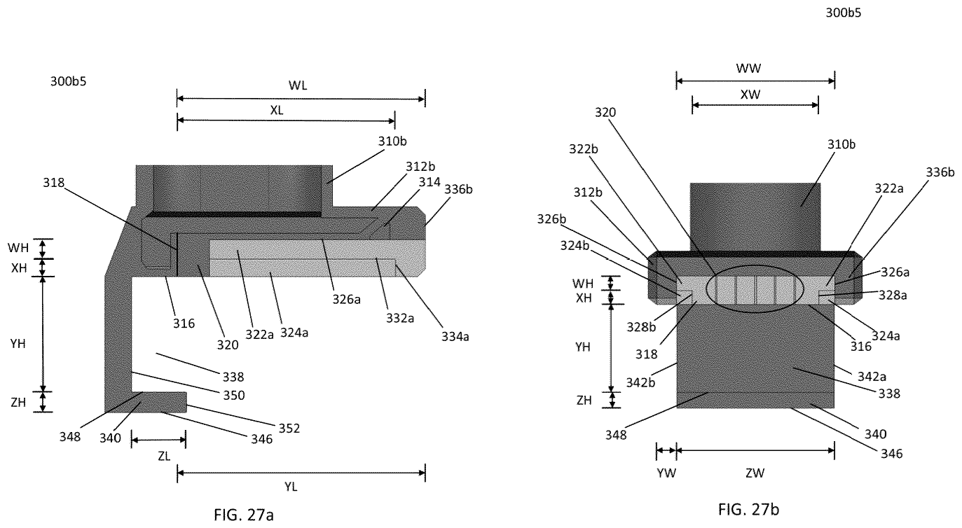

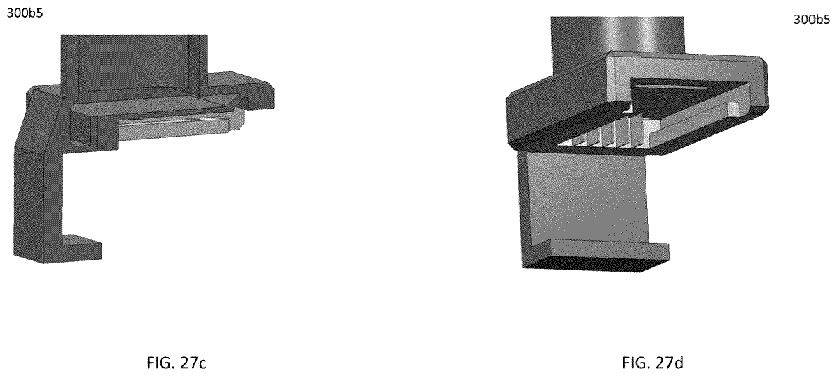

FIGS. 27a-27d illustrate a fifth example embodiment of a dual rail interface power tool 300b5 that is compatible with both a single rail interface battery pack and a dual rail interface battery pack 200b5. In the example of FIGS. 27a-27d, the second set of rails 340 and the second set of grooves 338 are located exterior to and below the tool shroud 312b, whereas the first set of rails 324a, 324b and the first set of grooves 322a, 322b are located in the interior of the tool shroud 312b. The second set of rails 340 includes a single rail support assembly element 340 instead of two rail elements as in previous embodiments. Similarly, the second set of grooves includes a single groove element 338 instead of two groove elements as in the previous embodiments. The second rail element 340 is on a different plane than the first set of rails 324a, 324b and in a different orientation than the first set of rails 324a, 324b. The primary rail support assembly element 340 and the single groove element 338 forms a long L-shaped structure.

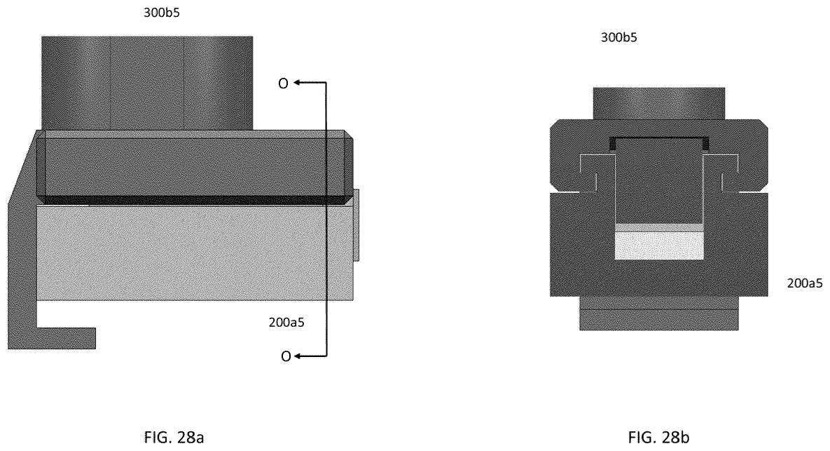

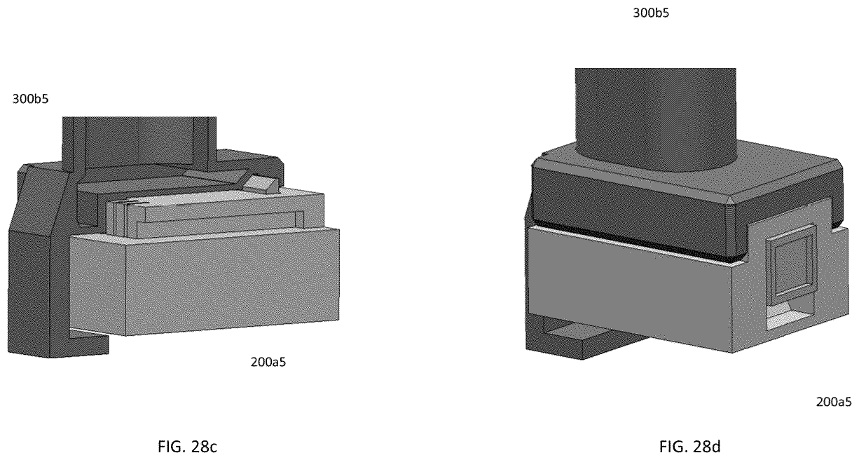

FIGS. 28a-28d illustrate a combination of the single rail battery pack of FIGS. 2a-2d and the dual rail power tool of FIGS. 27a-27d. Referring also to FIGS. 28a-28d, the dual rail interface power tool 300b5 is compatible with the single rail interface battery pack 200a5. FIG. 28a illustrates a side view and FIG. 28b illustrates a cross-section front view taken along the line O-O of FIG. 28a of the combination. FIG. 28c illustrates a partial, cut-away isometric view and FIG. 28d illustrates an isometric view of the combination. The latch 212 engages with the tool catch 314, both of which are in a same relative location to each other.

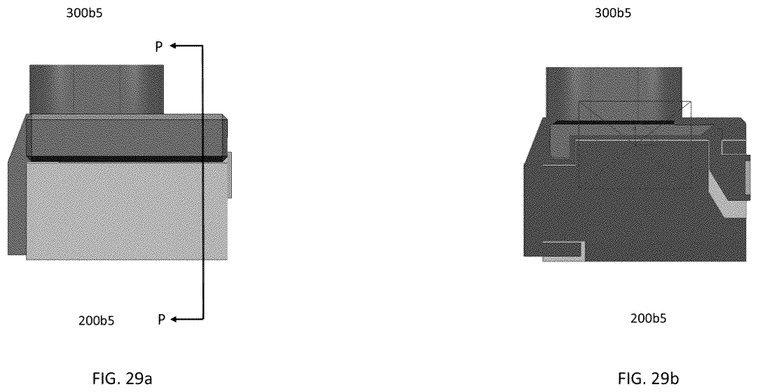

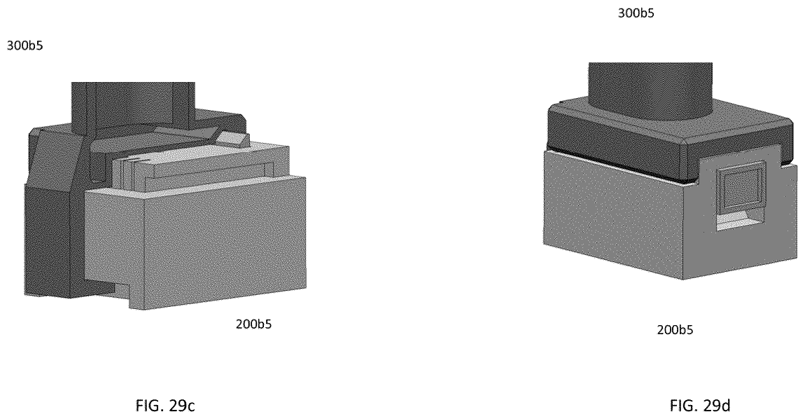

FIGS. 29a-29d illustrate a combination of the dual rail battery pack of FIGS. 25a-25d and the dual rail power tool of FIGS. 27a-27d. Referring to FIGS. 29a-29d, the dual rail interface power tool 300b5 is compatible with the dual rail interface battery pack 200b5. FIG. 29a illustrates a side view and FIG. 29b illustrates a cross-section front view taken along the line P-P of FIG. 29a of the combination. FIG. 29c illustrates a partial, cut-away isometric view and FIG. 29d illustrates an isometric view of the combination. In this example, the tool shroud 312b covers and receives the entire battery pack 200b5. The latch 212 engages with the tool catch 314, both of which are in a same relative location to each other.

As illustrated in FIGS. 29a-29d, the primary battery pack rails 222a, 222b and the secondary battery pack rail 238 are sized to fit in the primary power tool grooves 322a, 322b and secondary power tool groove 338, respectively. The primary battery pack rails 222a, 222b and the secondary battery pack rail 238 slide within and along the primary power tool grooves 322a, 322b and the secondary power tool groove 338, respectively until the battery pack vertical datum plane 218 stops at the power tool vertical datum plane 318, and vice versa. Similarly, the primary power tool rails 324a, 324b and the secondary power tool rail 340 are sized to fit and be received in the primary battery pack grooves 224a, 224b and the secondary battery pack groove 240, respectively. The primary power tool rails 324a, 324b and the secondary power tool rail 340 slide within and along the primary battery pack grooves 224a, 224b, and the secondary battery pack groove 240, respectively until the battery pack vertical datum plane 218 stops at the power tool vertical datum plane 318, and vice versa. The battery pack latch 212 engages with the power tool catch 314 to hold the battery pack 200a1 within the tool shroud 312. In this example, the L-shaped formed by the secondary tool rail 340 and the secondary tool groove 338 slides into the notch formed by the secondary battery pack rail 238 and the secondary battery pack groove 240 such that the secondary tool rail 340 provides a supporting structure in the notch of the bottom of the battery pack housing to hold and secure the battery pack 200b5 and the tool 300b5 together specifically in keeping the terminal area held tight to the tool.

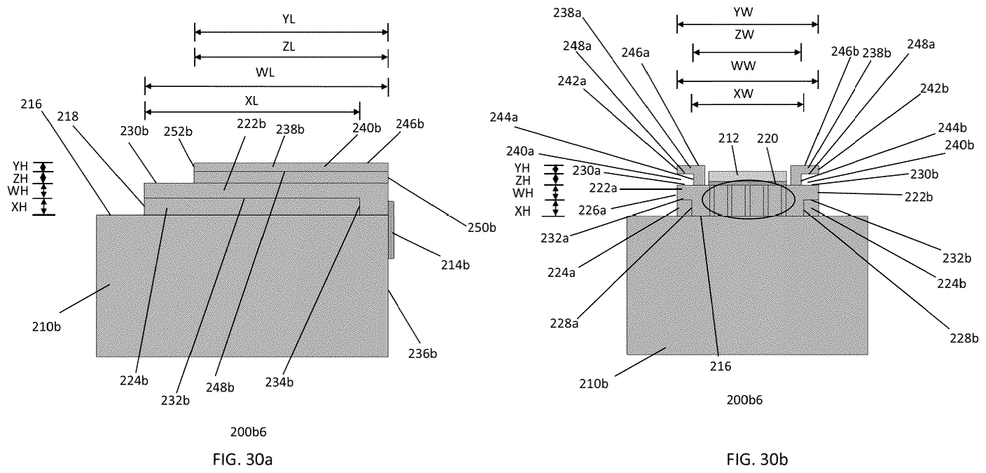

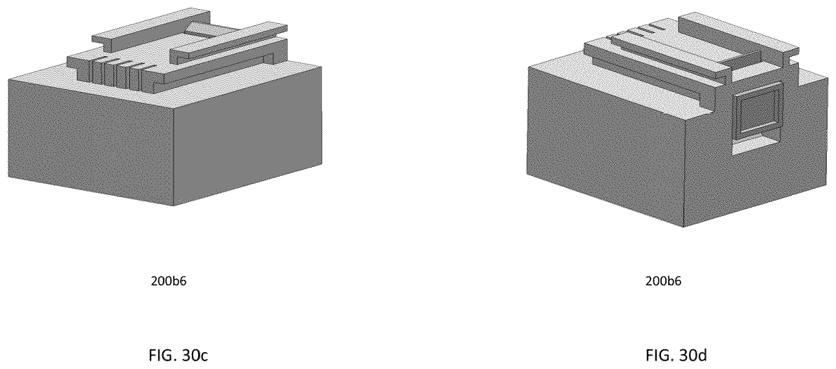

Referring to FIGS. 30a-30d, a sixth embodiment of a dual rail interface battery pack 200b6 is illustrated. In this example, the dual rail interface battery pack 200b6 includes a second set of rails 238a, 238b and a second set of grooves 240a, 240b approximately directly above the first set of rails 222a, 222b and the first set of grooves 224a, 224b, on a higher plane. In other words, the second set of rails 238a, 238b and the second set of grooves 240a, 240b are farther from the datum plane 216 than the first set of rails 222a, 222b and the first set of grooves 224a, 224b, respectively. Each of the second set of rails 238a, 238b and corresponding second set of grooves 240a, 240b form an L-shape similar to the first of rails 222a, 222b and the first set of grooves 224a, 224b. The second set of rails 238a, 238b are above and define the grooves 240a, 240b, which are below the rails 238a, 238b in relation to the base surface 216. The height dimension ZH for the second set of grooves 240a, 240b is defined by the first rails top walls 230a, 230b and the second rails bottom walls 248a, 248b. In this example, the first set of rails 222a, 222b and the first set of grooves 224a, 224b remain the same as in previous embodiments. It is noted that while this example embodiment may not be compatible with the single rail interface power tool, this geometry can be useful in that this rail geometry would not allow the dual rail pack into a single rail tool of perhaps lower power or voltage that should not accept the dual rail pack, while still having a dual rail structure advantage in a dual rail tool also while allowing single rail convertible voltage packs into the dual rail tool.

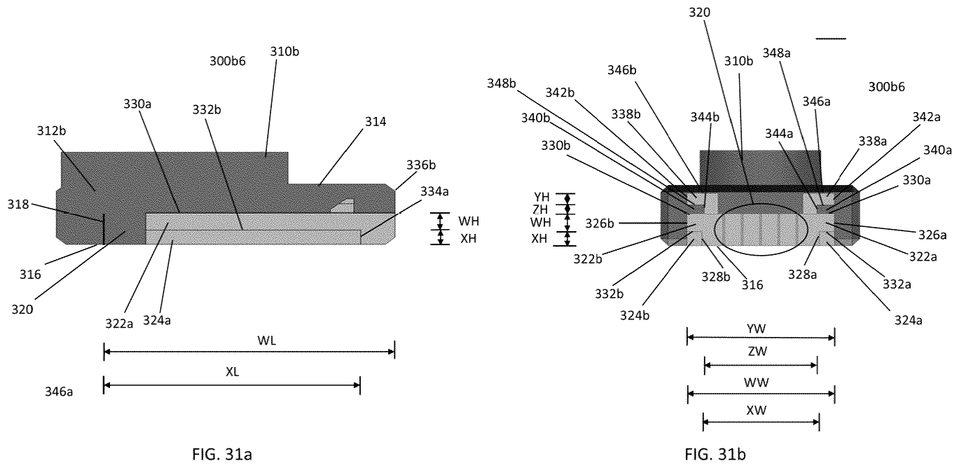

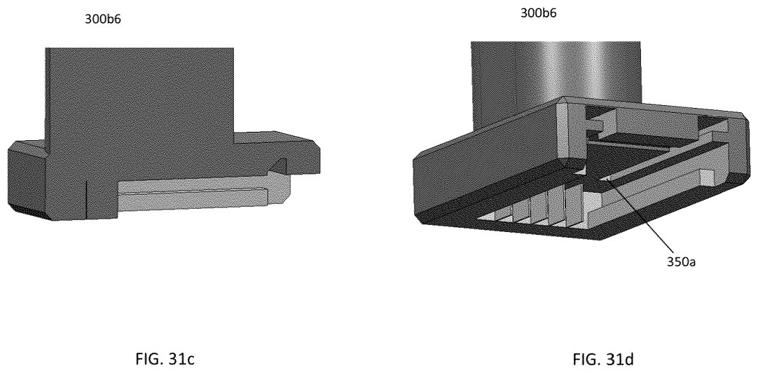

FIGS. 31a-31d illustrate a sixth example embodiment of a dual rail interface power tool 300b6 that is compatible with both a single rail interface battery pack and a dual rail interface battery pack. In the example of FIGS. 31a-31d, the second set of rails 340a, 340b and the second set of grooves 338a, 338b are located interior to the tool shroud 312b along with the first set of tool rails 324a, 324b and the first set of tool grooves 322a, 322b. The second set of rails 340a, 340b are on a different plane than the first set of rails 324a, 324b located above and parallel to the first set of rails 324a, 324b. The second set of rails 340a, 340b and the second set of grooves 338a, 338b have the grooves 338a, 338b on top of the rails 340a, 340b.

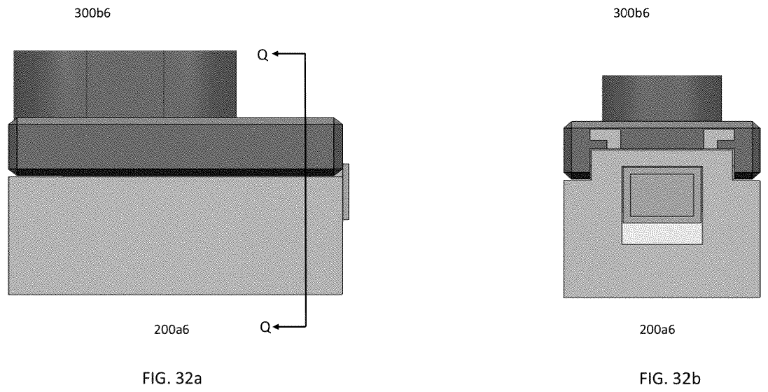

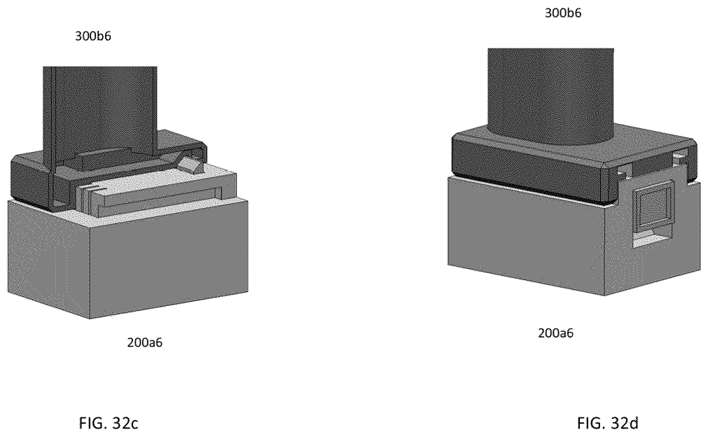

Referring also to FIGS. 32a-32d, the dual rail interface power tool 300b6 is compatible with the single rail interface battery pack 200a6. FIG. 32a illustrates a side view and FIG. 32b illustrates a cross-section front view taken along the line Q-Q of FIG. 32a of the combination. FIG. 32c illustrates a partial, cut-away isometric view and FIG. 32d illustrates an isometric view of the combination.

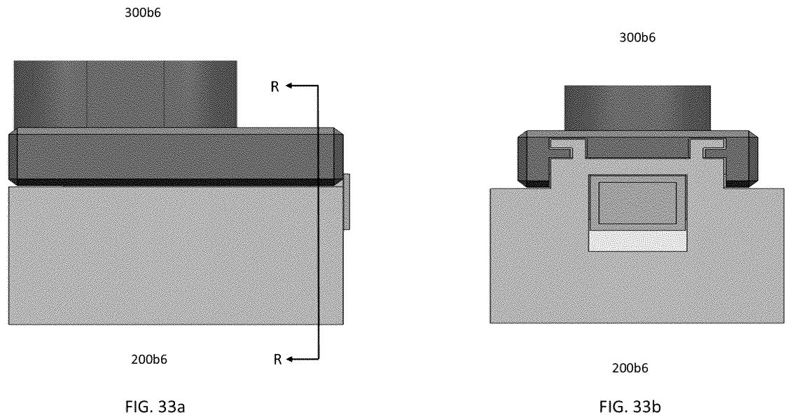

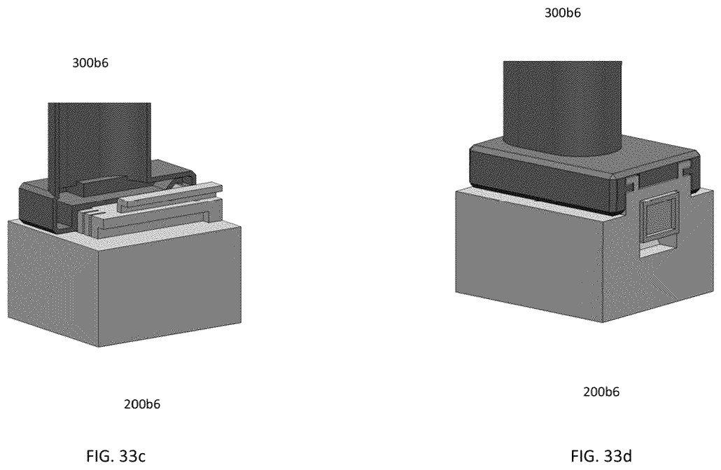

Referring to FIGS. 33a-33d, the dual rail interface power tool 300b6 is compatible with the dual rail interface battery pack 200b6. FIG. 33a illustrates a side view and FIG. 33b illustrates a cross-section front view taken along the line R-R of FIG. 33a of the combination. FIG. 33c illustrates a partial, cut-away isometric view and FIG. 33d illustrates an isometric view of the combination. In this example, the tool shroud 312b does not cover the entire battery pack 200b6 because the battery pack 200b6 may be wider than the tool shroud 312b. The latch 212 engages with the tool catch 314, both of which are in a same relative location to each other.

As illustrated in FIGS. 33a-33d, the primary battery pack rails 222a, 222b and the secondary battery pack rails 238a, 238b are sized to fit and be received in the primary power tool grooves 322a, 322b and the secondary power tool grooves 338a, 338b, respectively. The primary battery pack rails 222a, 222b and the secondary battery pack rails 238a, 238b slide within and along the primary power tool grooves 322a, 322b and the secondary power tool grooves 338a, 338b, respectively until the battery pack vertical datum plane 218 stops at the power tool vertical datum plane 318, and vice versa. Similarly, the primary power tool rails 324a, 324b and the secondary power tool rails 340a, 340b are sized to fit and be received in the primary battery pack grooves 224a, 224b and the secondary battery pack grooves 240a, 240b, respectively. The primary power tool rails 324a, 324b and the secondary power tool rails 340a, 340b slide within and along the primary battery pack grooves 224a, 224b and the secondary battery pack grooves 240a, 240b, respectively until the battery pack vertical datum plane 218 stops at the power tool vertical datum plane 318, and vice versa. The battery pack latch 212 engages with the power tool catch 314 to hold the battery pack 200a1 within the tool shroud 312. In this example, the elevated battery pack second rails 238a, 238b and battery pack second grooves 240a, 240b engage the elevated tool second rails 340a, 340b and the tool second grooves 338a, 338b to interlock and secure the dual rail interface battery pack 200b6 to the dual rail interface power tool 300b6.

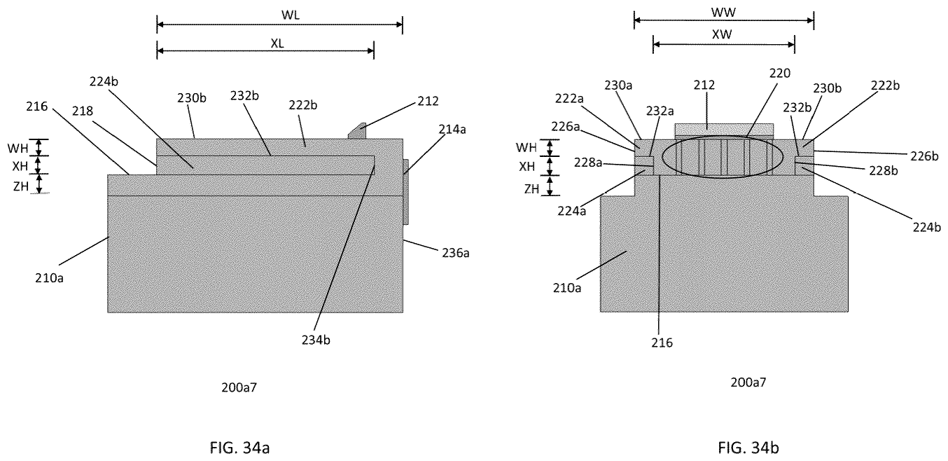

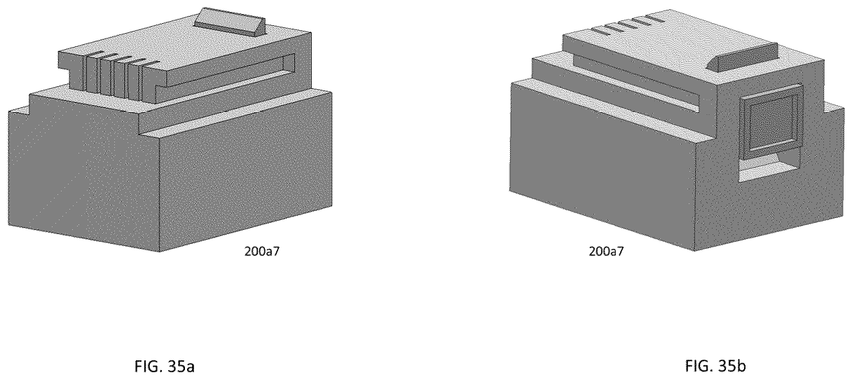

Referring to FIGS. 34a-34b and FIGS. 35a-35b, a seventh embodiment illustrates a single rail interface battery pack 200a7. In this example, the single rail interface battery pack 200a7 differs from the first embodiment single rail interface battery pack 200a1 in that the base surface 216 is raised in the battery pack 200a7 providing for a taller, single rail interface when compared to the battery pack 200a1. The pack rails 222a, 222b and pack grooves 224a, 224b are offset from the base surface 216 by a distance XH.

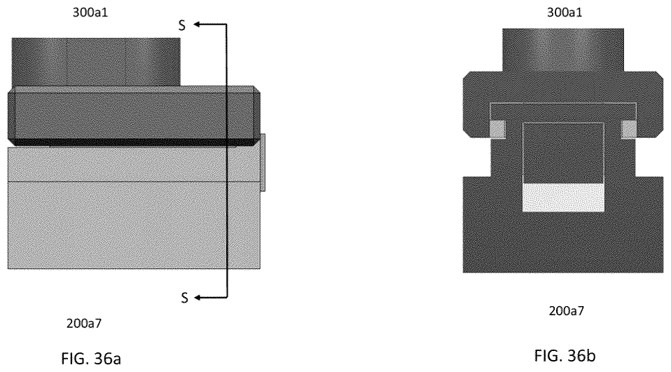

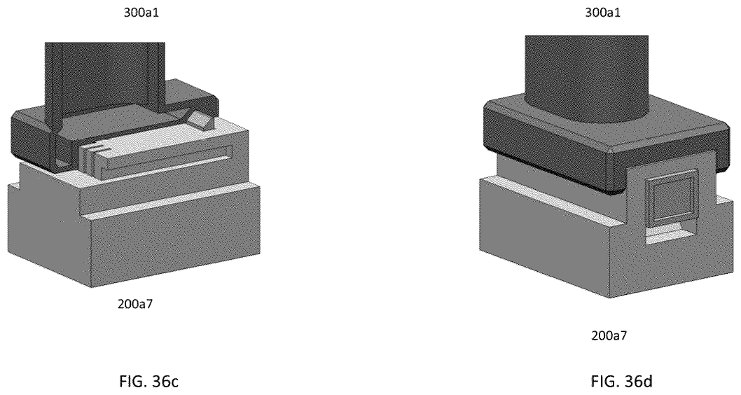

Referring to FIGS. 36a-36d, the single rail interface battery pack 200a7 is coupled with the single rail interface power tool 300a1 of FIGS. 3a-3d. FIG. 36a illustrates a side view and FIG. 36b illustrates a cross-section front view taken along the line S-S of FIG. 36a of the combination. FIG. 36c illustrates a partial, cut-away isometric view and FIG. 36d illustrates an isometric view of the combination. The pack rails 222a, 222b and pack grooves 224a, 224b align with, slide along and engage the tool rails 324a, 324b and tool grooves 322a, 322b because the single rail interface on the battery pack 200a7 and the single rail interface on the power tool 300a1 are both offset by the same distance ZH.

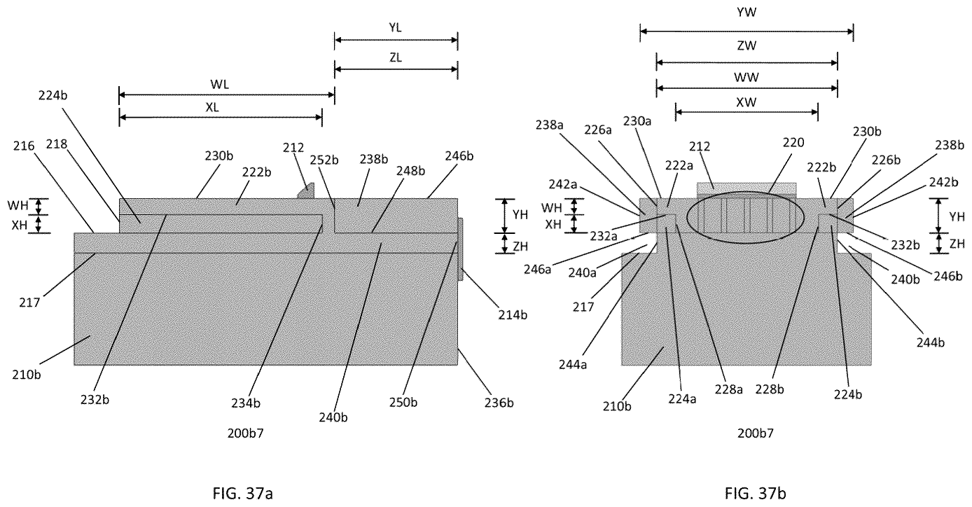

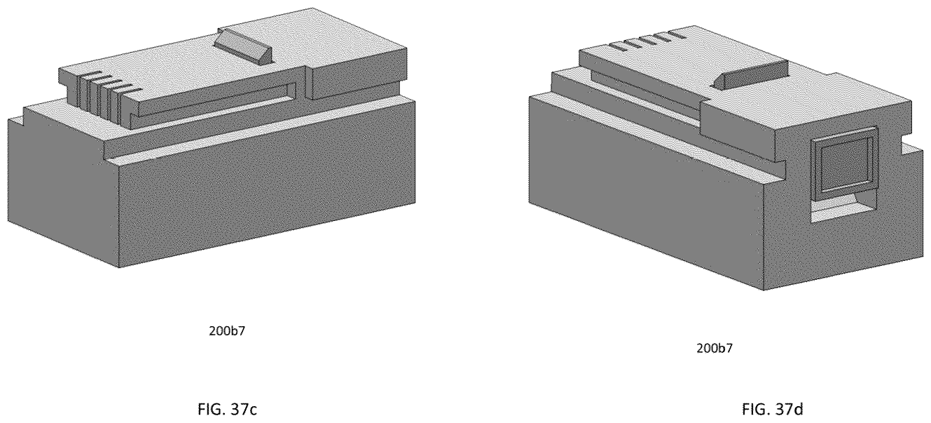

Referring to FIGS. 37a-37d, a seventh embodiment of a dual rail interface battery pack 200b7 is illustrated. In this example, the dual rail interface battery pack 200b7 is the same as the dual rail interface battery pack 200b1 of FIGS. 5a-5d, except that the first rails 222a, 222b are a distance XH from the base surface 216 equal to a height dimension of the first grooves 224a, 224b and the second rails 238a, 238b are a distance ZH from a second base surface 217 equal to a height dimension of the second grooves 240a, 240b. Furthermore, the first set of rails 222a, 222b have a height dimension WH and the second set of rails 238a, 238b have a height dimension YH, wherein YH is greater than WH. Still further, the second set of grooves 240a, 240b extend below the base surface 216, while the first set of grooves 224a, 224b extend above the base surface 216. The primary battery pack rails 222a, 222b have a first height WH. The secondary battery pack rails 238a, 238b have a second height YH. The first height WH is less than the second height YH. The primary battery pack rails 222a, 222b have exterior sidewalls 226a, 226b, respectively. The primary battery pack rail sidewall 226a, 226b are approximately, generally parallel to each other. The primary battery pack rail sidewalls 226a, 226b have a first width of WW. The secondary battery pack rails 238a, 238b have exterior sidewalls 242a, 242b, respectively. The secondary battery pack rail sidewalls 242a, 242b are approximately parallel to each other and to the primary battery pack rail sidewalls 226a, 226b. The secondary battery pack rail sidewalls 242a, 242b have a second width YW. The first width WW is less than the second width YW. The primary battery pack rails 222a, 222b are positioned above the datum plane 216 approximately by a distance equal to the primary battery pack grooves 224a, 224b at a distance XH. The secondary battery pack rails 238a, 238b are positioned above the datum plane 216 by a distance less than the distance XH. The primary battery pack rails 222a, 222b are positioned closer to a front (forward) side of the battery pack housing 210b than the secondary battery pack rails 238a, 238b. The secondary battery pack rails 238a, 238b are positioned closed to a rear (rearward) side of the battery pack housing 210b than the primary battery pack rails 222a, 222b.

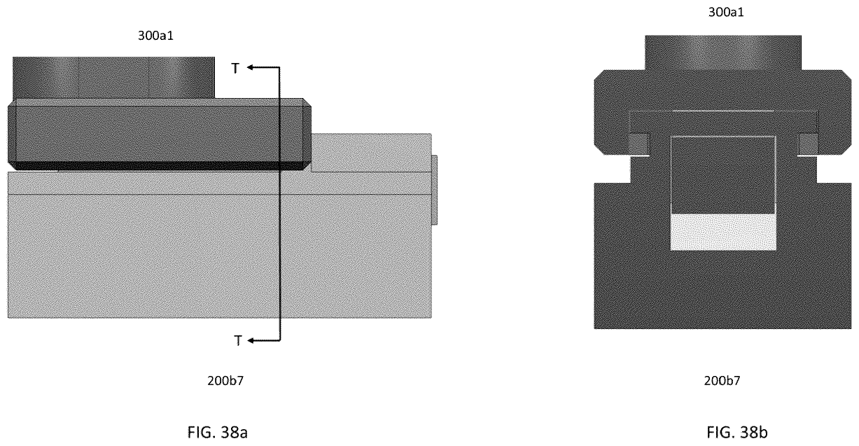

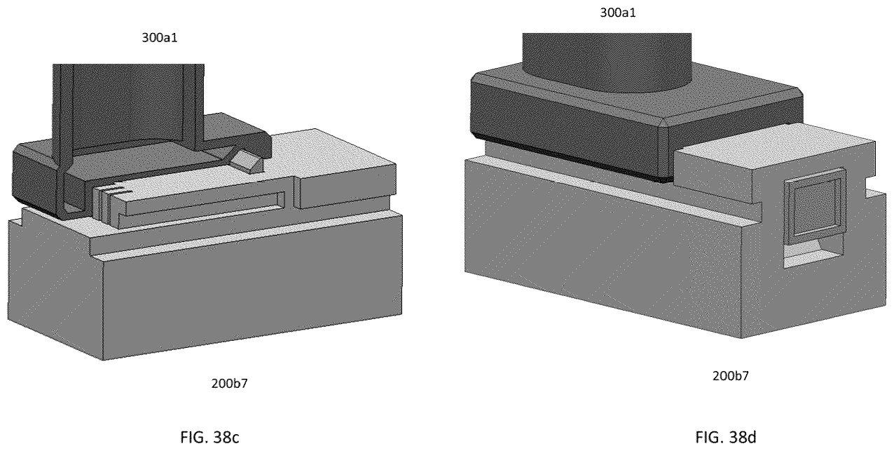

The dual rail interface battery pack 200b7 is compatible with a single rail interface power tool such as the single rail interface power tool 300a1 as illustrated in FIGS. 38a-38d. FIG. 38a illustrates a side view and FIG. 38b illustrates a cross-section front view taken along the line T-T of FIG. 38a of the combination. FIG. 38c illustrates a partial, cut-away isometric view and FIG. 38d illustrates an isometric view of the combination. The single rail interface power tool 300a1 includes the same features as described above with respect to the single rail interface power tool 300a1. The power tool 300a1 engages with the dual rail interface battery pack 200b7 using the first set of rails 222a, 222b and the first set of grooves 224a, 224b on the battery pack and not the second set of rails and grooves.

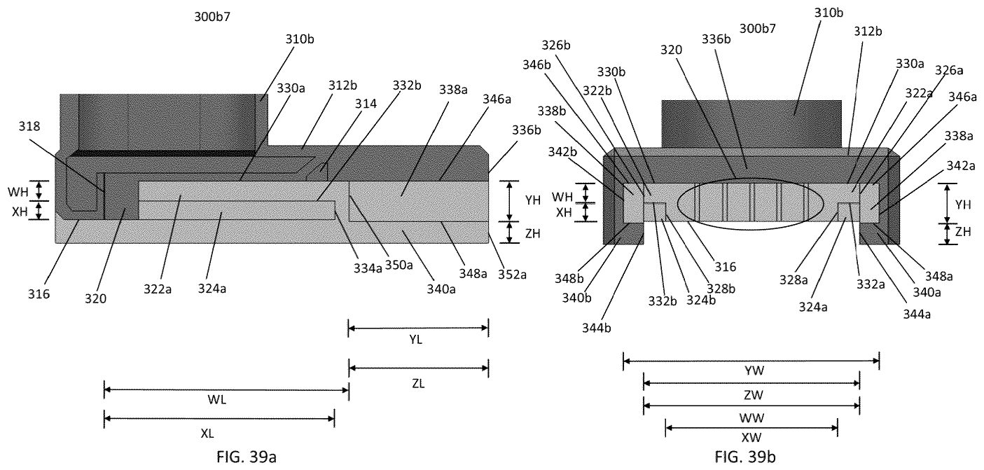

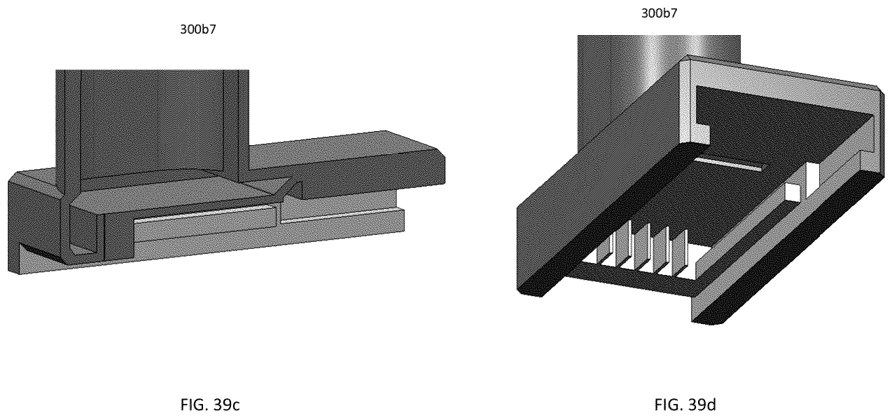

FIGS. 39a-39d illustrate a seventh example embodiment of a dual rail interface power tool 300b7 that is compatible with both a single rail interface battery pack and a dual rail interface battery pack. In the example of FIGS. 39a-39d, the second set of rails 340a, 340b and the second set of grooves 338a, 338b are located the same as the dual rail interface power tool 300b1 of FIGS. 7a-7d except with the additional height offset ZH for the tool shroud 312b.

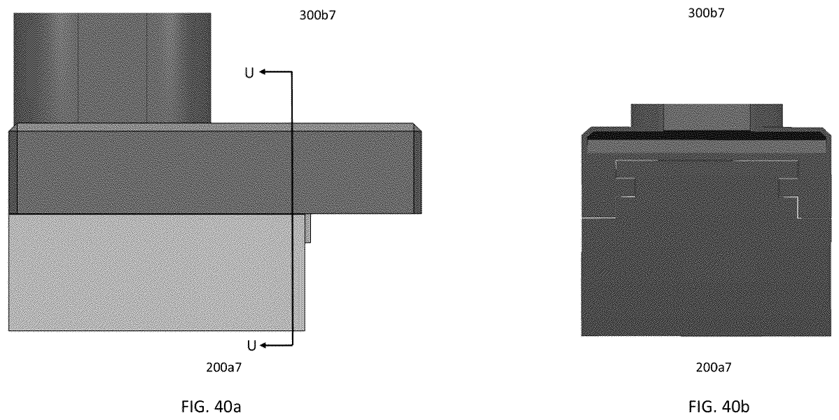

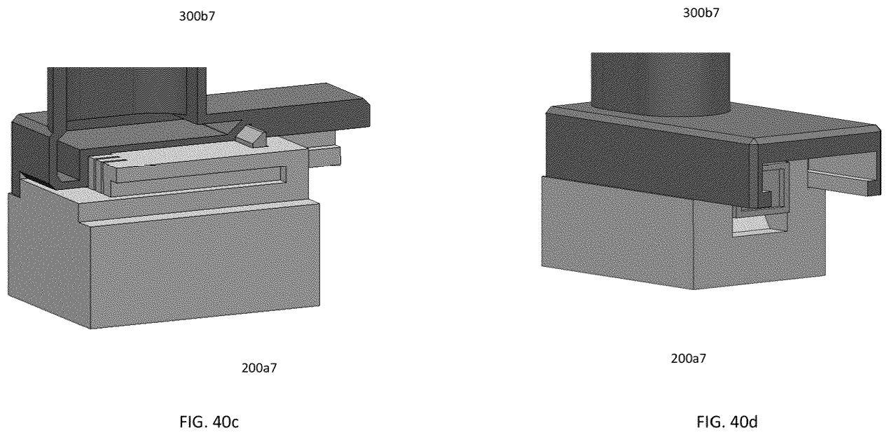

Referring also to FIGS. 40a-40d, the dual rail interface power tool 300b7 is compatible with the single rail interface battery pack 200a7 of FIGS. 34a-34b and FIGS. 35a-35b. FIG. 40a illustrates a side view and FIG. 40b illustrates a cross-section front view taken along the line U-U of FIG. 40a of the combination. FIG. 40c illustrates a partial, cut-away isometric view and FIG. 40d illustrates an isometric view of the combination.

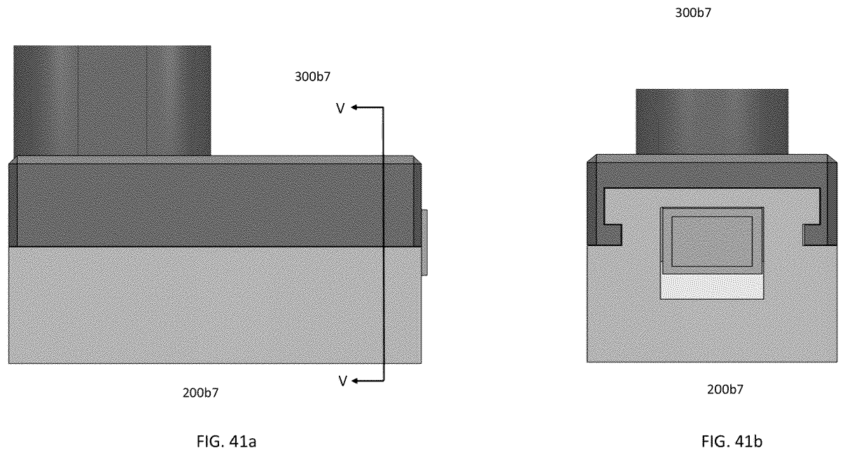

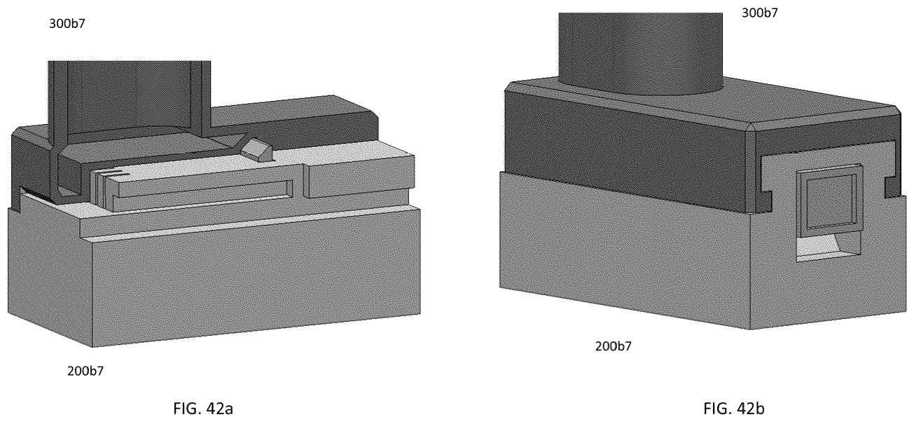

Referring to FIGS. 41a-41b and FIGS. 42a-42b, the dual rail interface power tool 300b7 is compatible with the dual rail interface battery pack 200b7. FIG. 41a illustrates a side view and FIG. 41b illustrates a cross-section front view taken along the line V-V of FIG. 41a of the combination. FIG. 42a illustrates a partial, cut-away isometric view and FIG. 42b illustrates an isometric view of the combination. In this example, the tool shroud 312b receives and covers the entire battery pack 200b7. The latch 212 engages with the tool catch 314, both of which are in a same relative location to each other.

As illustrated in FIGS. 41a-41b and FIGS. 42a-42b, the primary battery pack rails 222a, 222b and the secondary battery pack rails 238a, 238b are sized to fit and be received in the primary power tool grooves 322a, 322b and the secondary power tool grooves 338a, 338b, respectively. The primary battery pack rails 222a, 222b and the secondary battery pack rails 238a, 238b slide within and along the primary power tool grooves 322a, 322b and the secondary power tool grooves 338a, 338b, respectively until the battery pack vertical datum plane 218 stops at the power tool vertical datum plane 318, and vice versa. Similarly, the primary power tool rails 324a, 324b and the secondary power tool rails 340a, 340b are sized to fit and be received in the primary battery pack grooves 224a, 224b and the secondary battery pack grooves 240a, 240b, respectively. The primary power tool rails 324a, 324b and the secondary power tool rails 340a, 340b slide within and along the primary battery pack grooves 224a, 224b and the secondary battery pack grooves 240a, 240b, respectively until the battery pack vertical datum plane 218 stops at the power tool vertical datum plane 318, and vice versa. The battery pack latch 212 engages with the power tool catch 314 to hold the battery pack 200a1 within the tool shroud 312. In this example, both the secondary battery pack rails 238a, 238b and the secondary battery pack grooves 240a, 240b align with and engage the secondary power tool rails 340a, 340b and the secondary power tool grooves 338a, 338b, respectively.

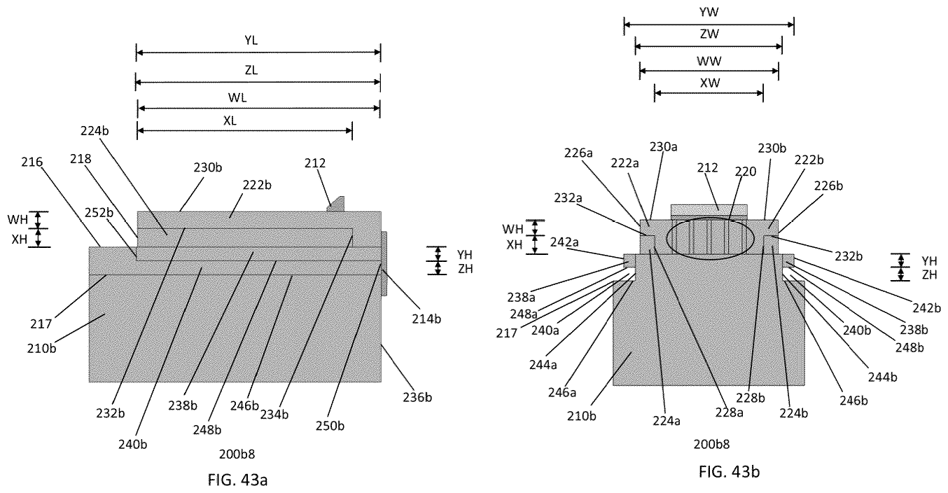

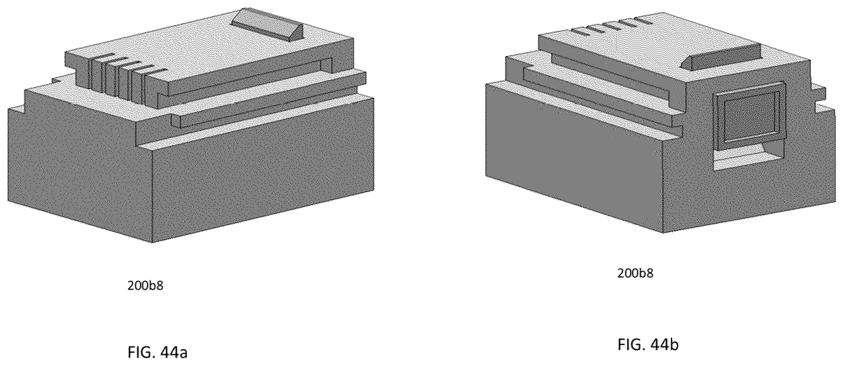

Referring to FIGS. 43a-43b and FIGS. 44a-44b, an eighth embodiment of a dual rail interface battery pack 200b8 is illustrated. In this example, the dual rail interface battery pack 200b8 includes a secondary set of rails 238a, 238b and a secondary set of grooves 240a, 240b. The secondary battery pack rails 238a, 238b and the secondary set of grooves 240a, 240b are below the primary set of rails 222a, 222b and the primary set of grooves 224a, 224b. The secondary battery pack rails 238a, 238b and the secondary set of grooves 240a, 240b are below a first datum plane 216 and the primary set of rails 222a, 222b and the primary set of grooves 224a, 224b are above the first datum plane 216. In other words, the combination of the primary set of battery pack rails 222a, 222b and the primary set of battery pack grooves 224a, 224b and the combination of the secondary set of battery pack rails 238a, 238b and the secondary set of battery pack grooves 240a, 240b are on opposite sides of the first datum plane 216. The secondary set of rails 238a, 238b are above and define the secondary set of grooves 240a, 240b. The secondary set of grooves 240a, 240b are below the secondary set of rails 238a, 238b relative to the base surface 216. The height distance ZH for the second set of grooves 240a, 240b is defined by the first rails top walls 230a, 230b and the second rails bottom walls 248a, 248b. In this example, the first set of rails 222a, 222b and the first set of grooves 224a, 224b remain the same as in the previous embodiment of 200b7.

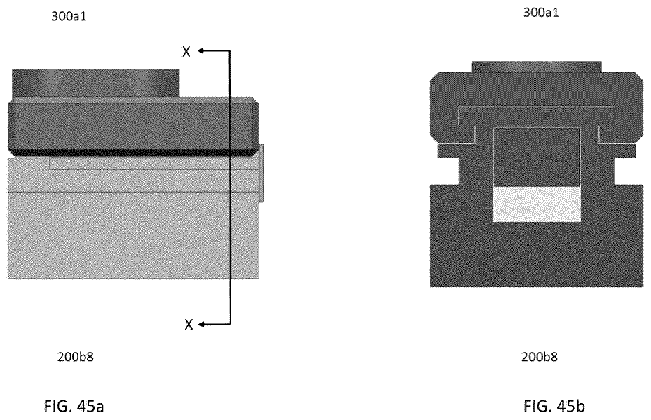

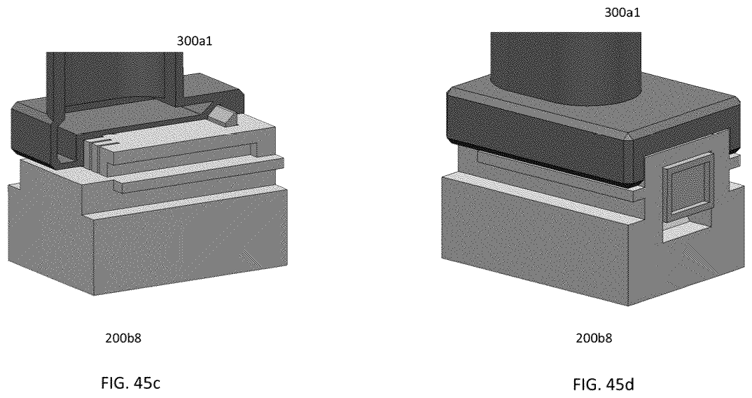

The dual rail interface battery pack 200b8 is compatible with a single rail interface power tool such as the single rail interface power tool 300a1 as illustrated in FIGS. 45a-45d. FIG. 45a illustrates a side view and FIG. 45b illustrates a cross-section front view taken along the line X-X of FIG. 45a of the combination. FIG. 45c illustrates a partial, cut-away isometric view and FIG. 45d illustrates an isometric view of the combination. The single rail interface power tool 300a1 includes the same features as described above with respect to the single rail interface power tool 300a1 of FIGS. 3a-3d. The power tool 300a1 engages with the dual rail interface battery pack 200b8 using the first set of rails 222a, 222b and the first set of grooves 224a, 224b on the battery pack and not the second set of rails and grooves.

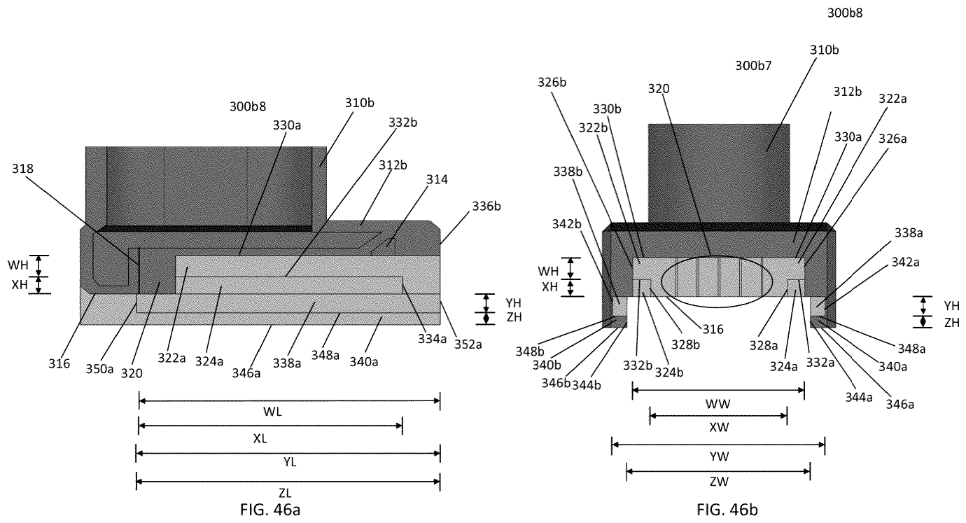

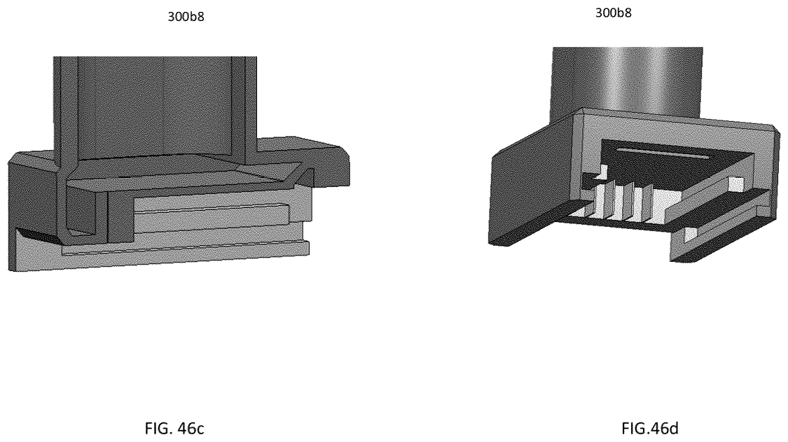

FIGS. 46a-46d illustrate an eighth example embodiment of a dual rail interface power tool 300b8 that is compatible with both a single rail interface battery pack and a dual rail interface battery pack. In the example of FIGS. 46a-46d, the second set of rails 340a, 340b and the second set of grooves 338a, 338b are located below and on a different plane than the first set of rails 324a, 324 and the first set of grooves 322a, 322b. Additionally, the second set of rails 340a, 340b and the second set of grooves 338a, 338b are offset wider than the first set of rails 324a, 324 and the first set of grooves 322a, 322b.

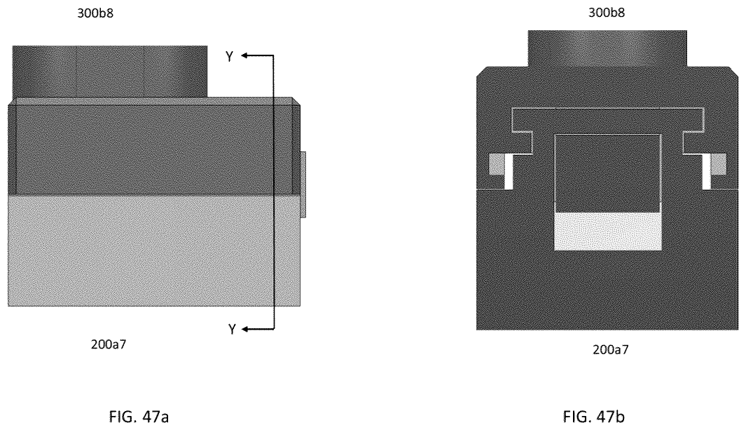

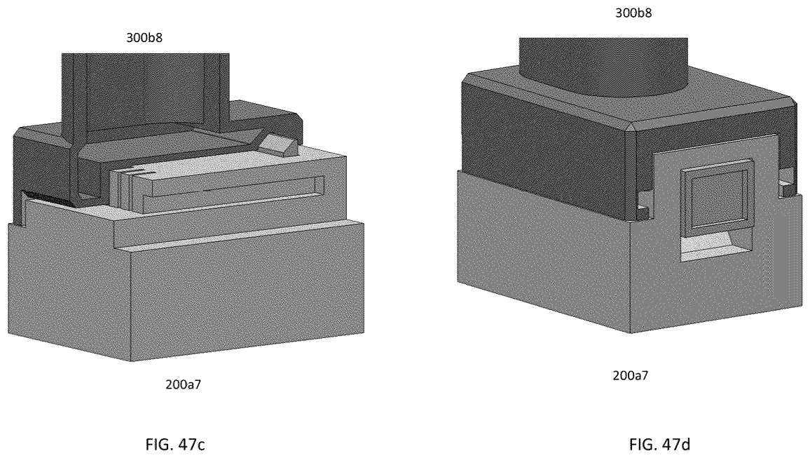

Referring also to FIGS. 47a-47d, the dual rail interface power tool 300b8 is compatible with the single rail interface battery pack 200a7. FIG. 47a illustrates a side view and FIG. 47b illustrates a cross-section front view taken along the line Y-Y of FIG. 47a of the combination. FIG. 47c illustrates a partial, cut-away isometric view and FIG. 47d illustrates an isometric view of the combination.

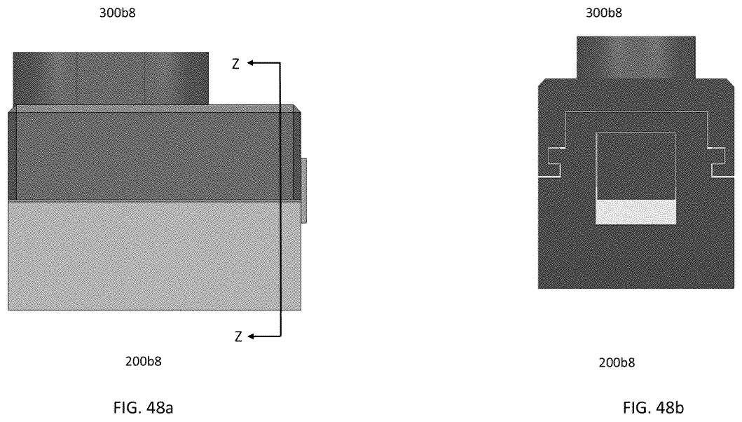

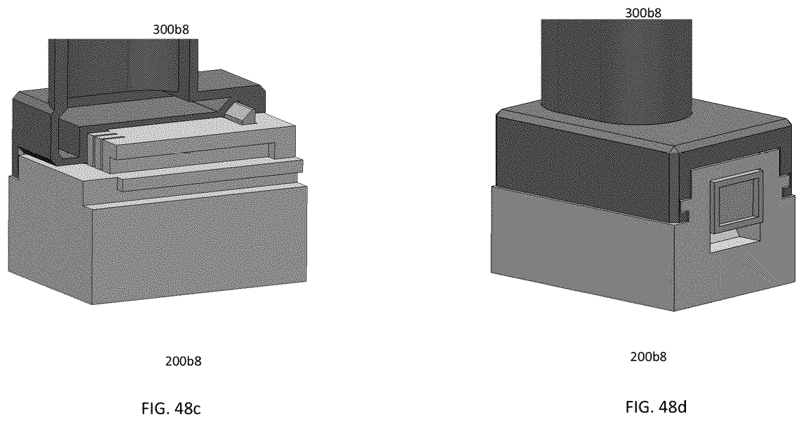

Referring to FIGS. 48a-48d, the dual rail interface power tool 300b8 is compatible with the dual rail interface battery pack 200b8. FIG. 48a illustrates a side view and FIG. 48b illustrates a cross-section front view taken along the line Z-Z of FIG. 48a of the combination. FIG. 48c illustrates a partial, cut-away isometric view and FIG. 48d illustrates an isometric view of the combination. In this example, the tool shroud 312b receives and covers the entire battery pack 200b7. The latch 212 engages with the tool catch 314, both of which are in a same relative location to each other.

As illustrated in FIGS. 48a-48d, the primary battery pack rails 222a, 222b and the secondary battery pack rails 238a, 238b are sized to fit and be received in the primary power tool grooves 322a, 322b and the secondary power tool grooves 338a, 338b, respectively. The primary battery pack rails 222a, 222b and the secondary battery pack 238a, 238b slide within and along the primary power tool grooves 322a, 322b and the secondary power tool grooves 338a, 338b, respectively until the battery pack vertical datum plane 218 stops at the power tool vertical datum plane 318, and vice versa. Similarly, the primary power tool rails 324a, 324b and secondary power tool rails 340a, 340b are sized to fit and be received in the primary battery pack grooves 224a, 224b and the secondary battery pack grooves 240a, 240b, respectively. The primary power tool rails 324a, 324b and the secondary power tool rails 340a, 340b slide within and along the primary battery pack grooves 224a, 224b and the secondary battery pack grooves 240a, 240b, respectively until the battery pack vertical datum plane 218 stops at the power tool vertical datum plane 318, and vice versa. The battery pack latch 212 engages with the power tool catch 314 to hold the battery pack 200a1 within the tool shroud 312.

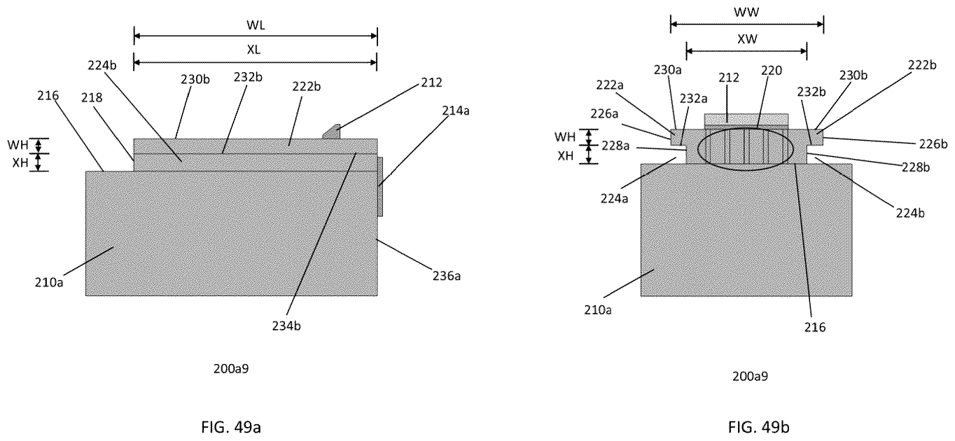

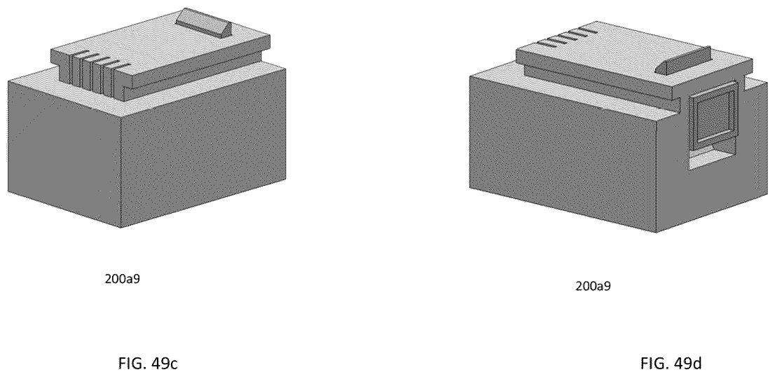

Referring to FIGS. 49a-49d, there is illustrated a ninth example embodiment of a battery pack 200a9 having a basic rail interface. In this example battery pack 200a9, the basic rail interface differs from the basic rail interface of the first example embodiment battery pack 200a1 in that the battery pack rear housing wall 236a is open and there is no rear groove wall such that the length WL of the battery pack rails 222a, 222b is the same length XL as the battery pack grooves 224a, 224b. This basic battery pack interface may be referred to as a single length battery pack interface and a battery pack including this basic battery pack interface may be referred to as a single length interface battery pack.

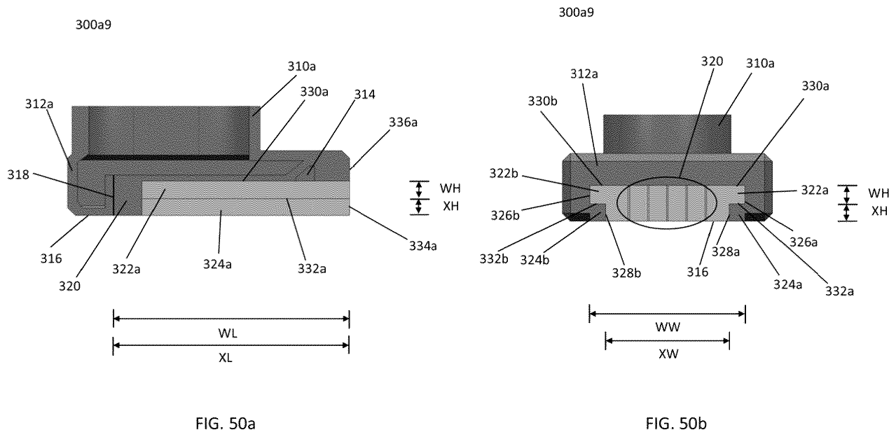

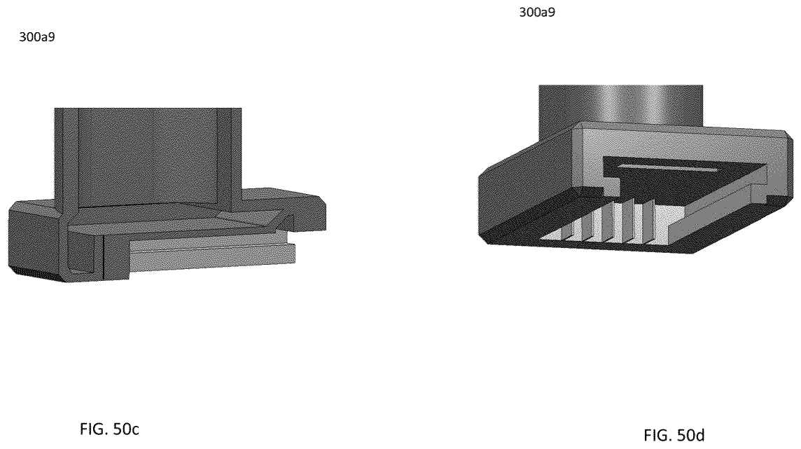

Referring to FIGS. 50a-50d, there is illustrated a ninth example embodiment of a power tool 300a9 having a basic rail interface. In this example power tool 300a9, the basic rail interface differs from the basic rail interface of the first example embodiment power tool 300a1 in that the length XL of the rails 324a, 324b and the length WL of the grooves 322a, 322b are the same. This basic power tool interface may be referred to as a single length power tool interface and a power tool including this basic power tool interface may be referred to as a single length interface power tool.

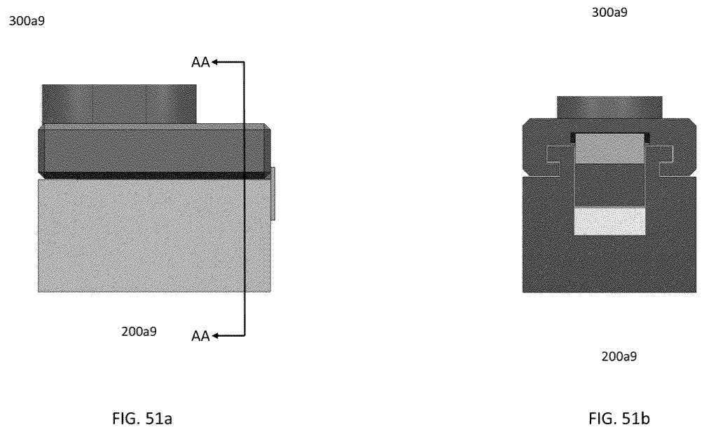

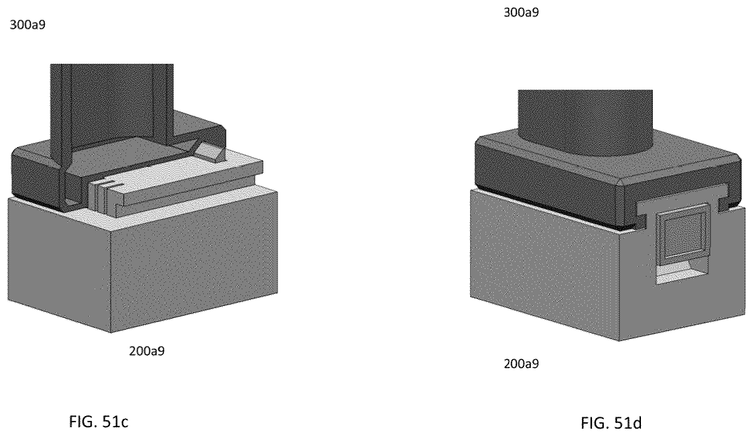

Referring to FIGS. 51a-51d, there is illustrated the example battery pack 200a9 having the single length battery pack interface coupled with the example power tool 300a9 having the single length power tool interface. FIG. 51a illustrates a side view and FIG. 51b illustrates a cross-section front view taken along the line AA-AA of FIG. 51a of the combination. FIG. 51c illustrates a partial, cut-away isometric view and FIG. 51d illustrates an isometric view of the combination. The pack rails 222a, 222b and pack grooves 224a, 224b align with, slide along and engage the tool rails 324a, 324b and tool grooves 322a, 322b, respectively. The lengths XL and WL for each of the embodiments 200a9 and 300a9 are the same.

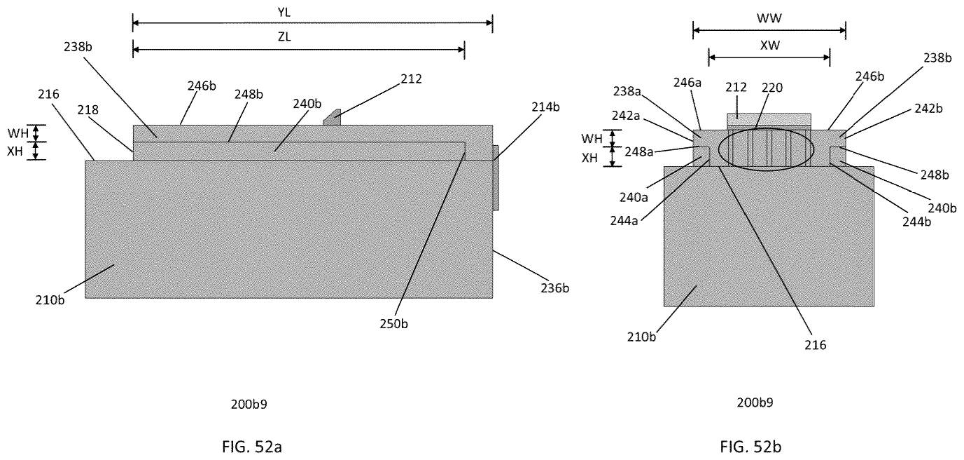

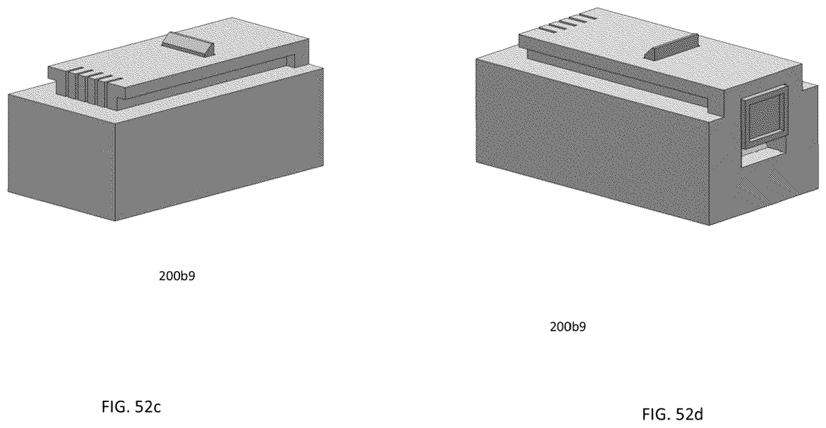

Referring to FIGS. 52a-52d, there is illustrated an example embodiment of a battery pack 200b9 having an advanced rail interface. In this example, the length ZL of the battery pack rails 238a, 238b and the corresponding pack grooves 240a, 240b is approximately twice the length XL of the battery pack rails 222a, 222b and the corresponding battery pack grooves 224a, 224b of the battery pack 200a9 having a single length battery pack interface. This advanced battery pack interface may be referred to as a double length battery pack interface and a battery pack including this advance battery pack interface may be referred to as a double length interface battery pack.

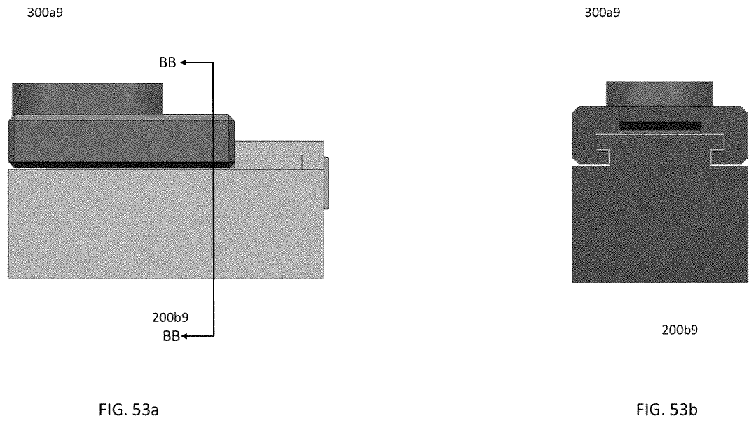

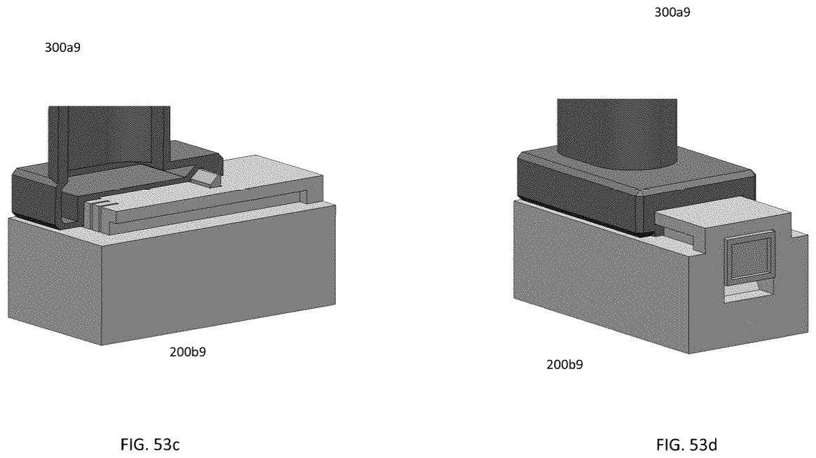

Referring also to FIGS. 53a-53d, there is illustrated an example power tool 300a9 having a single length power tool interface mated with an example battery pack 200b9 having a double length battery pack interface. FIG. 53a illustrates a side view and FIG. 53b illustrates a cross-section front view taken along the line BB-BB of FIG. 53a of the combination. FIG. 53c illustrates a partial, cut-away isometric view and FIG. 53d illustrates an isometric view of the combination.

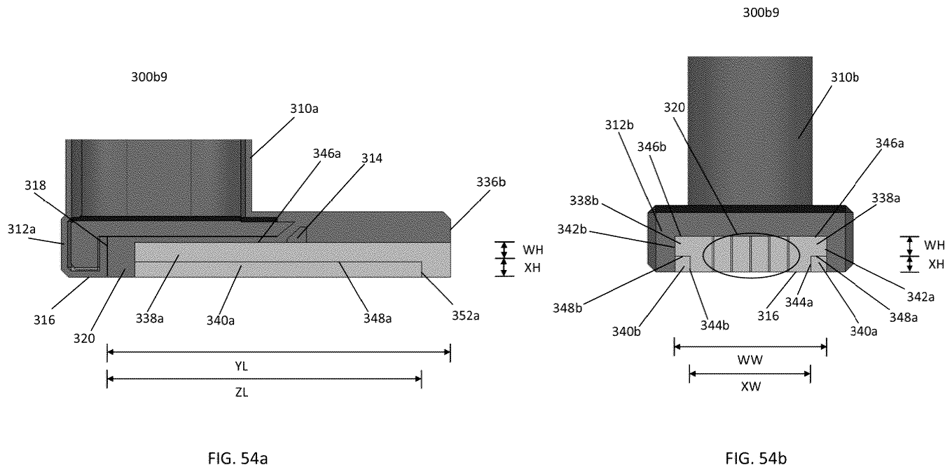

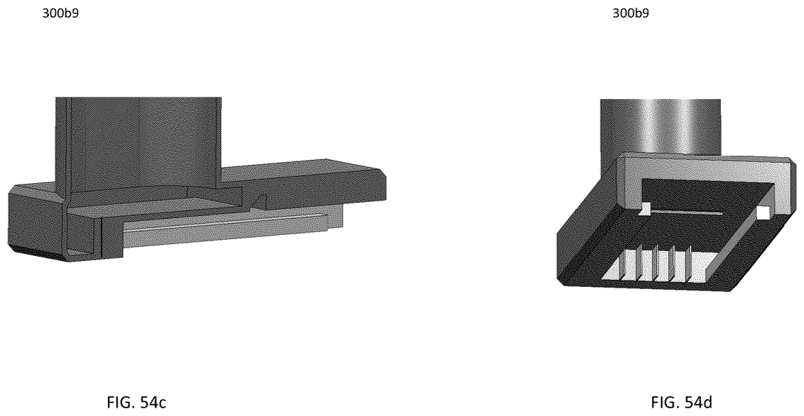

Referring to FIGS. 54a-54d, there is illustrated a ninth example embodiment of a power tool 300b9 having an advanced rail interface. In this example power tool 330b9, the advanced rail interface differs from the advanced rail interface of the example embodiment power tool 300b1 in that the length ZL of the power tool rails 340a, 340b and the corresponding pack grooves 338a, 338b is approximately twice the length XL of the power tool rails 324a, 324b and the corresponding power tool grooves 322a, 322b of the basic interface power tool 300a9. This advanced power tool interface may be referred to as a double length power tool interface and a power tool including this advanced power tool interface may be referred to as a double length interface power tool.

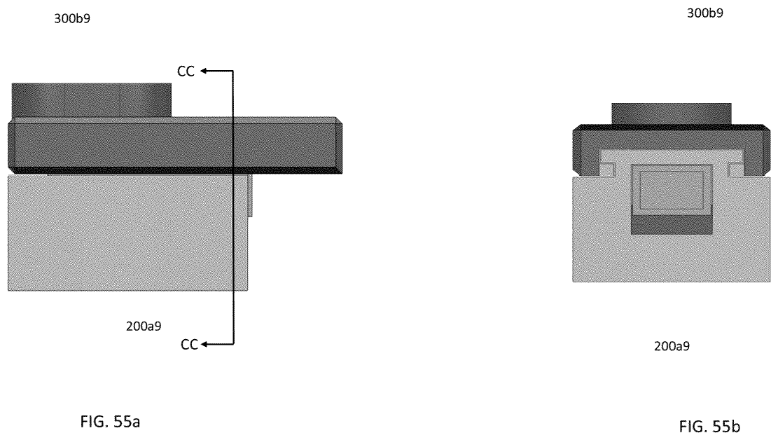

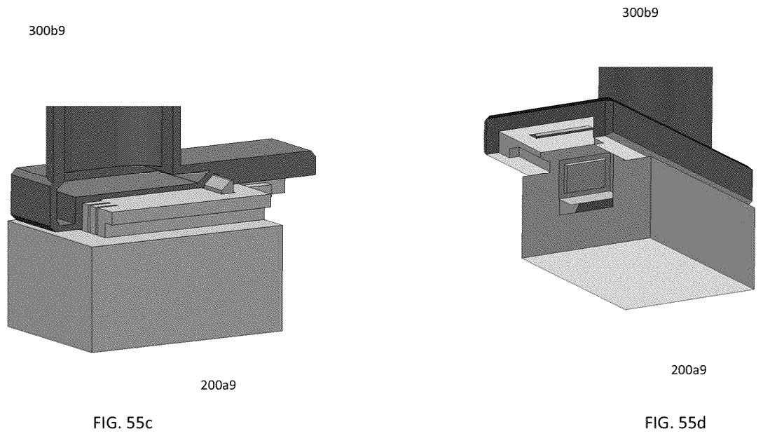

FIGS. 55a-55d illustrate the combination of the double length interface power tool 300b9 with a single length interface battery pack 200a9. FIG. 55a illustrates a side view and FIG. 55b illustrates a cross-section front view taken along the line CC-CC of FIG. 55a of the combination. FIG. 55c illustrates a partial, cut-away isometric view and FIG. 55d illustrates an isometric view of the combination.

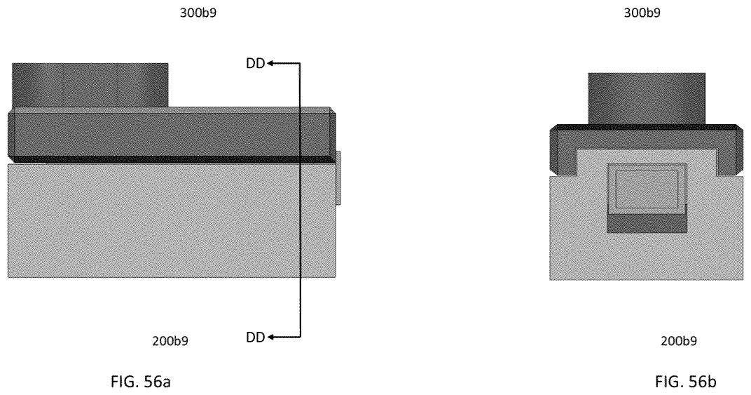

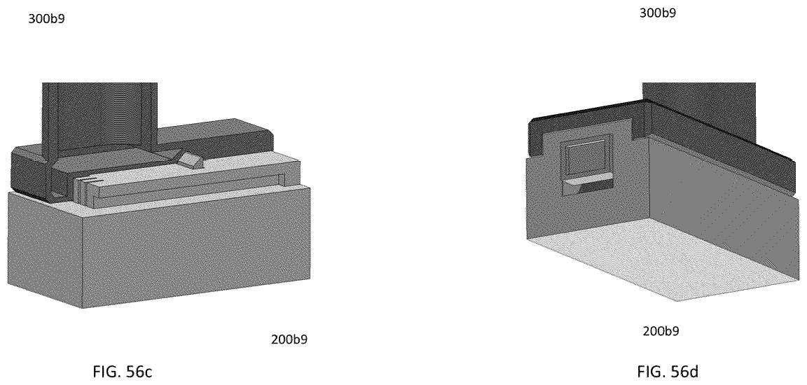

FIGS. 56a-56d illustrate the combination of the double length interface power tool 300b9 with the double length interface battery pack 200b9. FIG. 56a illustrates a side view and FIG. 56b illustrates a cross-section front view taken along the line DD-DD of FIG. 56a of the combination. FIG. 56c illustrates a partial, cut-away isometric view and FIG. 56d illustrates an isometric view of the combination.

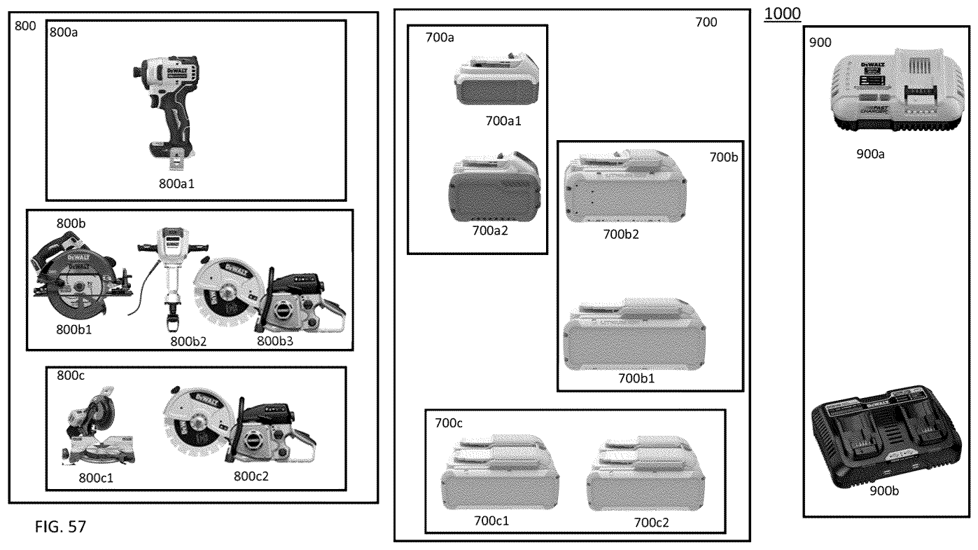

Similar to FIG. 1, FIG. 57 illustrates an example embodiment of a cordless, electric power tool system 1000. The power tool system 1000 includes a set of removable, rechargeable battery packs 700, a set of cordless electric power tools 800 and a set of battery pack chargers 900.

The set of removable, rechargeable battery packs 700 may include a subset of battery packs 700a having a basic interface. These battery packs may be referred to as basic interface battery packs and their interface may be referred to as a battery pack basic interface. The basic interface battery packs 700a may be similar to and include the same features and characteristics of the single rail interface battery packs 200a of FIG. 1. The basic interface battery packs 700a may include single voltage battery packs 700a1 (e.g., 18V, 20V, 40V, 60V etc.) and multi-voltage capable battery packs 700a2 (e.g., 18V/36V, 20V/40V, 20V/60V, etc.).

The set of battery packs 700 may include a subset of battery packs 700b having an advanced interface. These battery packs may be referred to as advanced interface battery packs and their interface may be referred to as a battery pack advanced interface. The advanced interface battery packs 700b may be similar to and include the same features and characteristics of the dual rail interface battery packs 200b of FIG. 1. The advanced interface battery packs 700b may include single voltage battery packs 700b1 (e.g., 18V, 20V, 40V, 60V etc.) and multi-voltage capable battery packs 700b2 (e.g., 18V/36V, 20V/40V, 20V/60V, etc.).

Additionally, the rechargeable battery packs 700 may include a subset of battery packs 700c having multiple (two) advanced interfaces. These battery packs may be referred to as multi-advanced interface battery packs and their interface may be referred to as a battery pack multi-advanced interface. The multi-advanced interface battery packs 700c may be similar to and include the same features and characteristics of the advanced interface battery packs 700b and 200b of FIG. 1 with the additional feature that there are two advanced interfaces combined together in one battery pack. The multi-advanced interface battery packs 700c may include single voltage battery packs 700c1 (e.g., 36V, 40V, 60V, 120V, etc.) and multi-voltage capable battery packs 700c2 (e.g., 36V/72V, 40V/80V, 60V/120V, etc.).

The set of cordless electric power tools 800 may include power tools that operate at different voltages. For example, the set of power tools 800 may include a subset of low voltage power tools 800a (e.g., 18V, 20V, etc.), a subset of medium voltage power tools 800b (e.g., 36V, 40V, 60V, etc.), and a set of high voltage power tools 800c (e.g., 72V, 80V, 120V, etc.).

The subset of low voltage power tools 800a may include tools having a basic interface 800a1, for example a drill driver. These power tools may be referred to as basic interface power tools and their interface may be referred to as a power tool basic interface The basic interface tools 800a1 may be similar to and include the same features and characteristics of the single rail interface tools 300a of FIG. 1.

The subset of medium voltage power tools 800b may include power tools having a basic interface 800b1, power tools having an advanced interface 800b2 and power tools having multiple (two) advanced interfaces. The power tools having an advanced interface may be referred to as advanced interface power tools and their interface may be referred to as a power tool advanced interface. The advanced interface power tools 800b may be similar to and include the same features and characteristics of the dual rail interface tools 300b of FIG. 1. The power tools having multiple advanced interfaces may be referred to as multi-advanced interface power tools and their interface may be referred to as a power tool multi-advanced interface.

The subset of high voltage power tools 800c may include power tools having a multiple basic interfaces 800c1 and power tools having multiple (two) advanced interfaces 800c2. The power tools having multiple basic interfaces may be referred to as multi-basic interface power tools and their interface may be referred to as a power tool multi-basic interface. The multi-basic interface power tools 800c1 may be similar to and include the same features and characteristics of the single rail interface tools 300a of FIG. 1.

The battery packs 700 and the power tools 800 illustrated in FIG. 57 may be compatible as noted below. For example, assuming that the rated voltage of the battery pack matches the operating voltage of the power tool, the basic interface battery packs 700a may be compatible with the low voltage power tools 800a, the medium voltage power tools 800b and the high voltage power tools 800c. In addition, for example, assuming that the rated voltage of the battery pack matches the operating voltage of the power tool, the advanced interface battery packs 700b may be compatible with the low voltage power tools 800a, the medium voltage power tools 800b and the high voltage power tools 800c. In addition, for example, assuming that the rated voltage of the battery pack matches the operating voltage of the power tool, the multi-advanced interface battery packs 700c may be compatible with the medium voltage power tools 800b3 and the high voltage power tools 800c.

The set of battery pack chargers 900 may include a subset of single port chargers 900a capable of charging to (a) a single voltage set point, e.g., a low voltage set point, a medium voltage set point or a high voltage set point or (b) to multiple set points, depending upon the coupled battery pack, e.g., low voltage/medium voltage set points, medium voltage/high voltage set points and a subset of dual port chargers 900b capable of charging to (a) a single set point, e.g., a low voltage set point, a medium voltage set point or a high voltage set point or (b) to multiple set points, depending upon the coupled battery pack, e.g., low voltage/medium voltage set points, medium voltage/high voltage set points. The battery packs 700 and the battery chargers 900 illustrated in FIG. 57 may be compatible as noted below. For example, assuming that the rated voltage of the battery pack matches the charging voltage set point of the battery charger, the basic interface battery packs 700a may be compatible with the single port battery chargers 900a and the dual port battery chargers 900b. In addition, for example, assuming that the rated voltage of the battery pack matches the charging voltage set point of the battery charger, the advanced interface battery packs 700b may be compatible with the single port battery chargers 900a and the dual port battery chargers 900b. In addition, for example, assuming that the rated voltage of the battery pack matches the charging voltage set point of the battery charger, the multi-advanced interface battery packs 700c may be compatible with the dual port battery chargers 900b.

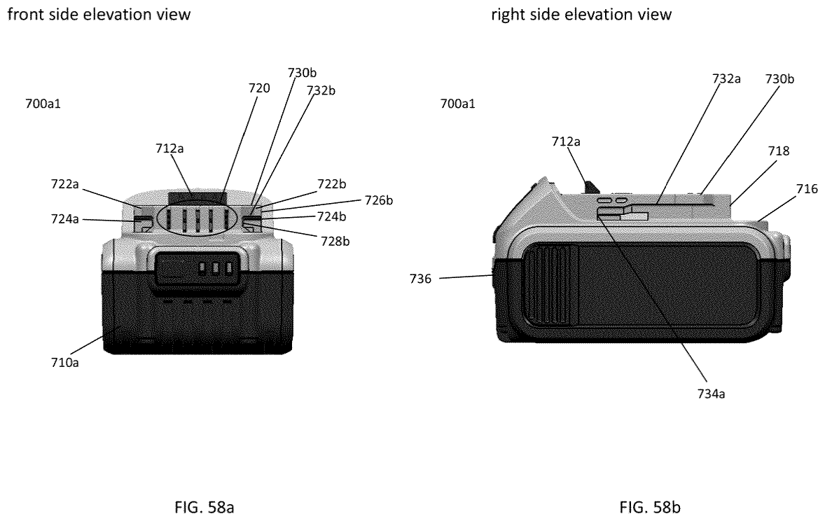

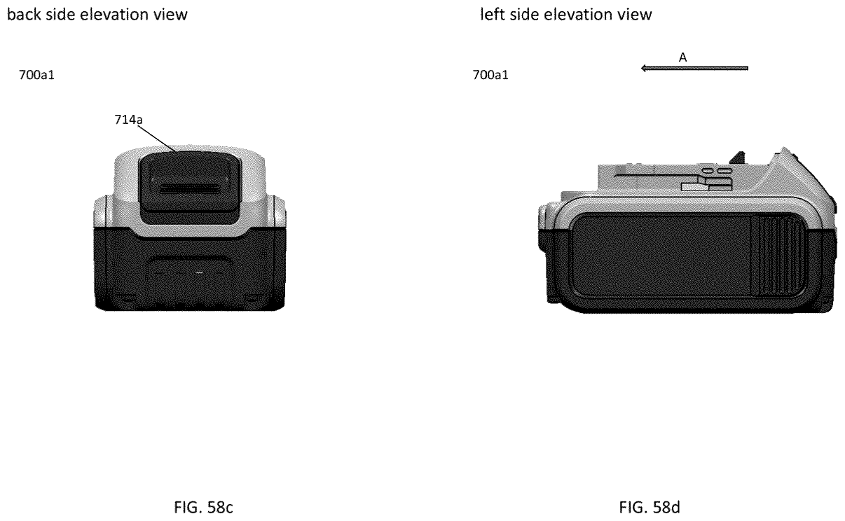

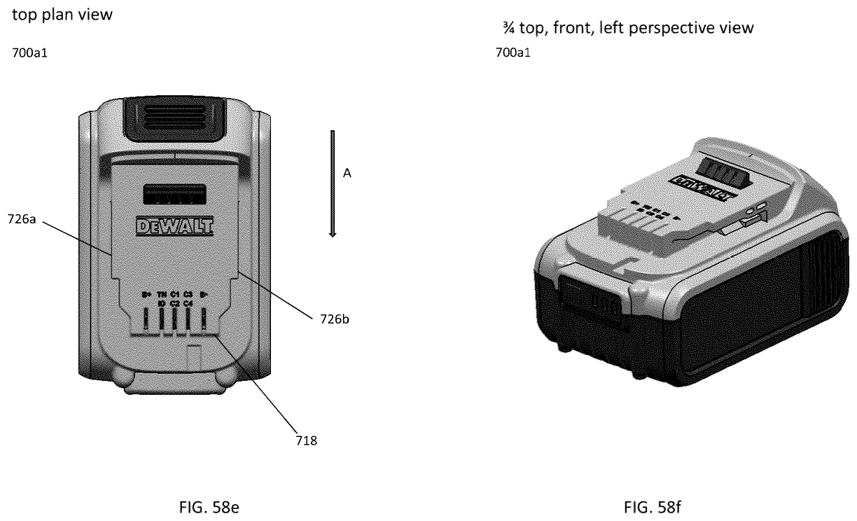

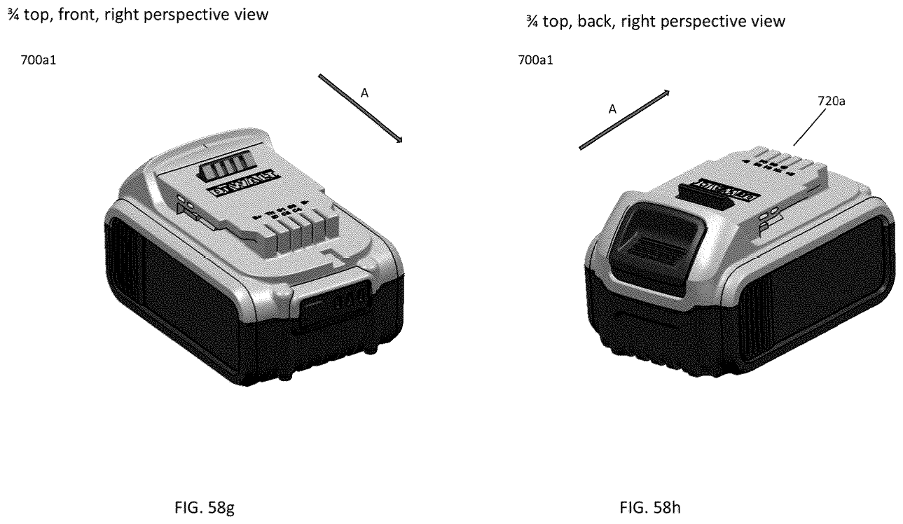

FIGS. 58a-58i illustrate another example embodiment of a basic interface battery pack 700a1 of the power tool system of FIG. 57 including a primary interface element. The basic interface battery pack 700a1 includes the features and characteristics of the single rail interface battery pack 200a1 of FIGS. 2a-2d. The reference numbers used in FIGS. 58a-58i refer to the same components and description above with respect to the reference numbers used in FIGS. 2a-2d with the exception that 700 series reference numbers are used in FIGS. 58a-58i instead of the 200 series reference numbers used in FIGS. 2a-2d.

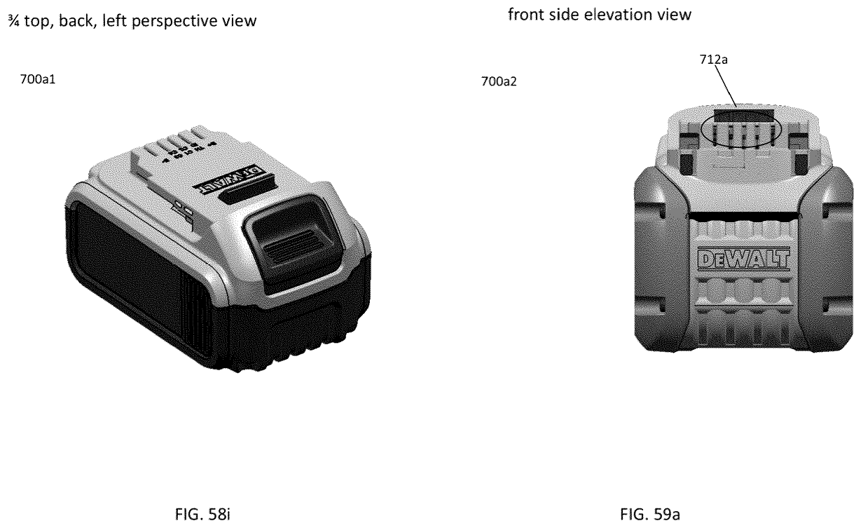

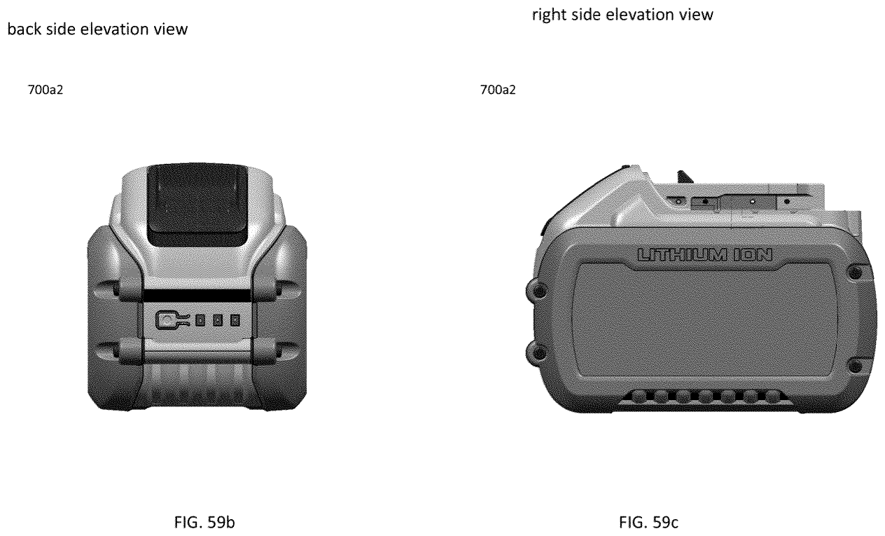

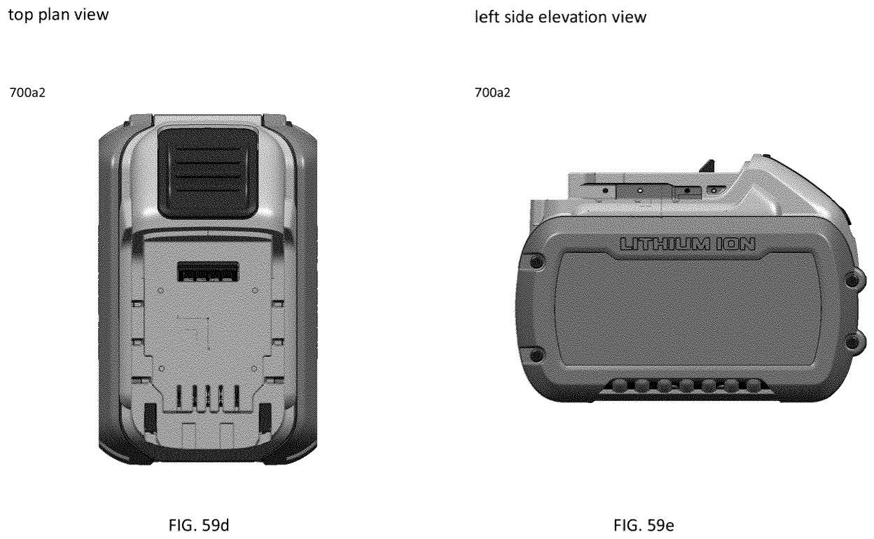

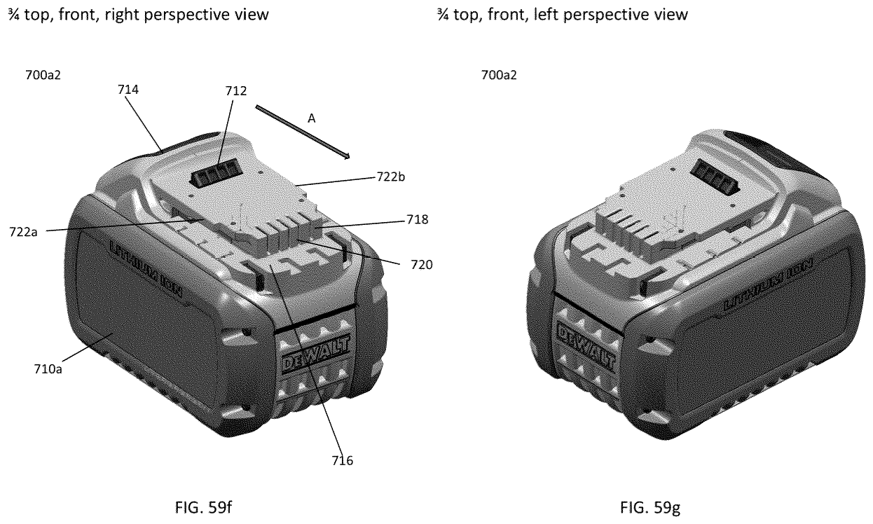

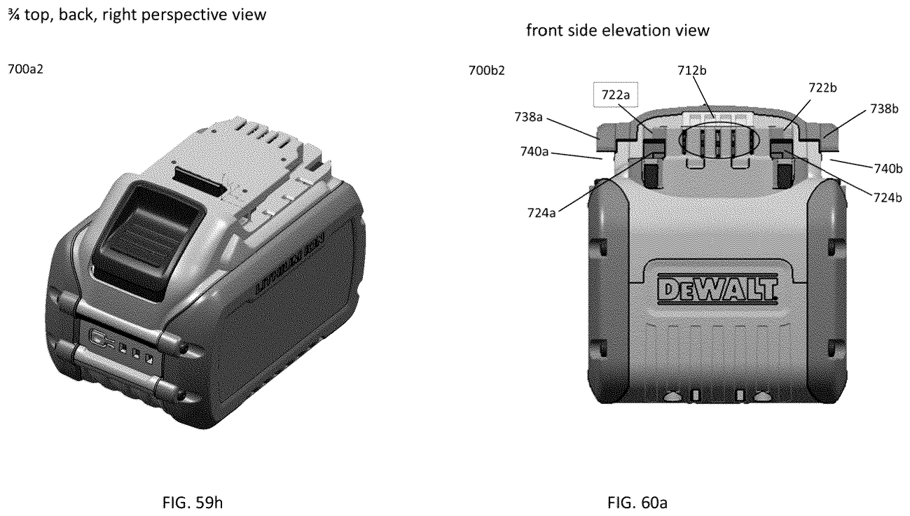

FIGS. 59a-59h illustrate another example embodiment of a basic interface battery pack 700a2 of the power tool system of FIG. 57 including a primary interface element. The basic interface battery pack 700a2 includes the features and characteristics of the single rail interface battery pack 200a1 of FIGS. 2a-2d. The reference numbers used in FIGS. 59a-59h refer to the same components and description above with respect to the reference numbers used in FIGS. 2a-2d with the exception that 700 series reference numbers are used in FIGS. 59a-59h instead of the 200 series reference numbers used in FIGS. 2a-2d.

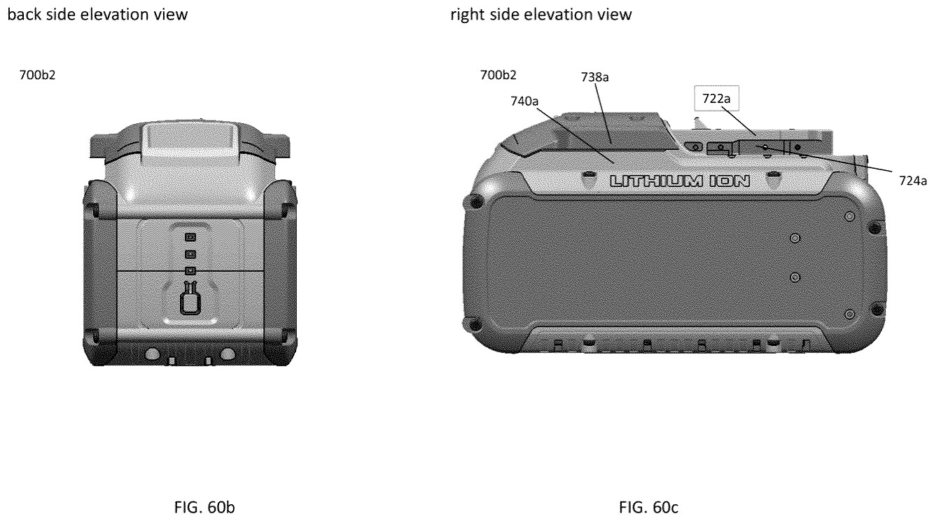

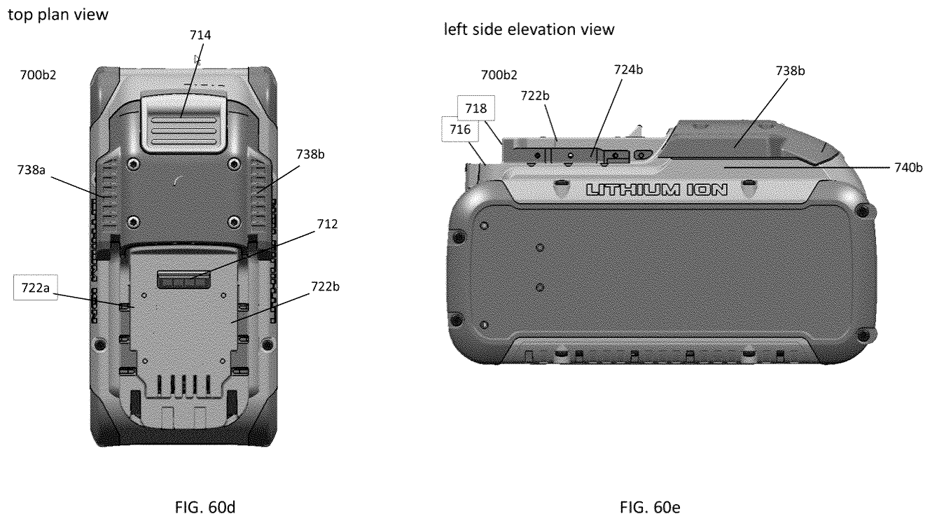

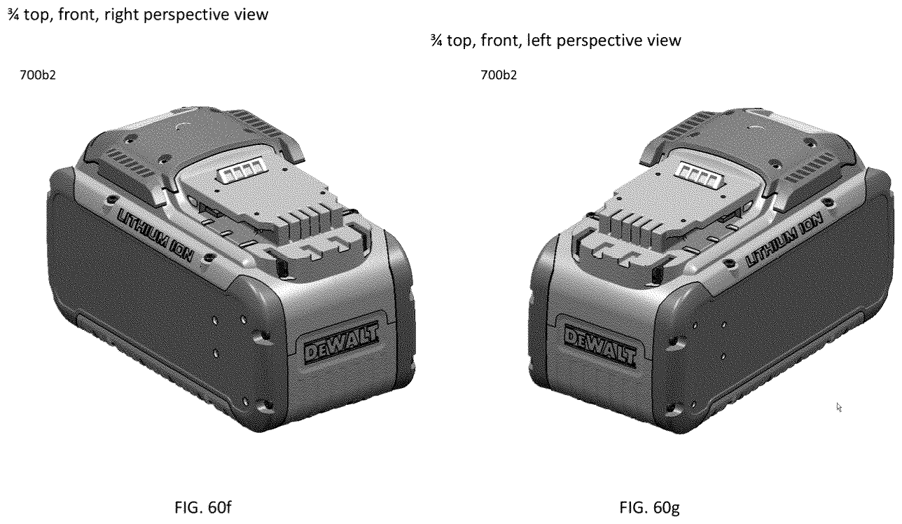

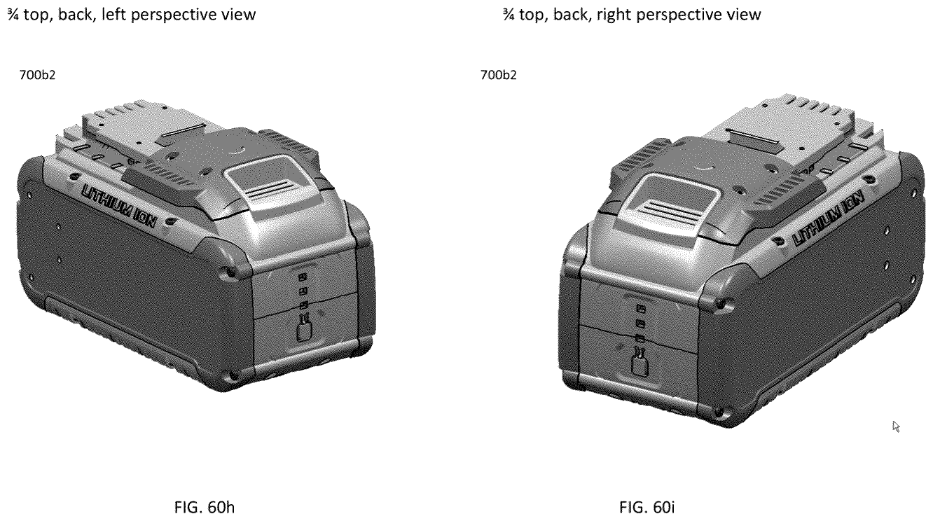

FIGS. 60a-60i illustrate another example embodiment of an advanced interface battery pack 700b2 of the power tool system of FIG. 57 including a primary interface element and a secondary interface element. The advanced interface battery pack 700b2 includes the features and characteristics of the dual rail interface battery pack 200b1 of FIGS. 5a-5d. The reference numbers used in FIGS. 60a-60i refer to the same components and description above with respect to the reference numbers used in FIGS. 5a-5d with the exception that 700 series reference numbers are used in FIGS. 60a-60i instead of the 200 series reference numbers used in FIGS. 5a-5d.

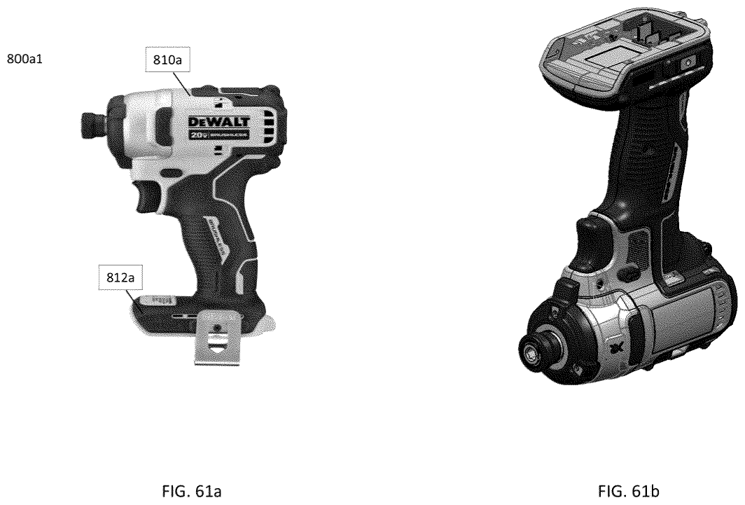

FIGS. 61a-1b illustrate an example embodiment of a basic interface power tool 800a1 of the power tool system of FIG. 57 including a primary interface element. The basic interface power tool 800a1 includes the features and characteristics of the single rail interface power tool 300a1 of FIGS. 3a-3d. The reference numbers used in FIG. 61 refer to the same components and description above with respect to the reference numbers used in FIGS. 3a-3d with the exception that 800 series reference number are used in FIG. 61 instead of the 300 series reference numbers used in FIGS. 3a-3d.

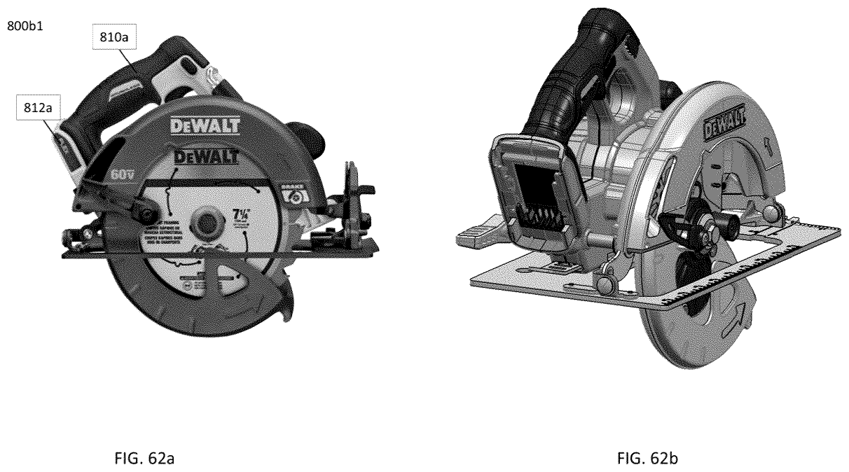

FIGS. 62a-62b illustrate another example embodiment of a basic interface power tool 800b1 of the power tool system of FIG. 57 including a primary interface element. The basic interface power tool 800b1 includes the features and characteristics of the single rail interface power tool 300a1 of FIGS. 3a-3d. The reference numbers used in FIG. 62 refer to the same components and description above with respect to the reference numbers used in FIGS. 3a-3d with the exception that 800 series reference number are used in FIG. 61 instead of the 300 series reference numbers used in FIGS. 3a-3d.

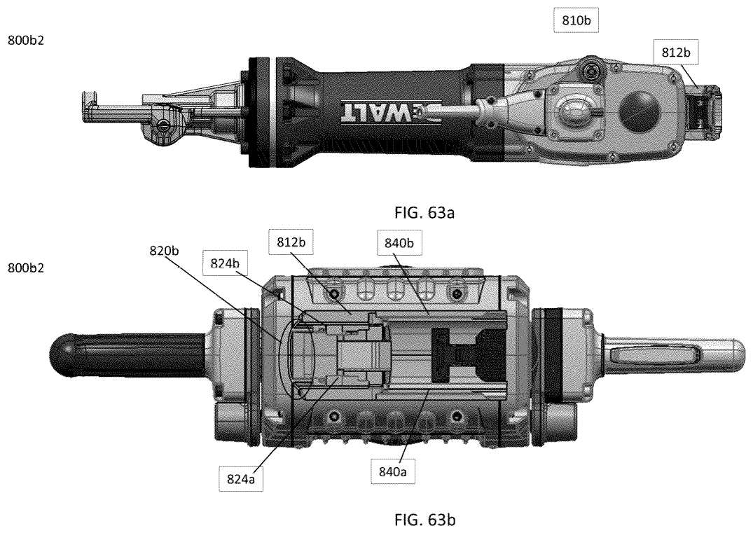

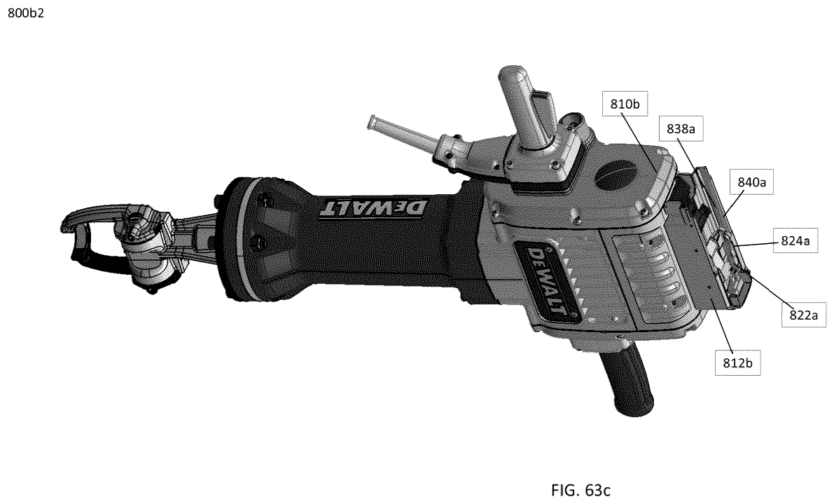

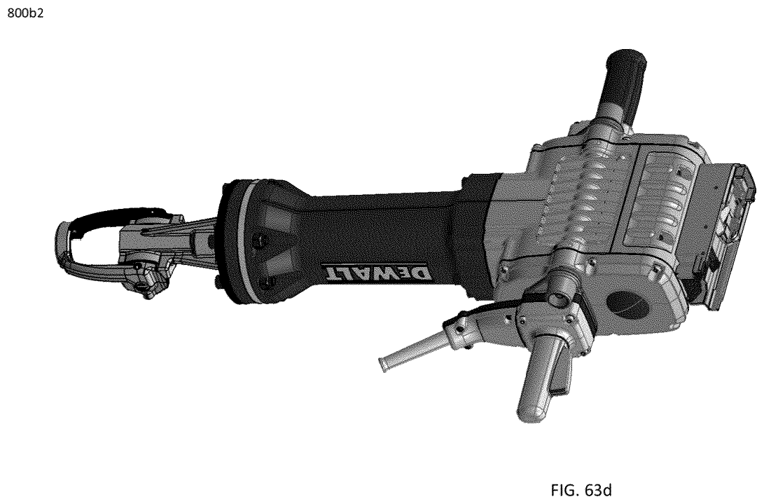

FIGS. 63a-63d illustrate an example embodiment of an advanced interface power tool 800b2 of the power tool system of FIG. 57 including a primary interface element and a secondary interface element. The advanced interface power tool 800b21 includes the features and characteristics of the dual rail interface power tool 300b1 of FIGS. 7a-7d. The reference numbers used in FIGS. 63a-63d refer to the same components and description above with respect to the reference numbers used in FIGS. 7a-7d with the exception that 800 series reference number are used in FIGS. 63a-63d instead of the 300 series reference numbers used in FIGS. 7a-7d.

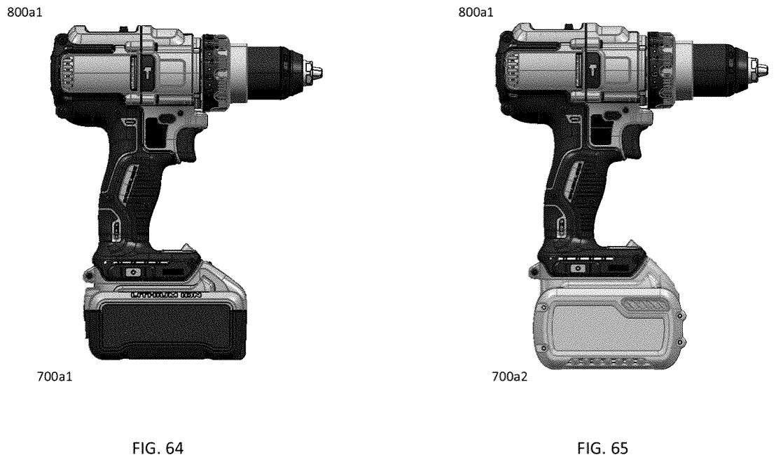

FIG. 64 illustrates a combination of an example basic interface battery pack 700a1 including a primary interface element and an example basic interface power tool 800a1 including a primary interface element of the power tool system of FIG. 57.

FIG. 65 illustrates a combination of an example basic interface battery pack 700a2 including a primary interface element and an example basic interface power tool 800a1 including a primary interface element of the power tool system of FIG. 57.

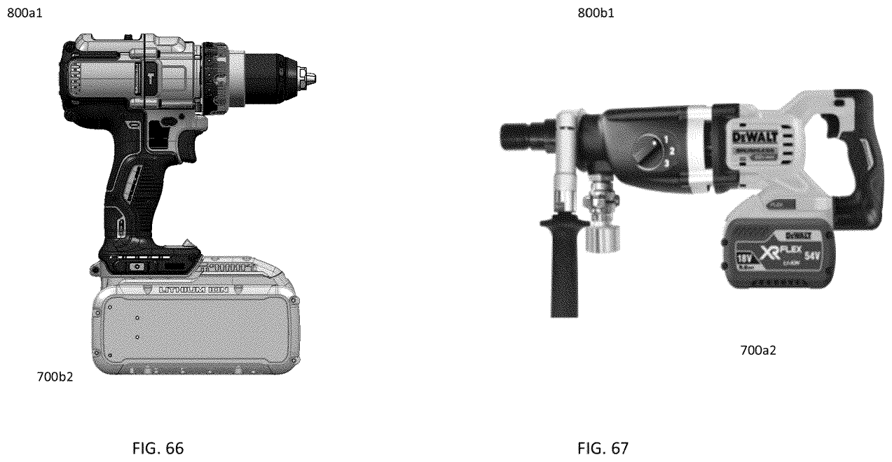

FIG. 66 illustrates a combination of an example advanced interface battery pack 700b2 including a primary interface element and a secondary interface element and an example basic interface power tool 800a1 including a primary interface element of the power tool system of FIG. 57.

FIG. 67 illustrates a combination of an example basic interface battery pack 700a2 including a primary interface element and an example basic interface power tool 800b1 including a primary interface element of the power tool system of FIG. 57.

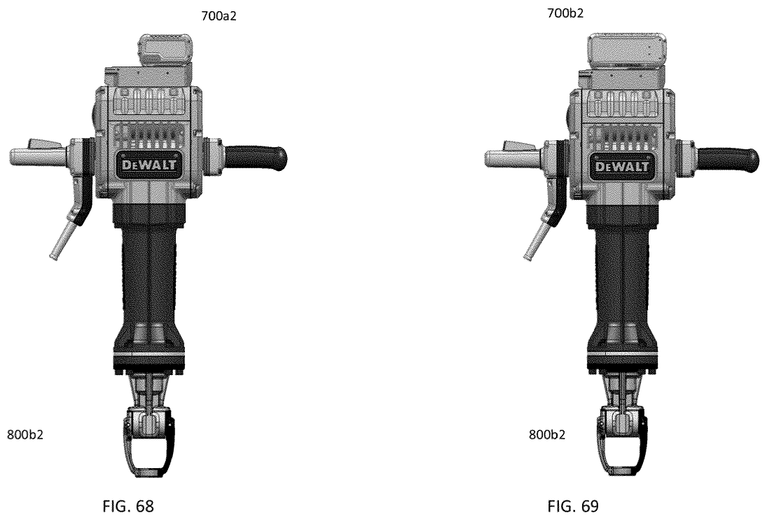

FIG. 68 illustrates a combination of an example basic interface battery pack 700a2 including a primary interface element and an example advanced interface power tool 800b2 including a primary interface element and a secondary interface element of the power tool system of FIG. 57.

FIG. 69 illustrates a combination of an example advanced interface battery pack 700b2 including a primary interface element and a secondary interface element and an example advanced interface power tool 800b2 including a primary interface element and a secondary interface element of the power tool system of FIG. 57.

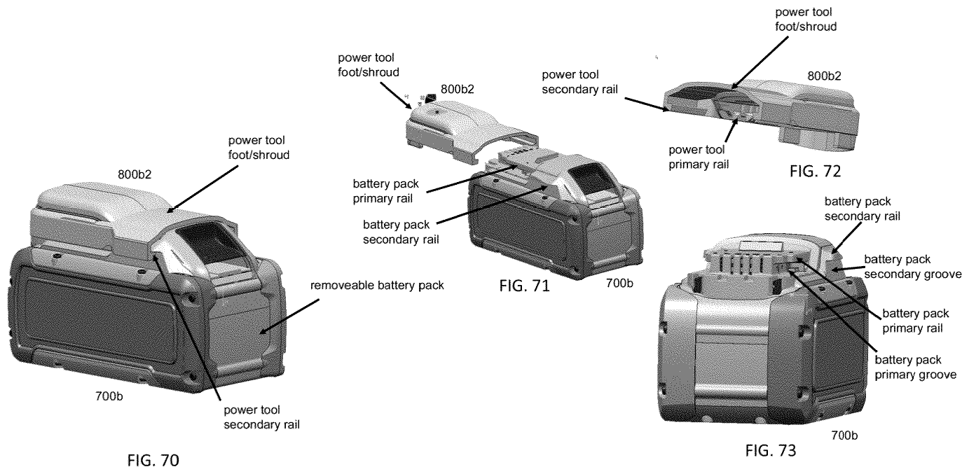

FIG. 70 illustrates another example combination of an example advanced interface battery pack 700b including a primary interface element and a secondary interface element and an example advanced interface power tool 800b2 (foot/shroud) including a primary interface element and a secondary interface element after mating. FIG. 71 illustrates the example combination of FIG. 70 prior to mating. FIG. 72 illustrates the example power tool 800b2 (foot/shroud) of FIGS. 70 and 71. FIG. 73 illustrates the example battery pack 700b of FIGS. 70 and 71.

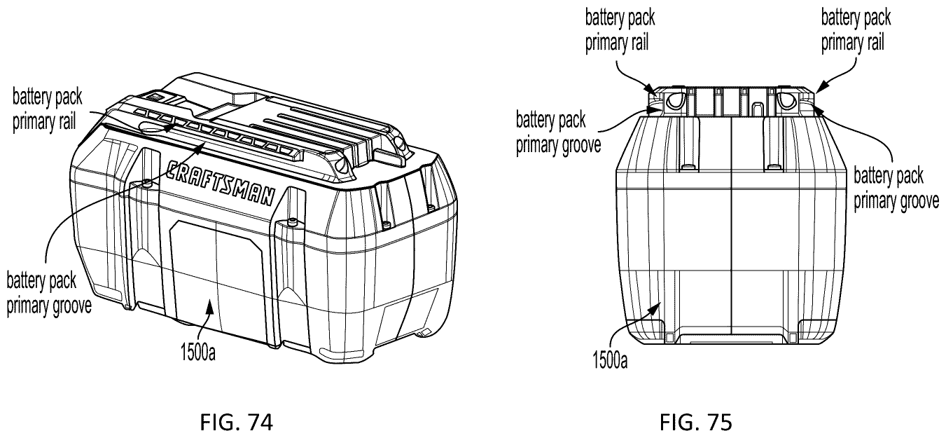

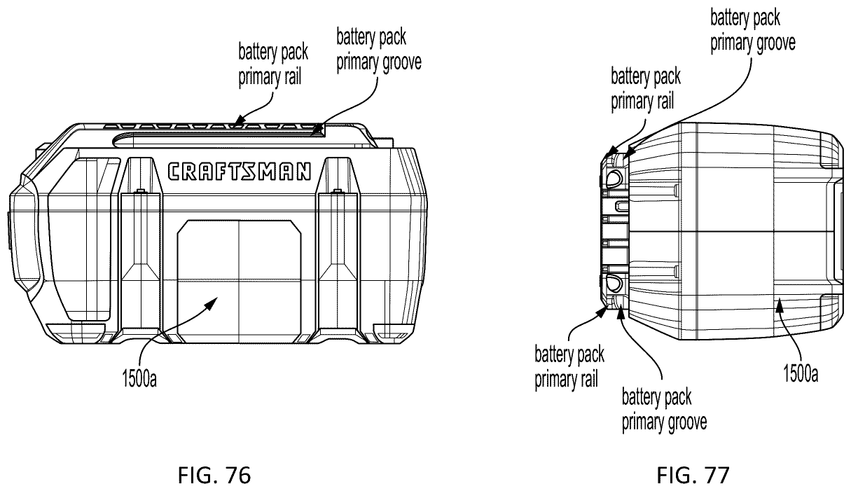

FIGS. 74-77 illustrate another example embodiment of a basic interface battery pack 1500a including a primary interface element.

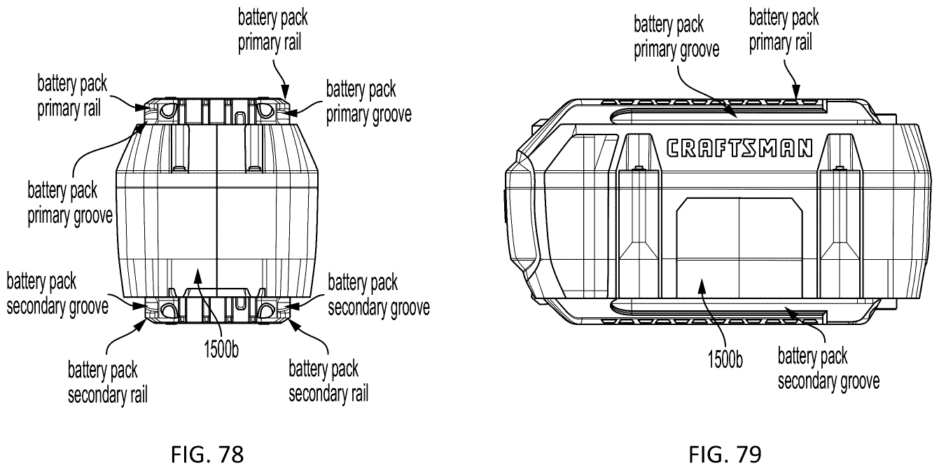

FIGS. 78 and 79 illustrate another example embodiment of an advanced interface battery pack 1500b including a primary interface element and a secondary interface element.

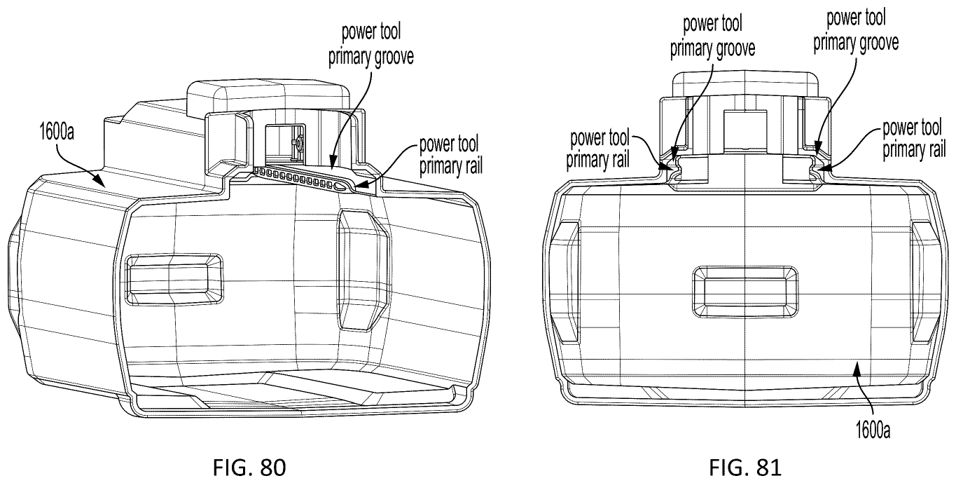

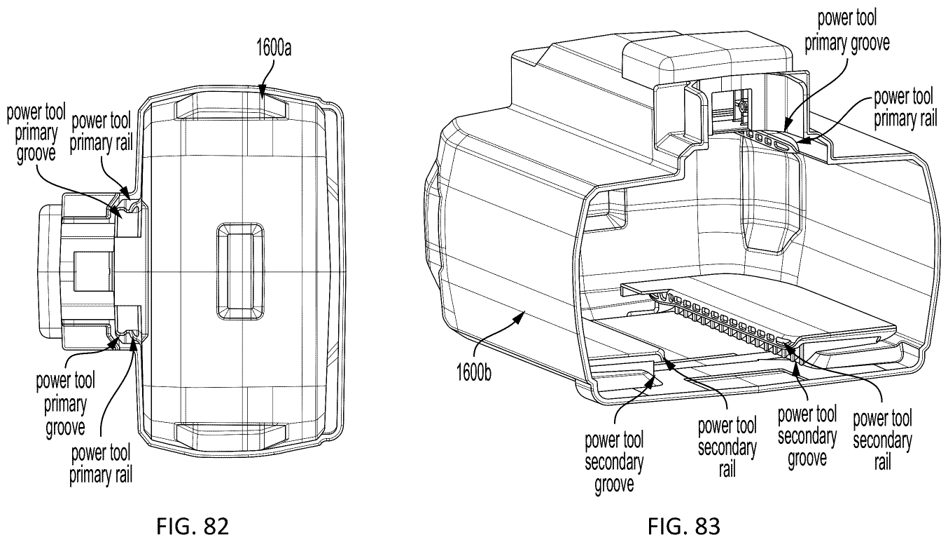

FIGS. 80-82 illustrate another example embodiment of a basic interface power tool (foot/shroud) 1600a including a primary interface element.

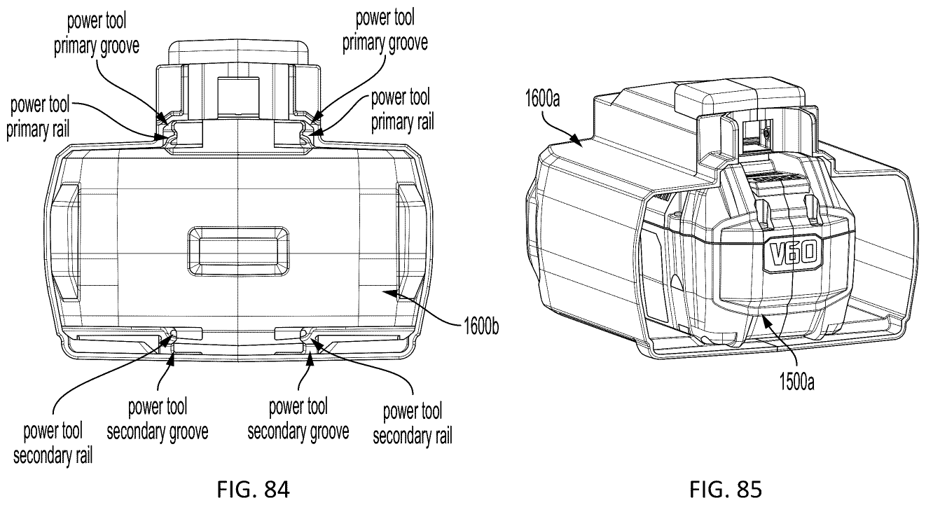

FIGS. 83 and 84 illustrate another example embodiment of an advanced interface power tool (foot/shroud) 1600b including a primary interface element and secondary interface element.

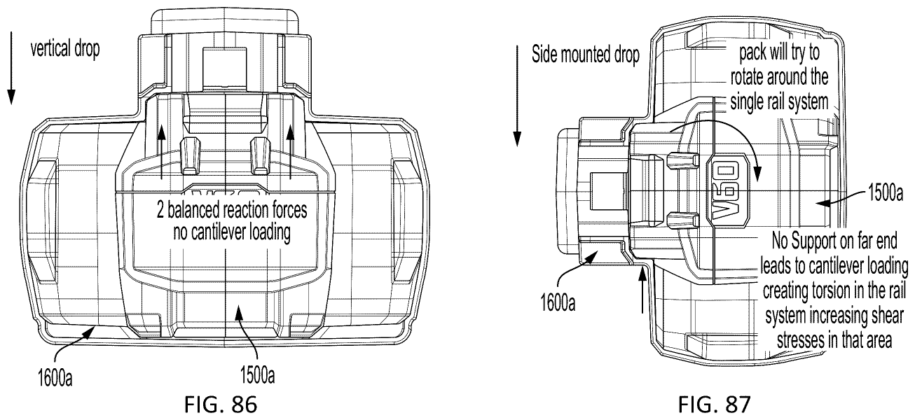

FIGS. 85-87 illustrate a combination of the basic interface battery pack 1500a of FIGS. 74-77 and the basic interface power tool (foot/shroud) 1600a of FIGS. 80-82.

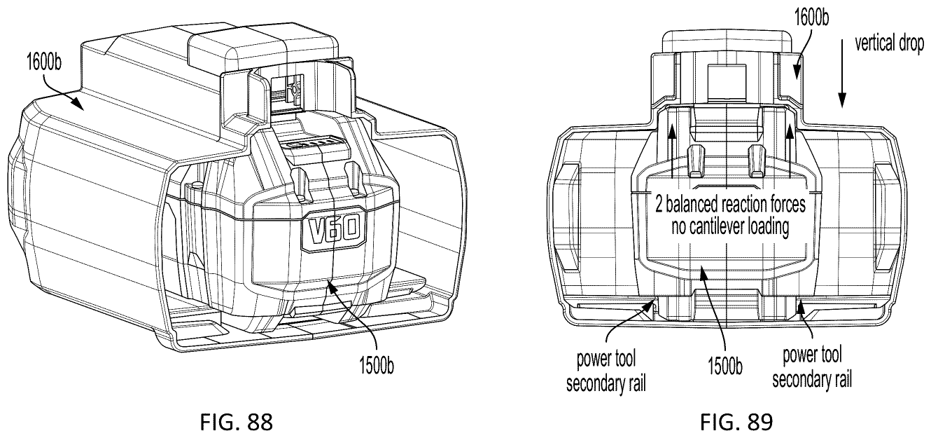

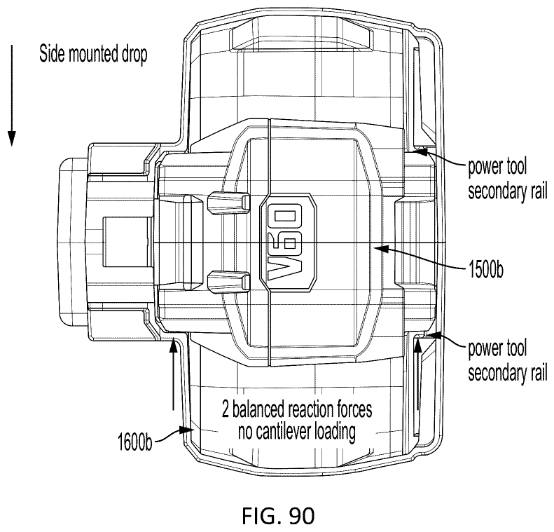

FIGS. 88-90 illustrate a combination of the advanced interface battery pack 1500b of FIGS. 78 and 79 and the advanced interface power tool (foot/shroud) 1600b of FIGS. 83 and 84.

A battery pack may include an interface for mating with an interface of an electrical device, e.g., a cordless electric power tool or battery pack charger. The battery pack interface may include an interface element. The interface element may include a set of rails. The interface element may also include a set of grooves. The interface may also include a latch and a user actuation button for actuating the latch.

The use of the terms primary and secondary is not intended to indicate or infer that primary is of greater importance or significance than secondary. The same is true with the use of principal and supplemental or main and auxiliary or basic and additional, in any combination.

Numerous modifications may be made to the exemplary implementations described above. These and other implementations are within the scope of this application.

1. A removable battery pack for providing electrical energy to a cordless electric tool, the removable battery pack comprising:
a housing having a forward side and a rearward side, the forward side including a plurality of terminal slots; and
an interface including a first set of grooves and a second set of grooves, the first set of grooves positioned closer to the forward side than the second set of grooves.

2. The removable battery pack, as recited in claim 1, wherein the first set of grooves are in a same horizontal plane as the second set of grooves.

3. The removable battery pack, as recited in claim 1, wherein the first set of grooves are not in a same horizontal plane as the second set of grooves.

4. The removable battery pack, as recited in claim 1, wherein the battery pack housing includes a datum plane and the first set of grooves are not offset from the datum plane and the second set of grooves are offset from the datum plane by a first distance.

5. The removable battery pack, as recited in claim 1, wherein the first set of grooves includes two grooves in a first plane and the second set of grooves includes two grooves in a second plane, each of the two grooves of the first set of grooves includes a side wall, the side walls of the two grooves of the first set of grooves being generally perpendicular to each other and separated by a first distance and each of the two grooves of the second set of grooves includes a side wall, the side walls of the two grooves of the second set of grooves being generally perpendicular to each other and separated by a second distance.

6. The removable battery pack, as recited in claim 5, wherein the first distance is generally less than the second distance.

7. The removable battery pack, as recited in claim 4, wherein the battery pack housing is configured to mate with the cordless electric tool in a mating direction and wherein the datum plane is parallel to the mating direction and wherein the first distance is offset from the datum plane in a direction perpendicular to the datum plane.

8. The removable battery pack, as recited in claim 1, further comprising a first set of rails associated with the first set of grooves and a second set of rails associated with the second set of grooves.

9. The removable battery pack, as recited in claim 1, wherein the first set of grooves includes two grooves in a first plane and the second set of grooves includes two grooves in a second plane, wherein the battery pack housing includes a datum plane and the first plane is not offset from the datum plane and the second plane is offset from the datum plane by a first distance.

10. The removable battery pack, as recited in claim 1, wherein the removable battery pack is compatible with both a single rail interface power tool and a dual rail interface power tool.

11. The removable battery pack, as recited in claim 1, wherein the first set of rails defines a first rail height dimension and the second set of rails defines a second rail height dimension, the first rail height dimension being a same rail height dimension as the second rail height dimension.

12. The removable battery pack, as recited in claim 8, wherein the first set of grooves defines a first groove height dimension and the second set of grooves defines a second groove height dimension, the first groove height dimension being a same groove height dimension as the second groove height dimension.

13. An interface of a removable battery pack for mating with an interface of a cordless electric power tool, the interface comprising:
a first set of battery pack grooves and a first set of battery pack rails associated with the first set of battery pack grooves and a second set of battery pack grooves and a second set of battery pack rails associated with the second set of battery pack grooves, the first set of battery pack grooves and the first set of battery pack rails positioned closer to a forward side of the battery pack than the second set of battery pack grooves and the second set of battery pack rails.

14. The interface, as recited in claim 13, wherein the first set of battery pack grooves are generally in a first plane and the second set of battery pack grooves are in a second plane and the first plane and the second plane are generally in a same plane.

15. The interface, as recited in claim 13 wherein the first set of battery pack grooves are not in a same plane as the second set of battery pack grooves.

16. The interface, as recited in claim 13, further comprising a datum plane and wherein the first set of battery pack grooves are not offset from the datum plane and the second set of battery pack grooves are offset from the datum plane by a first distance.

17. The interface, as recited in claim 13, wherein the first set of battery pack grooves includes two grooves in a first plane and the second set of battery pack grooves includes two grooves in a second plane, each of the two grooves of the first set of battery pack grooves includes a side wall, the side walls of the two grooves of the first set of battery pack grooves being generally perpendicular to each other and separated by a first distance and each of the two grooves of the second set of battery pack grooves includes a side wall, the side walls of the two grooves of the second set of battery pack grooves being generally perpendicular to each other and separated by a second distance.

18. The interface, as recited in claim 17, wherein the first distance is generally less than the second distance.

19. The interface, as recited in claim 16, wherein the interface is configured to mate with an interface of a cordless electric tool in a mating direction and wherein the datum plane is generally parallel to the mating direction and wherein the first distance is offset from the datum plane in a direction generally perpendicular to the datum plane.

20. A cordless electric power tool for receiving electrical energy from a removable battery pack, the cordless electric power tool comprising:
a housing having a forward side and a rearward side, the forward side including a plurality of terminal slots; and
an interface including a first set of power tool grooves and a second set of power tool grooves, the first set of power tool grooves positioned closer to the forward side than the second set of power tool grooves.

21. The cordless electric power tool, as recited in claim 20, wherein the first set of power tool grooves are in a same horizontal plane as the second set of power tool grooves.

22. The cordless electric power tool, as recited in claim 20, wherein the first set of power tool grooves are not in a same plane as the second set of power tool grooves.

23. The cordless electric power tool, as recited in claim 20, wherein the power tool housing includes a datum plane and the first set of power tool grooves are not offset from the datum plane and the second set of power tool grooves are offset from the datum plane by a first distance.

24. The cordless electric power tool, as recited in claim 20, wherein the first set of power tool grooves includes two grooves in a first plane and the second set of power tool grooves includes two grooves in a second plane, each of the two grooves of the first set of power tool grooves includes a side wall, the side walls of the two grooves of the first set of power tool grooves being parallel to each other and separated by a first distance and each of the two grooves of the second set of power tool grooves includes a side wall, the side walls of the two grooves of the second set of power tool grooves being parallel to each other and separated by a second distance.

25. The cordless electric power tool, as recited in claim 24, wherein the first distance is generally less than the second distance.

26. The cordless electric power tool, as recited in claim 23, wherein the power tool housing is configured to mate with the battery pack in a mating direction and wherein the datum plane is parallel to the mating direction and wherein the first distance is offset from the datum plane in a direction perpendicular to the datum plane.

27. The cordless electric power tool, as recited in claim 20, further comprising a first set of power tool rails associated with the first set of power tool grooves and a second set of power tool rails associated with the second set of power tool grooves.

28. The cordless electric power tool, as recited in claim 20, wherein the first set of power tool rails defines a first power tool rail height dimension and the second set of power tool rails defines a second power tool rail height dimension, the first power tool rail height dimension being a same power tool rail height dimension as the second power tool rail height dimension.

29. The cordless electric power tool, as recited in claim 27, wherein the first set of power tool grooves defines a first power tool groove height dimension and the second set of power tool grooves defines a second power tool groove height dimension, the first power tool groove height dimension being a same power tool groove height dimension as the second power tool groove height dimension.

30. A cordless power tool system, comprising:
a removable battery pack configured to mate with a cordless power tool and to provide electrical energy to the cordless power tool, the battery pack comprising:
a battery pack housing having a forward side and a rearward side, the forward side including a plurality of terminal slots that provide access to a plurality of battery terminals; and
an interface including a first set of battery pack grooves and a first set of battery pack rails associated with the first set of battery pack grooves and a second set of battery pack grooves and a second set of battery pack rails associated with the second set of battery pack grooves, the first set of battery pack grooves and the first set of battery pack rails positioned closer to the forward side than the second set of battery pack grooves and the second set of battery pack rails; and
a cordless power tool configured to mate with the removable battery pack and to receive electrical energy from the removable battery pack, the cordless power tool comprising:
a power tool housing having a forward side and a rearward side, the rearward side including a plurality of tool terminals configured to mate with the plurality of battery terminals upon mating with the removable battery pack; and
an interface including a first set of power tool grooves and a first set of power tool rails associated with the first set of power tool grooves and a second set of power tool grooves and a second set of power tool rails associated with the second set of power tool grooves, the first set of power tool grooves and the first set of power tool rails positioned closer to the rearward end than the second set of power tool grooves and the second set of power tool rails;
the first set of battery pack grooves and the first set of battery pack rails and the second set of battery pack grooves and the second set of battery pack rails and the first set of power tool grooves and the first set of power tool rails and the second set of power tool grooves and the second set of power tool rails shaped, dimensioned and configured such that when the battery pack is mated with the power tool the first set of battery pack grooves is received in the first set of power tool rails and the second set of battery pack grooves is received in the second set of power tool rails and the first set of power tool grooves is received in the first set of battery pack rails and the second set of power tool grooves is received in the second set of battery pack rails.

31. The cordless power tool system, as recited in claim 30, wherein the first set of battery pack grooves includes two grooves in a first plane and the second set of battery pack grooves includes two grooves in a second plane, each of the two grooves of the first set of battery pack grooves includes a side wall, the side walls of the two grooves of the first set of battery pack grooves being parallel to each other and separated by a first distance and each of the two grooves of the second set of battery pack grooves includes a side wall, the side walls of the two grooves of the second set of battery pack grooves being parallel to each other and separated by a second distance, the first distance being less than the second distance and wherein the first set of power tool grooves includes two grooves in a first plane and the second set of power tool grooves includes two grooves in a second plane, each of the two grooves of the first set of power tool grooves includes a side wall, the side walls of the two grooves of the first set of power tool grooves being parallel to each other and separated by a first distance and each of the two grooves of the second set of power tool grooves includes a side wall, the side walls of the two grooves of the second set of power tool grooves being parallel to each other and separated by a second distance, the first distance being less than the second distance

32. The cordless power tool system, as recited in claim 30, wherein the first set of battery pack rails defines a first battery pack rail height dimension and the second set of battery pack rails defines a second battery pack rail height dimension, the first battery pack rail height dimension being a same battery pack rail height dimension as the second battery pack rail height dimension.

33. The cordless power tool system, as recited in claim 30, wherein the first set of battery pack grooves defines a first battery pack groove height dimension and the second set of battery pack grooves defines a second battery pack groove height dimension, the first battery pack groove height dimension being a same battery pack groove height dimension as the second battery pack groove height dimension.

34. The cordless power tool system, as recited in claim 30, wherein the first set of power tool rails defines a first power tool rail height dimension and the second set of power tool rails defines a second power tool rail height dimension, the first power tool rail height dimension being a same power tool rail height dimension as the second power tool rail height dimension.

35. The cordless power tool system, as recited in claim 30, wherein the first set of power tool grooves defines a first power tool groove height dimension and the second set of power tool grooves defines a second power tool groove height dimension, the first power tool groove height dimension being a same power tool groove height dimension as the second power tool groove height dimension.
